(19) United States
(12) Patent Application Publication
(10) Pub. No.: US 2025/0300551 A1
(43) Pub. Date: Sep. 25, 2025

(54) MULTI-STAGE CHARGE PUMP, CURRENT LIMITING CIRCUIT, DRIVER CIRCUIT, AND CHARGE PUMP

(71) Applicant: Zhuhai Nanxin Semiconductor Technology Co., Ltd., Zhuhai City (CN)

(72) Inventors: Lei Yi, Zhuhai City (CN); Jun Ma, Zhuhai City (CN); Jidong Diao, Zhuhai City (CN); Mouzhao Zhou, Zhuhai City (CN)

(21) Appl. No.: 19/087,373

(22) Filed: Mar. 21, 2025

(30) Foreign Application Priority Data
Mar. 21, 2024 (CN) 202410332938.7
Mar. 21, 2024 (CN) 202410332951.2
Feb. 14, 2025 (CN) 202510165920.7

(51) Int. Cl. H02M 3/07; H02M 1/32

(52) U.S. Cl. CPC H02M 3/073; H02M 1/32

(57) ABSTRACT

The present disclosure provides a multi-stage charge pump, a current limiting circuit, a driver circuit, a charge pump, a chip, and an electronic device. A control circuit controls a first charge pump circuit to boost an input voltage of a multi-stage charge pump, and controls, based on a second-phase clock signal, a second charge pump circuit to be charged using an output voltage of the first charge pump circuit, such that the second charge pump circuit boosts an output voltage of the first charge pump circuit, and hence a high-side switch driver circuit satisfies a drive requirement of a high-side switch. This ensures normal operation of the charge pump is ensured while reducing the cost and circuit area. In this way, the reliability and safety of the charge pump are improved.

### CROSS-REFERENCE TO RELATED APPLICATION

This application is based upon and claims the priority of Chinese Patent Application No. 202410332938.7, filed on Mar. 21, 2024, Chinese Patent Application No. 202410332951.2, filed on Mar. 21, 2024, and Chinese Patent Application No. 202510165920.7, filed on Feb. 14, 2025. All of the aforementioned patent applications are hereby incorporated by reference in their entireties.

### TECHNICAL FIELD

The present disclosure relates to the technical field of charge pumps, and in particular, relates to a multi-stage charge pump, a current limiting circuit, a driver circuit, a charge pump, a chip, and an electronic device.

### BACKGROUND

In the automotive field, a charge pump is typically used to supply power to a high-side switch driver circuit, such that the high-side switch driver circuit is capable of driving a high-side switch to be turned on or turned off. In practice, a voltage difference between an input voltage and an output voltage of the charge pump needs to be maintained within a range of 10 V to 15 V. In this way, the high-side switch driver circuit may satisfy a drive requirement of the high-side switch.

In the related art, the charge pump may boost the output voltage to twice the input voltage. However, in a case where the input voltage is relatively low, the output voltage is also relatively low, and as a result, an overdrive voltage of the high-side switch is relatively low, such that an on-resistance (impedance) of the high-side switch increases. Consequently, the high-side switch driver circuit fails to satisfy the drive requirement of the high-side switch.

In the related art, the charge pump selects either a first operating mode or a second operating mode based on a magnitude of the input voltage. In the first operating mode, the output voltage of the charge pump is three times the input voltage, while in the second operating mode, the output voltage is twice the input voltage.

However, in the related art, under special operating conditions such as power-up with an arbitrary initial value of an energy storage capacitor, input voltage transients, or open/short circuits of the energy storage capacitor, body diodes of power transistors in the charge pump may be turned on. This results in uncontrollable large currents flowing through the body diodes of the power transistors.

The charge pump, also known as a switched-capacitor voltage converter, is a type of DC-DC converter that utilizes “flying” or “pumping” capacitors to store and transfer energy.

In the charge pump, switching transistors are typically used to control different energy storage branches.

However, since the switching transistors generally have a low impedance, excessive currents may occur within the charge pump, leading to reduced reliability and even potential circuit damage.

### SUMMARY

Embodiments of the present disclosure provide a multi-stage charge pump, a chip, and an electronic device. With these technical solutions, in a case where an input voltage is small, an output voltage may be raised to three times the input voltage, such that a high-side switch driver circuit satisfies a drive requirement of a high-side switch.

In a first aspect, the embodiments of the present disclosure provide a multi-stage charge pump. The multi-stage charge pump is applicable to a high-side switch driver circuit. The multi-stage charge pump includes a first charge pump circuit, a second charge pump circuit, and a control circuit; wherein
the first charge pump circuit includes a first switching transistor, a second switching transistor, a third switching transistor, a first capacitor, and a first current output circuit; wherein a control terminal of the first switching transistor, a control terminal of the first current output circuit, and a control terminal of the second charge pump circuit are all electrically connected to the control circuit, a first terminal of the first switching transistor and a second terminal of the third switching transistor are both electrically connected to an input voltage of the multi-stage charge pump, a second terminal of the first switching transistor is electrically connected to an input terminal of the second charge pump circuit, a first terminal of the first capacitor is electrically connected between the second terminal of the first switching transistor and the input terminal of the second charge pump circuit, a second terminal of the first capacitor is electrically connected to a first terminal of the second switching transistor, a control terminal of the second switching transistor is electrically connected to a first terminal of the first current output circuit, a first terminal of the third switching transistor is electrically connected between the second terminal of the first capacitor and the first terminal of the second switching transistor, a second terminal of the first current output circuit, a second terminal of the second switching transistor and a first terminal of the second charge pump circuit are all grounded, and an output terminal of the second charge pump circuit is configured to output an output voltage of the multi-stage charge pump;
the control circuit is configured to, in a case where the input voltage of the multi-stage charge pump is less than a first threshold voltage, control, based on a first-phase clock signal, the first current output circuit to turn on the second switching transistor to charge the first capacitor using the input voltage of the multi-stage charge pump; and control, based on a second-phase clock signal, the second charge pump circuit to be charged using an output voltage of the first charge pump circuit;
in response to the first-phase clock signal, the first switching transistor is turned on, such that the first capacitor starts to be charged; and the second charge pump circuit is configured to boost the output voltage of the first charge pump circuit to obtain the output voltage of the multi-stage charge pump, wherein the output voltage of the multi-stage charge pump is three times the input voltage of the multi-stage charge pump; and
in response to the second-phase clock signal, the third switching transistor is turned on, such that the first charge pump circuit starts boosting the input voltage of the multi-stage charge pump to obtain the output voltage of the first charge pump circuit, and the output voltage of the first charge pump circuit is twice the input voltage of the multi-stage charge pump; and the second charge pump circuit is configured to be charged using the output voltage of the first charge pump circuit;
wherein the first-phase clock signal and the second-phase clock signal do not overlap and each have a duty cycle of 50%, forming a two-phase clock.

In the multi-stage charge pump according to the first aspect, in a case where the input voltage of the multi-stage charge pump is less than the first threshold voltage, the control circuit may control, based on the first-phase clock signal, the first current output circuit to turn on the second switching transistor, such that the first charge pump circuit charges the first capacitor using the input voltage of the multi-stage charge pump, and hence the first charge pump circuit is capable of boosting the input voltage of the multi-stage charge pump. In addition, the control circuit may control, based on the second-phase clock signal, the second charge pump circuit to enter a charging state using the output voltage of the first charge pump circuit, such that the second charge pump circuit is capable of boosting the output voltage of the first charge pump circuit. In this case, under the effect of the first-phase clock signal, the first charge pump circuit may charge the first capacitor using the input voltage of the multi-stage charge pump, and the second charge pump circuit may boost the output voltage of the first charge pump circuit, such that the output voltage of the multi-stage charge pump is obtained. Under the effect of the second-phase clock signal, the first charge pump circuit may boost the input voltage of the multi-stage charge pump, such that the output voltage of the first charge pump circuit is obtained. The second charge pump circuit may be charged using the output voltage of the first charge pump circuit. The output voltage of the first charge pump circuit is twice the input voltage of the multi-stage charge pump. Therefore, the output voltage of the multi-stage charge pump obtained by the second charge pump circuit is three times the input voltage of the multi-stage charge pump. In this way, the multi-stage charge pump is capable of raising the output voltage thereof to three times the input voltage of the multi-stage charge pump, such that the high-side switch driver circuit satisfies the drive requirement of the high-side switch under the effect of the output voltage of the multi-stage charge pump.

In some embodiments, the control circuit is configured to, in a case where the input voltage of the multi-stage charge pump is greater than the first threshold voltage, control the first switching transistor to always remain on, and control the first current output circuit to always remains off; and control, based on the second-phase clock signal, the second charge pump circuit to be charged using the input voltage of the multi-stage charge pump;
in response to the first-phase clock signal, the second charge pump circuit is configured to boost the input voltage of the multi-stage charge pump to obtain the output voltage of the multi-stage charge pump, wherein the output voltage of the multi-stage charge pump is twice the input voltage of the multi-stage charge pump; and
in response to the second-phase clock signal, the third switching transistor is turned on, such that the second charge pump circuit starts to be charged using the input voltage of the multi-stage charge pump.

In some embodiments, the second charge pump circuit includes a fourth switching transistor, a fifth switching transistor, a sixth switching transistor, a seventh switching transistor, a second capacitor, a third capacitor, and a second current output circuit; wherein
a control terminal of the second current output circuit is electrically connected to the control circuit, a first terminal of the fourth switching transistor is electrically connected to the second terminal of the first switching transistor, a second terminal of the fourth switching transistor is electrically connected to a first terminal of the fifth switching transistor, a second terminal of the fifth switching transistor is electrically connected to a first terminal of the second capacitor, a first terminal of the third capacitor is electrically connected between the second terminal of the fourth switching transistor and the first terminal of the fifth switching transistor, a second terminal of the third capacitor is electrically connected to a first terminal of the sixth switching transistor, a control terminal of the sixth switching transistor is electrically connected to a first terminal of the second current output circuit, a first terminal of the seventh switching transistor is electrically connected between the second terminal of the third capacitor and the first terminal of the sixth switching transistor, a second terminal of the seventh switching transistor is electrically connected to a second terminal of the second capacitor, and a second terminal of the second current output circuit and a second terminal of the sixth switching transistor are both grounded;
the control circuit is configured to control, based on the second-phase clock signal, the second current output circuit to be conducted so as to turn on the sixth switching transistor;
in response to the first-phase clock signal, the fifth switching transistor and the seventh switching transistor are both turned on, such that the third capacitor discharges to the second capacitor; and
in response to the second-phase clock signal, the fourth switching transistor is turned on, such that the third capacitor starts to be charged.

In some embodiments, the control circuit includes a first sub-control circuit, a second sub-control circuit, and a third sub-control circuit; wherein
an output terminal of the first sub-control circuit is electrically connected to the control terminal of the first current output circuit, an output terminal of the second sub-control circuit is electrically connected to the control terminal of the second current output circuit, and an output terminal of the third sub-control circuit is electrically connected to the control terminal of the first switching transistor and the control terminal of the first current output circuit;
the first sub-control circuit is configured to, in a case where the input voltage of the multi-stage charge pump is less than the first threshold voltage, control, based on the first-phase clock signal, the first current output circuit to be conducted;
the second sub-control circuit is configured to control, based on the second-phase clock signal, the second current output circuit to be conducted; and
the third sub-control circuit is configured to, in a case where the input voltage of the multi-stage charge pump is greater than the first threshold voltage, control the first switching transistor to always remain on, and control the first current output circuit to always remain off.

In some embodiments, the multi-stage charge pump further includes a first over-voltage protection circuit and a second over-voltage protection circuit; wherein
an input terminal of the first over-voltage protection circuit is electrically connected to the first terminal of the first capacitor, an output terminal of the first over-voltage protection circuit is electrically connected to an input terminal of the first sub-control circuit, an input terminal of the second over-voltage protection circuit is electrically connected to the first terminal of the third capacitor, and an output terminal of the second over-voltage protection circuit is electrically connected to an input terminal of the second sub-control circuit;
the first over-voltage protection circuit is configured to, in a case where a voltage stored on the first capacitor is greater than a first predetermined voltage, transmit a first over-voltage protection signal to the first sub-control circuit, wherein the first over-voltage protection signal is used to cut off the first current output circuit; and
the second over-voltage protection circuit is configured to, in a case where a voltage stored on the third capacitor is greater than a second predetermined voltage, transmit a second over-voltage protection signal to the second current output circuit, wherein the second over-voltage protection signal is used to cut off the second current output circuit.

In some embodiments, the first current output circuit includes a constant-current source, a first transistor, a second transistor, and a third transistor; wherein
an output terminal of the constant-current source is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded; and
the constant-current source is configured to output a first charge current, wherein a current value of the first charge current is greater than a maximum current value of a second charge current output by the second current output circuit.

In some embodiments, the second current output circuit includes a first sampling circuit, an operational amplifier, a fourth transistor, a fifth transistor, and a sixth transistor; wherein
an input terminal of the first sampling circuit is electrically connected to the first terminal of the second capacitor, an output terminal of the first sampling circuit is electrically connected to a first input terminal of the operational amplifier, a second input terminal of the operational amplifier is electrically connected to a reference voltage, an output terminal of the operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the first sampling circuit is configured to sample a voltage stored on the second capacitor, and transmit the voltage stored on the second capacitor to the operational amplifier; and
the operational amplifier is configured to regulate a magnitude of the second charge current based on the voltage stored on the second capacitor and the reference voltage.

In some embodiments, the multi-stage charge pump further includes an over-voltage protection circuit; wherein
an input terminal of the over-voltage protection circuit is electrically connected to the first terminal of the third capacitor, and an output terminal of the over-voltage protection circuit is electrically connected to the second sub-control circuit; and
the over-voltage protection circuit is configured to, in a case where a voltage stored on the third capacitor is greater than a predetermined voltage, transmit an over-voltage protection signal to the second current output circuit, wherein the over-voltage protection signal is used to cut off the second current output circuit.

In some embodiments, the first current output circuit includes a first sampling circuit, a first operation amplifier, a first transistor, a second transistor, and a third transistor; wherein
an input terminal of the first sampling circuit is electrically connected to the first terminal of the first capacitor, an output terminal of the first sampling circuit is electrically connected to a first input terminal of the first operational amplifier, a second input terminal of the first operational amplifier is electrically connected to a first reference voltage, an output terminal of the first operational amplifier is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded;
the first sampling circuit is configured to sample a voltage stored on the first capacitor, and transmit the voltage stored on the first capacitor to the first operational amplifier; and
the first operational amplifier is configured to regulate a magnitude of the first charge current based on the voltage stored on the first capacitor and the first reference voltage.

In some embodiments, the second current output circuit includes a second sampling circuit, a second operation amplifier, a fourth transistor, a fifth transistor, and a sixth transistor; wherein
an input terminal of the second sampling circuit is electrically connected to the first terminal of the second capacitor, an output terminal of the second sampling circuit is electrically connected to a first input terminal of the second operational amplifier, a second input terminal of the second operational amplifier is electrically connected to a second reference voltage, an output terminal of the second operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the second sampling circuit is configured to sample a voltage stored on the second capacitor, and transmit the voltage stored on the second capacitor to the second operational amplifier; and
the second operational amplifier is configured to regulate a magnitude of the second charge current based on the voltage stored on the second capacitor and the second reference voltage.

In some embodiments, the multi-stage charge pump further includes an over-voltage protection circuit; wherein
an input terminal of the over-voltage protection circuit is electrically connected to the first terminal of the second capacitor, an input terminal of the first sub-control circuit and an input terminal of the second sub-control circuit are both electrically connected to an output terminal of the over-voltage protection circuit; and
the over-voltage protection circuit is configured to, in a case where a voltage stored on the second capacitor is greater than a predetermined voltage, transmit an over-voltage protection signal to the first sub-control circuit and the second sub-control circuit, wherein the over-voltage protection signal is used for cutting off the first current output circuit and the second current output circuit.

In some embodiments, the first current output circuit includes a first sampling circuit, a first operation amplifier, a first transistor, a second transistor, and a third transistor; wherein
an input terminal of the first sampling circuit is electrically connected to the first terminal of the first capacitor, an output terminal of the first sampling circuit is electrically connected to a first input terminal of the first operational amplifier, a second input terminal of the first operational amplifier is electrically connected to a first reference voltage, an output terminal of the first operational amplifier is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded;
the first sampling circuit is configured to sample a voltage stored on the first capacitor, and transmit the voltage stored on the first capacitor to the first operational amplifier; and
the first operational amplifier is configured to regulate a magnitude of the first charge current based on the voltage stored on the first capacitor and the first reference voltage.

In some embodiments, the second current output circuit includes a second sampling circuit, a second operation amplifier, a fourth transistor, a fifth transistor, and a sixth transistor; wherein
an input terminal of the second sampling circuit is electrically connected to the first terminal of the third capacitor, an output terminal of the second sampling circuit is electrically connected to a first input terminal of the second operational amplifier, a second input terminal of the second operational amplifier is electrically connected to a second reference voltage, an output terminal of the second operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the second sampling circuit is configured to sample a voltage stored on the third capacitor, and transmit the voltage stored on the third capacitor to the second operational amplifier; and
the second operational amplifier is configured to regulate a magnitude of the second charge current based on the voltage stored on the third capacitor and the second reference voltage.

In some embodiments, the multi-stage charge pump further includes a gate driver device; wherein
the gate driver device is electrically connected to a control terminal of a P-type switching transistor in the multi-stage charge pump; and
the gate driver device is configured to transmit the first-phase clock signal and the second-phase clock signal to the multi-stage charge pump.

In some embodiments, the gate driver device includes a driver circuit, a level conversion circuit, a first series branch, a second series branch, a fourth capacitor, a fifth capacitor, a seventh transistor, an eighth transistor, a ninth transistor, a tenth transistor, and an inverter; wherein
a power terminal of the driver circuit, a power terminal of the level conversion circuit, a power terminal of the first series branch, a power terminal of the second series branch, a first terminal of the fourth capacitor, a first terminal of the fifth capacitor, a first terminal of the seventh transistor, a first terminal of the eighth transistor, and a first terminal of the ninth transistor are all electrically connected to a high-side power supply voltage, an input terminal of the level conversion circuit is configured to receive a phase control signal, an output terminal of the level conversion circuit is electrically connected to an input terminal of the driver circuit, and an output terminal of the driver circuit and a second terminal of the eighth transistor are both electrically connected to a control terminal of a P-type switching transistor in the multi-stage charge pump;
the first series branch includes a node, a first terminal of the first series branch is electrically connected to an enable signal output circuit, the node is electrically connected to a second terminal of the ninth transistor and a control terminal of the tenth transistor, a second terminal of the tenth transistor, a ground terminal of the level conversion circuit, a ground terminal of the driver circuit, and a second terminal of the seventh transistor are all electrically connected to a high-side ground voltage, and a second terminal of the fifth capacitor is electrically connected to a second terminal of the first series branch;
a first terminal of the second series branch is electrically connected to an output terminal of the inverter, an input terminal of the inverter is electrically connected to the enable signal output circuit, a second terminal of the second series branch is electrically connected to a second terminal of the fourth capacitor, a control terminal of the seventh transistor, a control terminal of the eighth transistor, and a control terminal of the ninth transistor, a third terminal of the second series branch and a third terminal of the first series branch are both electrically connected to a bias voltage, and a fourth terminal of the second series branch, a fourth terminal of the first series branch, and a first terminal of the tenth transistor are all grounded;
the first series branch is configured to, upon acquisition of an enable signal from the enable signal output circuit, pull down a voltage at the node in response to the enable signal being at a high level;
the tenth transistor is configured to, upon pulldown of the voltage at the node, pull down a potential of the high-side ground voltage to obtain a voltage domain, wherein a voltage within the voltage domain is greater than a second threshold voltage, and the voltage at the node changes with the high-side power supply voltage via the fifth capacitor;
the inverter is configured to invert the enable signal to obtain an inverted enable signal, and transmit the inverted enable signal to the second series branch; and
the second series branch is configured control, based on the inverted enable signal, the seventh transistor, the eighth transistor, and the ninth transistor to be turned on or turned off, wherein a voltage at the control terminal of the seventh transistor, a voltage at the control terminal of the eighth transistor, and a voltage at the control terminal of the ninth transistor change with the high-side power supply voltage via the fourth capacitor.

Upon acquisition of the enable signal from the enable signal output circuit, the first series branch may pull down the voltage at the node in response to the enable signal being at a high level, such that the tenth transistor is turned on. In this way, the tenth transistor may pull down the potential of the high-side ground voltage to obtain the voltage domain. Since the voltage at the node changes with the high-side power supply voltage via the fifth capacitor, the voltage domain remains stable, and hence the gate driver circuit exhibits good transient characteristics. The inverter may invert the enable signal to obtain an inverted enable signal, and may transmit the inverted enable signal to the second series branch, such that the second series branch acquires the inverted enable signal. In this way, the second series branch may control, based on the inverted enable signal, the seventh transistor, the eighth transistor, and the ninth transistor to be turned on or turned off. Since the voltage at the control terminal of the seventh transistor, the voltage at the control terminal of the eighth transistor, and the voltage at the control terminal of the ninth transistor may change with the high-side power supply voltage via the fourth capacitor, in a case where the high-side power supply voltage undergoes a rapid transient, the seventh transistor, the eighth transistor, and the ninth transistor may not be falsely turned on or turned off. In this way, the switching transistors in the multi-stage charge pump are prevented from being falsely turned on or turned off.

In some embodiments, the gate driver device further includes a first resistor, a second resistor, and a third resistor;
wherein a first terminal of the first resistor, a first terminal of the second resistor, and a first terminal of the third resistor are all electrically connected to the high-side power supply voltage, a second terminal of the first resistor is electrically connected to the second terminal of the first series branch, a second terminal of the second resistor is electrically connected to the high-side ground voltage, and a second terminal of the third resistor is electrically connected to the output terminal of the driver circuit.

In some embodiments, the first series branch includes a first N-type transistor, a second N-type transistor, a first diode, and a first current source;
wherein a first terminal of the first diode is electrically connected to the high-side power supply voltage, a second terminal of the first diode is electrically connected to a first terminal of the first N-type transistor, the node is arranged between the second terminal of the first diode and the first terminal of the first N-type transistor, a second terminal of the first N-type transistor is electrically connected to a first terminal of the second N-type transistor, a second terminal of the second N-type transistor is electrically connected to a first terminal of the first current source, a second terminal of the first current source is grounded, a control terminal of the first N-type transistor is electrically connected to the bias voltage, and a control terminal of the second N-type transistor is electrically connected to the enable signal output circuit.

In some embodiments, a withstand voltage of the first N-type transistor is greater than a predetermined withstand voltage.

In some embodiments, the gate driver device further includes a depletion-mode transistor; wherein a first terminal of the depletion-mode transistor is electrically connected to the high-side power supply voltage, a control terminal of the depletion-mode transistor is electrically connected to the second terminal of the first diode, and a second terminal of the depletion-mode transistor is electrically connected to the second terminal of the tenth transistor.

In some embodiments, the second series branch includes a fourth resistor, a third N-type transistor, a fourth N-type transistor, and a second current source;
wherein a first terminal of the fourth resistor is electrically connected to the high-side power supply voltage, a second terminal of the fourth resistor is electrically connected to a first terminal of the third N-type transistor, a second terminal of the third N-type transistor is electrically connected to a first terminal of the fourth N-type transistor, a second terminal of the fourth N-type transistor is electrically connected to a first terminal of the second current source, a second terminal of the second current source is grounded, a control terminal of the third N-type transistor is electrically connected to the bias voltage, and a control terminal of the fourth N-type transistor is electrically connected to the output terminal of the inverter.

In some embodiments, a withstand voltage of the third N-type transistor is greater than a predetermined withstand voltage.

In some embodiments, the gate driver device further includes a second diode;
wherein a first terminal of the second diode is electrically connected to the high-side power supply voltage, and a second terminal of the second diode is electrically connected to the control terminal of the seventh transistor.

In some embodiments, a withstand voltage of the tenth N-type transistor is greater than a predetermined withstand voltage.

In a second aspect, the embodiments of the present disclosure provide a chip. The chip includes the multi-stage charge pump according to the first aspect and any embodiment of the first aspect.

For details about the beneficial effects achieved by the chip according to the second aspect, reference may be made to the beneficial effects achieved by the first aspect or any embodiment of the first aspect, or reference may be made to the beneficial effects achieved by the second aspect, which are not described herein any further.

In a third aspect, the embodiments of the present disclosure provide an electronic device. The electronic device includes the chip according to the second aspect.

Embodiments of the present disclosure further provide a current limiting circuit, a charge pump, a chip, and an electronic device. With these technical solutions, a magnitude of an on current of a body diode of a power transistor may be controlled.

In a fourth aspect, the embodiments of the present disclosure provide a current limiting circuit applicable to a charge pump. The current limiting circuit includes a first current output circuit, a second current output circuit, and a current limiting assembly; wherein
an output terminal of the first current output circuit is electrically connected to a first terminal of the second current output circuit, a second terminal of the second current output circuit is electrically connected to a control terminal of the current limiting assembly, a third terminal of the second current output circuit and a first terminal of the current limiting assembly are both electrically connected to a node in the charge pump, a second terminal of the current limiting assembly is electrically connected to a second terminal of a P-type power transistor in the charge pump, and a ground terminal of the first current output circuit and a ground terminal of the second current output circuit are both grounded;
the first current output circuit is configured to transmit a first current to the second current output circuit, wherein the first current acts as a reference current;
the second current output circuit is configured to acquire a second current based on the first current, and transmit the second current to the current limiting assembly; and
the current limiting assembly is configured to control a current flowing through a body diode, in response to being turned on, of a power transistor in the charge pump to be less than or equal to the second current.

In the current limiting circuit according to the fourth aspect, the first current output circuit may transmit the first current acting as the reference current to the second current output circuit, such that the second current output circuit obtains the first current. In this case, the second current output circuit may obtain the second current based on the first current, and transmit the second current to the current limiting assembly, such that the current limiting assembly controls a current flowing through a body diode, in response to being turned on, of a power transistor in the charge pump to be less than or equal to the second current. Hence, the current limiting assembly may control the current flowing through the body diode, in response to being turned on, of the power transistor in the charge pump to be less than or equal to the second current. In this way, the current flowing through the body diode, in response to being turned on, of the power transistor in the charge pump is controllable.

In some embodiments, the current limiting circuit further includes a regulation circuit; wherein
a first terminal of the regulation circuit is electrically connected to the first terminal of the second current output circuit, a control terminal of the regulation circuit is configured to receive a control signal, a second terminal of the regulation circuit is electrically connected to a fourth terminal of the second current output circuit, and a ground terminal of the regulation circuit is grounded;
the second current output circuit is further configured to transmit the second current to the regulation circuit; and
the regulation circuit is configured to regulate a magnitude of the second current under an effect of the control signal.

In some embodiments, the regulation circuit includes at least one current mirror assembly; wherein
a first terminal of the current mirror assembly is electrically connected to the fourth terminal of the second current output circuit, a control terminal of the current mirror assembly is configured to receive the control signal, a second terminal of the current mirror assembly is electrically connected to the first terminal of the second current output circuit, and a third terminal of the current mirror assembly is grounded; and
the current mirror assembly is configured to mirror the second current under the effect of the control signal.

In some embodiments, the current mirror assembly includes a first switching transistor and a second switching transistor;
wherein a second terminal of the first switching transistor is electrically connected to the fourth terminal of the second current output circuit, a control terminal of the first switching transistor is configured to receive the control signal, a first terminal of the first switching transistor is electrically connected to a second terminal of the second switching transistor, a control terminal of the second switching transistor is electrically connected to the first terminal of the second current output circuit, and a first terminal of the second switching transistor is grounded.

In some embodiments, the current limiting circuit further includes a power transistor; wherein a first terminal of the power transistor is electrically connected to the second terminal of the current limiting assembly, a second terminal of the power transistor is electrically connected to a first terminal of the P-type transistor in the charge pump, and a control terminal of the power transistor is electrically connected to a driver circuit in the charge pump.

In some embodiments, the second current output circuit includes a third switching transistor, a fourth switching transistor, and a fifth switching transistor;
wherein a control terminal of the third switching transistor is electrically connected to the output terminal of the first current output circuit, a first terminal of the third switching transistor is grounded, a second terminal of the third switching transistor is electrically connected to a first terminal of the fourth switching transistor, a control terminal of the fourth switching transistor is configured to receive a bias voltage, a second terminal of the fourth switching transistor is electrically connected to a second terminal of the fifth switching transistor, a control terminal of the fifth switching transistor, and the control terminal of the current limiting assembly, and a first terminal of the fifth switching transistor is electrically connected to a node in the charge pump.

In some embodiments, the second current output circuit further includes a capacitor; wherein a first terminal of the capacitor is electrically connected to the first terminal of the fifth switching transistor, and a second terminal of the capacitor is electrically connected between the second terminal of the fifth switching transistor and the second terminal of the fourth switching transistor.

In some embodiments, the first current output circuit includes a current source and a sixth switching transistor;
wherein an output terminal of the current source is electrically connected to a second terminal of the sixth switching transistor, a control terminal of the sixth switching transistor is electrically connected between the output terminal of the current source and a first terminal of the sixth switching transistor, the control terminal of the sixth switching transistor is further electrically connected to the first terminal of the second current output circuit, and the first terminal of the sixth switching transistor is grounded.

In some embodiments, the current limiting assembly further includes a P-type transistor; wherein a first terminal of the P-type transistor is electrically connected to a node in the charge pump, and a second terminal of the P-type transistor is electrically connected to the second terminal of the P-type power transistor in the charge pump.

In a fifth aspect, the embodiments of the present disclosure provide a charge pump. The charge pump includes a first P-type power transistor, a second P-type power transistor, a third P-type power transistor, a fourth P-type power transistor, a fifth P-type power transistor, a first N-type power transistor, a second N-type power transistor, a first capacitor, a second capacitor, a third capacitor, a first control circuit, a second control circuit, a driver circuit, and at least one current limiting circuit according to the fourth aspect or any embodiment of the fourth aspect; wherein
a control terminal of the first P-type power transistor, a control terminal of the second P-type power transistor, a control terminal of the third P-type power transistor, a control terminal of the fourth P-type power transistor, and a control terminal of the fifth P-type power transistor are all electrically connected to the driver circuit, a second terminal of the first P-type power transistor and a first terminal of the third P-type power transistor are both connected to an input voltage of the charge pump, a second terminal of the first P-type power transistor is electrically connected to a second terminal of the second P-type power transistor, and a first terminal of the second P-type power transistor is electrically connected to a second terminal of the fourth P-type power transistor;
a first terminal of the first capacitor is electrically connected between the second terminal of the first P-type power transistor and the second terminal of the second P-type power transistor, a second terminal of the first capacitor is electrically connected to a second terminal of the first N-type power transistor, a second terminal of the third P-type power transistor is electrically connected between the second terminal of the first capacitor, and the second terminal of the first N-type power transistor, a control terminal of the first N-type power transistor is electrically connected to the first control circuit, and a first terminal of the first N-type power transistor and a first terminal of the second N-type power transistor are both grounded;
a first terminal of the second capacitor is electrically connected between the first terminal of the second P-type power transistor and the second terminal of the fourth P-type power transistor, a second terminal of the second capacitor is electrically connected to a second terminal of the second N-type power transistor, a second terminal of the fifth P-type power transistor is electrically connected between the second terminal of the second capacitor and the second terminal of the second N-type power transistor, and a control terminal of the second N-type power transistor is electrically connected to the second control circuit;
a first terminal of the third capacitor is electrically connected to a first terminal of the fourth P-type power transistor, and a second terminal of the third capacitor is electrically connected to a first terminal of the fifth P-type power transistor; and
the charge pump includes a plurality of nodes, wherein the plurality of nodes includes the first terminal of the first capacitor, the first terminal of the second capacitor, and the first terminal of the third capacitor, and the at least one current limiting circuit is electrically connected to at least one of the plurality of nodes.

For details about the beneficial effects achieved by the charge pump according to the fifth aspect or any embodiment of the fifth aspect, reference may be made to the beneficial effects achieved by the first aspect or any embodiment of the first aspect, which are not described herein any further.

In a sixth aspect, the embodiments of the present disclosure provide a chip. The chip includes the current limiting circuit according to the fourth aspect and any embodiment of the fourth aspect, or the charge pump according to the second aspect.

In a seventh aspect, the embodiments of the present disclosure provide an electronic device. The electronic device includes the chip according to the sixth aspect.

Embodiments of the present disclosure further provide a driver circuit, a charge pump, a chip. With these technical solutions, the problem that reliability of the charge pump is low is addressed.

In an eighth aspect, the embodiments of the present disclosure provide a driver circuit applicable to a charge pump. The charge pump includes energy storage branches in at least two stages; wherein an output terminal of the energy storage branch in a previous stage is electrically connected to an input terminal of the energy storage branch in a subsequent stage, each of the energy storage branches in at least two stages includes at least one switching transistor and a capacitor, an output terminal of the driver circuit is electrically connected to a control terminal of at least one switching transistor in a first-stage energy storage branch, and the energy storage branches in at least two stages include the first-stage energy storage branch;
the driver circuit includes a Zener diode, a voltage divider circuit, a current source, a level conversion circuit, a first switching transistor, and a second switching transistor; wherein
an input terminal of the level conversion circuit is configured to receive a first-phase clock signal, an output terminal of the level conversion circuit is the output terminal of the driver circuit, a first power supply terminal of the level conversion circuit is configured to receive a power supply voltage, a second power supply terminal of the level conversion circuit is electrically connected to a second terminal of the first switching transistor, a control terminal of the first switching transistor is electrically connected to an output terminal of the voltage divider circuit, a first terminal of the first switching transistor is electrically connected to a second terminal of the second switching transistor, a control terminal of the second switching transistor is electrically connected to a positive terminal of the Zener diode, a first terminal of the second switching transistor is grounded, a negative terminal of the Zener diode is configured to receive a power supply voltage, the positive terminal of the Zener diode is grounded via the current source, the voltage divider circuit and the Zener diode are connected in parallel; the voltage divider circuit is configured to divide a voltage across the two terminals of the Zener diode, and output a divided voltage at the output terminal of the voltage divider circuit, such that a voltage at the second terminal of the first switching transistor is greater than a difference between the power supply voltage and the divided voltage; and
the level conversion circuit is configured to convert a level value of the first-phase clock signal, and output a converted first-phase clock signal at the output terminal of the level conversion circuit, wherein a level value of the converted first-phase clock signal is within a value range from the power supply voltage to the voltage at the second terminal of the first switching transistor.

In some embodiments, the voltage divider circuit includes a first resistor and a second resistor that are connected in series; wherein a first terminal of the first resistor is electrically connected to the negative terminal of the Zener diode, a second terminal of the first resistor is electrically connected to a first terminal of the second resistor, a second terminal of the second resistor is electrically connected to the positive terminal of the Zener diode, and a first terminal of the second resistor is electrically connected to the control terminal of the first switching transistor.

In some embodiments, the level conversion circuit includes a level converter and series-connected inverters in a plurality of stages that are connected sequentially, wherein an input terminal of the level converter is configured to receive the first-phase clock signal, and an output terminal of the inverter in a last stage in the series-connected inverters in the plurality of stages is the output terminal of the driver circuit.

In the driver circuit applicable to the charge pump according to the present disclosure, in the energy storage branch in any stage of the charge pump, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In a ninth aspect, the embodiments of the present disclosure provide a charge pump. The charge pump includes a driver circuit and energy storage branches in at least two stages; wherein an output terminal of the energy storage branch in a previous stage is electrically connected to an input terminal of the energy storage branch in a subsequent stage, each of the energy storage branches in at least two stages includes at least one switching transistor and a capacitor, an output terminal of the driver circuit is electrically connected to a control terminal of at least one switching transistor in a first-stage energy storage branch, and the energy storage branches in at least two stages include the first-stage energy storage branch and a second-stage energy storage branch; and
the driver circuit is the driver circuit according to the eighth aspect.

In some embodiments, the first-stage energy storage branch includes a third switching transistor and a first capacitor, wherein a first terminal of the third switching transistor is configured to receive an input voltage; and a second terminal of the third switching transistor is electrically connected to the top plate of the first capacitor; and
the driver circuit includes a first driver circuit, wherein an output terminal of the first driver circuit is electrically connected to a control terminal of the third switching transistor, and a power supply voltage of the first driver circuit comes from the top plate of the first capacitor.

In some embodiments, the charge pump further includes a third resistor, wherein the second terminal of the third switching transistor is electrically connected to a top plate of the first capacitor via the third resistor.

In some embodiments, the second-stage energy storage branch includes a fourth switching transistor and a second capacitor, wherein a top plate of the second capacitor is electrically connected to the top plate of the first capacitor via the fourth switching transistor; and
the driver circuit includes a second driver circuit, wherein an output terminal of the second driver circuit is electrically connected to a control terminal of the fourth switching transistor, and a power supply voltage of the second driver circuit comes from the top plate of the second capacitor.

In some embodiments, the charge pump further includes a fourth resistor, wherein a second terminal of the fourth switching transistor is electrically connected to the top plate of the second capacitor via the fourth resistor.

In some embodiments, the second-stage energy storage branch further includes a fifth switching transistor, wherein a bottom plate of the second capacitor is electrically connected to a bottom plate of the first capacitor via the fifth switching transistor; and
the driver circuit includes a third driver circuit, wherein an output terminal of the third driver circuit is electrically connected to a control terminal of the fifth switching transistor, and a power supply voltage of the third driver circuit comes from the input voltage.

In some embodiments, the charge pump further includes a fifth resistor, wherein a second terminal of the fifth switching transistor is electrically connected to a bottom plate of the second capacitor via the fifth resistor.

In the charge pump according to the present disclosure, in the energy storage branch in any stage, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In a tenth aspect, the embodiments of the present disclosure provide a charge pump. The charge pump further includes a control circuit; and the first-stage energy storage branch includes a third switching transistor, a sixth switching transistor, a fifth switching transistor, a first capacitor, and a first current output circuit; wherein a control terminal of the third switching transistor, a control terminal of the first current output circuit, and a control terminal of the second-stage energy storage branch are all electrically connected to the control circuit, a first terminal of the third switching transistor and a second terminal of the fifth switching transistor are both electrically connected to an input voltage, a second terminal of the third switching transistor is electrically connected to an input terminal of the second-stage energy storage branch, a first terminal of the first capacitor is electrically connected between the second terminal of the third switching transistor and the input terminal of the second-stage energy storage branch, a second terminal of the first capacitor is electrically connected to a first terminal of the sixth switching transistor, a control terminal of the sixth switching transistor is electrically connected to a first terminal of the first current output circuit, a first terminal of the fifth switching transistor is electrically connected between the second terminal of the first capacitor and the first terminal of the sixth switching transistor, a second terminal of the first current output circuit, a second terminal of the sixth switching transistor and a first terminal of the second-stage energy storage branch are all grounded, and an output terminal of the second-stage energy storage branch is configured to output an output voltage of the charge pump;
the control circuit is configured to, in a case where the input voltage of the charge pump is less than a first threshold voltage, control, based on a first-phase clock signal, the first current output circuit to turn on the sixth switching transistor to charge the first capacitor using the input voltage of the charge pump; and control, based on a second-phase clock signal, the second-stage energy storage branch to be charged using an output voltage of the first-stage energy storage branch;
in response to the first-phase clock signal, the third switching transistor is turned on, such that the first capacitor starts to be charged; and the second-stage energy storage branch is configured to boost the output voltage of the first-stage energy storage branch to obtain the output voltage of the charge pump, wherein the output voltage of the charge pump is three times the input voltage of the charge pump; and
in response to the second-phase clock signal, the fifth switching transistor is turned on, such that the first charge pump circuit starts boosting the input voltage of the multi-stage charge pump to obtain the output voltage of the first charge pump circuit, and the output voltage of the first charge pump circuit is twice the input voltage of the multi-stage charge pump; and the second charge pump circuit is configured to be charged using the output voltage of the first charge pump circuit;
wherein the first-phase clock signal and the second-phase clock signal do not overlap and each have a duty cycle of 50%, forming a two-phase clock.

In some embodiments, the charge pump further includes a third resistor, wherein the second terminal of the third switching transistor is electrically connected to a top plate of the first capacitor via the third resistor.

In some embodiments, the second-stage energy storage branch includes a fourth switching transistor and a second capacitor, wherein a top plate of the second capacitor is electrically connected to the top plate of the first capacitor via the fourth switching transistor; and
the driver circuit includes a second driver circuit, wherein an output terminal of the second driver circuit is electrically connected to a control terminal of the fourth switching transistor, and a power supply voltage of the second driver circuit comes from the top plate of the second capacitor.

In some embodiments, the charge pump further includes a fourth resistor, wherein a second terminal of the fourth switching transistor is electrically connected to the top plate of the second capacitor via the fourth resistor.

In some embodiments, the second-stage energy storage branch further includes a fifth switching transistor, wherein a bottom plate of the second capacitor is electrically connected to a bottom plate of the first capacitor via the fifth switching transistor; and
the driver circuit includes a third driver circuit, wherein an output terminal of the third driver circuit is electrically connected to a control terminal of the fifth switching transistor, and a power supply voltage of the third driver circuit comes from the input voltage.

In some embodiments, the charge pump further includes a fifth resistor, wherein a second terminal of the fifth switching transistor is electrically connected to a bottom plate of the second capacitor via the fifth resistor.

In an eleventh aspect, the embodiments of the present disclosure provide a chip. The chip includes the driver circuit according to the eighth aspect.

In the chip according to the present disclosure, in the energy storage branch in any stage of the charge pump, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relative small, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In a twelfth aspect, the embodiments of the present disclosure provide a chip. The chip includes the charge pump according to the ninth aspect.

In a thirteenth aspect, the embodiments of the present disclosure provide a chip. The chip includes the charge pump according to the tenth aspect.

In the chip according to the present disclosure, in the energy storage branch in any stage, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In a fourteenth aspect, the embodiments of the present disclosure provide an electronic device. The electronic device includes the driver circuit according to the eighth aspect.

In the electronic device according to the present disclosure, in the energy storage branch in any stage of the charge pump, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In a fifteenth aspect, the embodiments of the present disclosure provide a chip. The chip includes the charge pump according to the ninth aspect.

In a sixteenth aspect, the embodiments of the present disclosure provide an electronic device. The electronic device includes the charge pump according to the tenth aspect.

In the electronic device according to the present disclosure, in the energy storage branch in any stage, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

### BRIEF DESCRIPTION OF THE DRAWINGS

FIG. 1 is a schematic structural diagram of a charge pump in the related art;

FIG. 2 is a schematic structural diagram of a multi-stage charge pump according to some embodiments of the present disclosure;

FIG. 3 is a schematic structural diagram of a multi-stage charge pump according to some embodiments of the present disclosure;

FIG. 4 is a schematic structural diagram of a multi-stage charge pump according to some embodiments of the present disclosure;

FIG. 5 is a schematic structural diagram of a multi-stage charge pump according to some embodiments of the present disclosure;

FIG. 6 is a schematic structural diagram of a multi-stage charge pump according to some embodiments of the present disclosure;

FIG. 7 is a schematic structural diagram of a multi-stage charge pump according to some embodiments of the present disclosure;

FIG. 8 is a schematic structural diagram of a gate driver device according to some embodiments of the present disclosure;

FIG. 9 is a schematic structural diagram of a charge pump in the related art;

FIG. 10 is a schematic sectional view of a power transistor in a charge pump in the related art;

FIG. 11 is a schematic structural diagram of a latched path in a charge pump in the related art;

FIG. 12 is a schematic structural diagram of a charge pump according to some embodiments of the present disclosure;

FIG. 13 is a schematic structural diagram of a current limiting circuit according to some embodiments of the present disclosure;

FIG. 14 is a schematic structural diagram of a current limiting circuit according to some embodiments of the present disclosure;

FIG. 15 is a schematic structural diagram of a current limiting circuit according to some embodiments of the present disclosure;

FIG. 16 is a schematic structural diagram of a charge pump in the related art;

FIG. 17 is a schematic structural diagram of a charge pump according to some embodiments of the present disclosure;

FIG. 18 is a schematic structural diagram of a charge pump according to some embodiments of the present disclosure; and

FIG. 19 is a schematic structural diagram of a charge pump according to some embodiments of the present disclosure.

### DETAILED DESCRIPTION

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

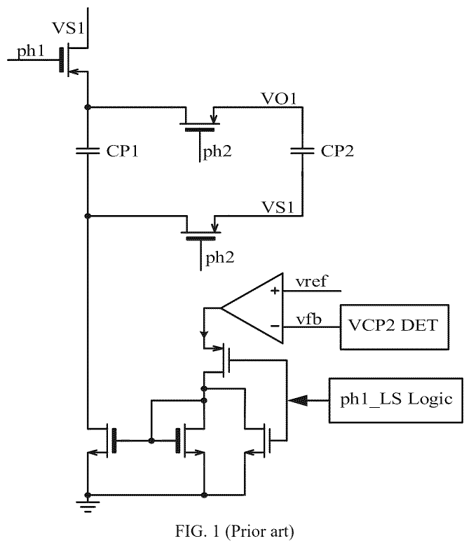

FIG. 1 is a schematic structural diagram of a charge pump in the related art. As illustrated in FIG. 1, switching transistors are turned on during a PH1 phase and a PH2 phase. In this case, during the PH1 phase, an input voltage VS1 stores energy to (charges) a capacitor CP1, such that a voltage VCP1 stored on the capacitor CP1 may be up to VS1. During the PH2 phase, the capacitor CP1 discharges to a capacitor CP2. In addition, the capacitor CP2 controls, via a feedback circuit VCP2 DET, a charge current of the capacitor CP1 to regulate the voltage VCP1 stored on the capacitor CP1, such that a voltage VCP2 stored on the capacitor CP2 is equal to the voltage VCP1 stored on the capacitor CP1. Thus, an output voltage VO1 is equal to a sum of the input voltage VS1 and the voltage VCP1 stored on the capacitor CP1. Since the voltage VCP1 stored on the capacitor CP1 may be up to the input voltage VS1, in an ideal situation without any load, a maximum value of the output voltage VO1 is twice the input voltage VS1.

However, in a case where the input voltage VS1 is relatively low, the output voltage VO1 is also relatively low, and as a result, an overdrive voltage of a high-side switch is relatively low, that is, VGS−VTH is also relatively low. VGS represents a gate-source voltage of the high-side switch, and VTH represents a threshold voltage of the high-side switch. Hence, an on-resistance (impedance) of the high-side switch becomes larger. Consequently, a high-side switch driver circuit fails to satisfy the drive requirement of the high-side switch.

In addition, since voltage rails of switching transistors in the charge pump are different, the voltage rails of some of the switching transistors undergo a rapid transient. Where a gate driver circuit does not exhibit good transient characteristics, the switching transistor may be falsely turned on or turned off.

In view of the above technical problems, embodiments of the present disclosure provide a multi-stage charge pump, a chip, and an electronic device.

The multi-stage charge pump is applicable to a high-side switch driver circuit, such that an output voltage of the multi-stage charge pump is capable of supplying power to the high-side switch driver circuit. Thus, under the effect of the output voltage of the multi-stage charge pump, the high-side switch driver circuit is capable of driving the high-side switch.

The multi-stage charge pump may be a chip or a circuit module.

In the present disclosure, the electronic device may include, but is not limited to, a charger, a tablet computer, a smart home device, a vehicle, and a wearable device.

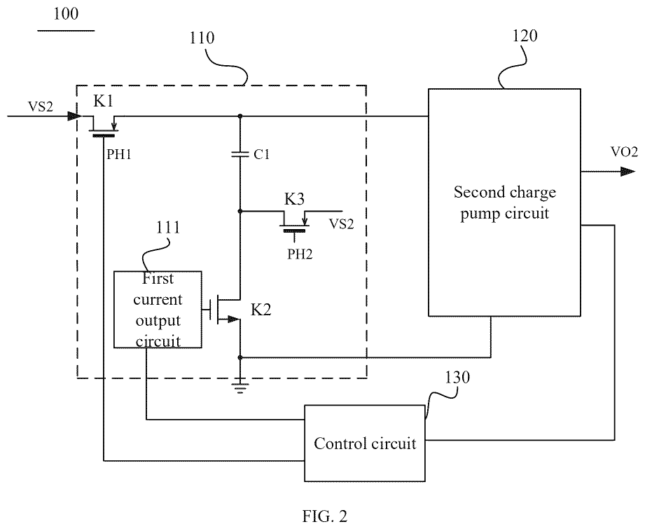

FIG. 2 is a schematic structural diagram of a multi-stage charge pump 100 according to some embodiments of the present disclosure. As illustrated in FIG. 2, the multi-stage charge pump 100 may include a first charge pump circuit 110, a second charge pump circuit 120, and a control circuit 130.

The first charge pump circuit 110 includes a first switching transistor K1, a second switching transistor K2, a third switching transistor K3, a first capacitor C1, and a first current output circuit 111.

A control terminal of the first switching transistor K1, a control terminal of the first current output circuit 111, and a control terminal of the second charge pump circuit 120 are all electrically connected to the control circuit 130, a first terminal of the first switching transistor K1 and a second terminal of the third switching transistor K3 are both electrically connected to an input voltage VS2 of the multi-stage charge pump 100, a second terminal of the first switching transistor K1 is electrically connected to an input terminal of the second charge pump circuit 120, a first terminal of the first capacitor C1 is electrically connected between the second terminal of the first switching transistor K1 and the input terminal of the second charge pump circuit 120, a second terminal of the first capacitor C1 is electrically connected to a first terminal of the second switching transistor K2, a control terminal of the second switching transistor K2 is electrically connected to a first terminal of the first current output circuit 111, a first terminal of the third switching transistor K3 is electrically connected between the second terminal of the first capacitor C1 and the first terminal of the second switching transistor K2, a second terminal of the first current output circuit 111, a second terminal of the second switching transistor K2 and a first terminal of the second charge pump circuit 120 are all grounded, and an output terminal of the second charge pump circuit 120 is configured to output an output voltage VO2 of the multi-stage charge pump 100.

The first charge pump circuit 110, the second charge pump circuit 120, and the control circuit 130 may be arranged separately, or may be integrated.

A first-phase clock signal PH1 and a second-phase clock signal PH2 do not overlap and each have a duty cycle of 50%, forming a two-phase clock. The multi-stage charge pump 100 is controlled by the first-phase clock signal PH1 and the second-phase clock signal PH2, that is, the switching transistors in the first charge pump circuit 110 and the second charge pump circuit 120 are alternately turned on at a duty cycle of 50%.

In response to the first-phase clock signal PH1, the first charge pump circuit 110 is in a charging phase, and the second charge pump circuit 120 is in a discharging phase. In response to the second-phase clock signal PH2, the first charge pump circuit 110 is in a discharge phase, and the second charge pump circuit 120 is in a charging phase.

In a case where the input voltage VS2 of the multi-stage charge pump 100 is less than a first threshold voltage, that is, the input voltage VS2 of the multi-stage charge pump 100 is small, in response to the first-phase clock signal PH1, the control circuit 130 may control the first current output circuit 111 to be conducted, such that the second switching transistor K2 is turned on. In this way, under the effect of the first-phase clock signal PH1, the first switching transistor K1 is turned on, such that the input voltage VS2 of the multi-state charge pump 100 may charge the first capacitor C1, and hence the first charge pump circuit 110 is in the charging phase. Further, the first charge pump circuit 110 is capable of charging the first capacitor C1 using the input voltage VS2 of the multi-stage charge pump 100. Under the effect of the second-phase clock signal PH2, the control circuit 130 may control the second charge pump circuit 120 to use an output voltage of the first charge pump circuit 110, that is, a voltage at the first terminal of the first capacitor C1 enters a charging state, such that the second charge pump circuit 120 is in the charging phase.

Under the effect of the first-phase clock signal PH1, the second switching transistor K2 and the first switching transistor K1 are both in a turned-on state. Therefore, the input voltage VS2 of the multi-stage charge pump 100 may charge the first capacitor C1, such that a voltage stored on the first capacitor C1 may be up to the input voltage VS2 of the multi-stage charge pump 100. Meanwhile, the second charge pump circuit 120 is in the discharging phase, and the second charge pump circuit 120 may boost the output voltage of the first charge pump circuit 110 to obtain the output voltage VO2 of the multi-stage charge pump 100. The output voltage of the first charge pump circuit 110 is twice the input voltage VS2 of the multi-stage charge pump 100. Therefore, the output voltage of the multi-stage charge pump 100 is three times the input voltage VS2 of the multi-stage charge pump 100.

Under the effect of the second-phase clock signal PH2, the first charge pump circuit 110 is in the discharging phase, and the third switching transistor K3 is turned on, such that the first charge pump circuit 110 boost the input voltage VS2 of the multi-stage charge pump 100 to obtain the output voltage of the first charge pump circuit 110, that is, the voltage at the first terminal of the first capacitor C1. The voltage stored on the first capacitor C1 may be up to the input voltage VS2 of the multi-stage charge pump 100, and the second terminal of the third switching transistor K3 is electrically connected to the input voltage VS2 of the multi-stage charge pump 100. Therefore, the voltage at the first terminal of the first capacitor C1 may be up to twice the input voltage VS2 of the multi-stage charge pump 100. Meanwhile, the second charge pump circuit 120 is in the charging phase, and the second charge pump circuit 120 may be charged using the output voltage of the first charge pump circuit 110, that is, the voltage at the first terminal of the first capacitor C1.

Embodiments of the present disclosure provide a multi-stage charge pump, a chip, and an electronic device. In a case where the input voltage of the multi-stage charge pump is less than the first threshold voltage, the control circuit may control, based on the first-phase clock signal, the first current output circuit to turn on the second switching transistor, such that the first charge pump circuit charges the first capacitor using the input voltage of the multi-stage charge pump, and hence the first charge pump circuit is capable of boosting the input voltage of the multi-stage charge pump. In addition, the control circuit may control, based on the second-phase clock signal, the second charge pump circuit to enter a charging state using the output voltage of the first charge pump circuit, such that the second charge pump circuit is capable of boosting the output voltage of the first charge pump circuit. In this case, under the effect of the first-phase clock signal, the first charge pump circuit may charge the first capacitor using the input voltage of the multi-stage charge pump, and the second charge pump circuit may boost the output voltage of the first charge pump circuit, such that the output voltage of the multi-stage charge pump is obtained. Under the effect of the second-phase clock signal, the first charge pump circuit may boost the input voltage of the multi-stage charge pump, such that the output voltage of the first charge pump circuit is obtained. The second charge pump circuit may be charged using the output voltage of the first charge pump circuit. The output voltage of the first charge pump circuit is twice the input voltage of the multi-stage charge pump. Therefore, the output voltage of the multi-stage charge pump obtained by the second charge pump circuit is three times the input voltage of the multi-stage charge pump. In this way, the multi-stage charge pump is capable of raising the output voltage thereof to three times the input voltage of the multi-stage charge pump, such that the high-side switch driver circuit satisfies the drive requirement of the high-side switch under the effect of the output voltage of the multi-stage charge pump.

In some examples, in a case where the input voltage VS2 of the multi-stage charge pump 100 is greater than the first threshold voltage, that is, the input voltage VS2 of the multi-stage charge pump 100 is large, no matter under the effect of the first-phase clock signal PH1 or under the effect of the second-phase clock signal PH2, the control circuit 130 may control the first switching transistor K1 to be turned on, and control the first current output circuit 111 to always remain off, such that the first charge pump circuit 110 does not operate. Thus, power consumption of the first charge pump circuit 110 is reduced. In addition, the control circuit 130 may control, based on the second-phase clock signal PH2, the second charge pump circuit 120 to be charged using the input voltage VS2 of the multi-stage charge pump 100. In this way, in a case where the input voltage VS2 of the multi-stage charge pump 100 is greater than the first threshold voltage, power consumption of the multi-stage charge pump 100 is reduced.

Under the effect of the first-phase clock signal PH1, the second charge pump circuit 120 is in the discharging phase, and the second charge pump circuit 120 may boost the output voltage VS2 of the multi-stage charge pump 100 to obtain the output voltage VO2 of the multi-stage charge pump 100. Therefore, the output voltage VO2 of the multi-stage charge pump 100 is twice the input voltage VS2 of the multi-stage charge pump 100.

Under the effect of the second-phase clock signal PH2, the third switching transistor K3 is turned on, and the second charge pump circuit 120 is in the charging phase, such that the second charge pump circuit 120 may be charged using the input voltage VS2 of the multi-stage charge pump 100, that is, the voltage at the first terminal of the first capacitor C1. The voltage stored on the first capacitor C1 is 0, and the second terminal of the third switching transistor K3 is electrically connected to the input voltage VS2 of the multi-stage charge pump 100. Therefore, the voltage at the first terminal of the first capacitor C1 may be up to the input voltage VS2 of the multi-stage charge pump 100.

In summary, in a case where the input voltage of the multi-stage charge pump is greater than the first threshold voltage, the control circuit may control the first switching transistor to always remain on, and control the first current output circuit to always remain off, such that the first charge pump circuit does not operate, and hence power consumption of the first charge pump circuit is reduced. In addition, the control circuit may control, based on the second-phase clock signal, the second charge pump circuit to be charged using the input voltage of the multi-stage charge pump, such that the second charge pump circuit is in the charging phase. In this way, power consumption of the multi-stage charge pump is reduced.

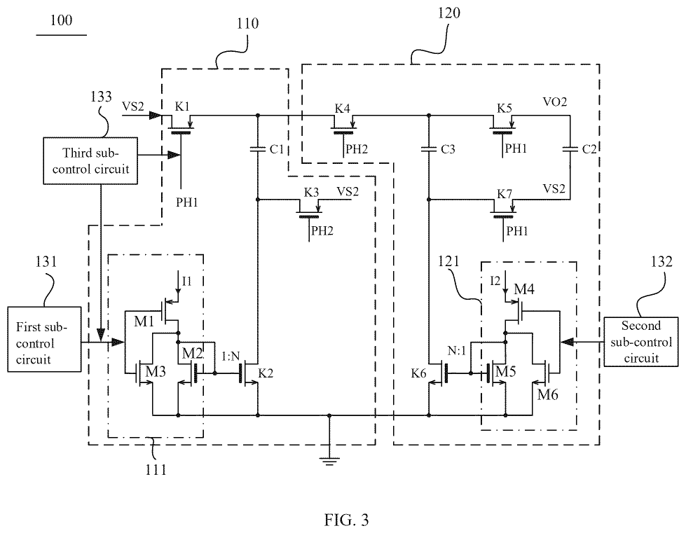

Based on the description of the above embodiment, exemplarily, one possible implementation of the second charge pump circuit 120 is described hereinafter. FIG. 3 is a schematic structural diagram of the multi-stage charge pump in FIG. 2. As illustrated in FIG. 3, the second charge pump circuit 120 may include a fourth switching transistor K4, a fifth switching transistor K5, a sixth switching transistor K6, a seventh switching transistor K7, a second capacitor C2, a third capacitor C3, and a second current output circuit 121.

A control terminal of the second current output circuit 121 is electrically connected to the control circuit 130, a first terminal of the fourth switching transistor K4 is electrically connected to the second terminal of the first switching transistor K1, a second terminal of the fourth switching transistor K4 is electrically connected to a first terminal of the fifth switching transistor K5, a second terminal of the fifth switching transistor K5 is electrically connected to a first terminal of the second capacitor C2, a first terminal of the third capacitor C3 is electrically connected between the second terminal of the fourth switching transistor K4 and the first terminal of the fifth switching transistor K5, a second terminal of the third capacitor C3 is electrically connected to a first terminal of the sixth switching transistor K6, a control terminal of the sixth switching transistor K6 is electrically connected to a first terminal of the second current output circuit 121, a first terminal of the seventh switching transistor K7 is electrically connected between the second terminal of the third capacitor C3 and the first terminal of the sixth switching transistor K6, a second terminal of the seventh switching transistor K7 is electrically connected to a second terminal of the second capacitor C2, and a second terminal of the second current output circuit 121 and a second terminal of the sixth switching transistor K6 are both grounded.

The control circuit 130 may control, based on the second-phase clock signal PH2, the second current output circuit 121 to be conducted, such that the sixth switching transistor K6 is turned on. In this way, under the effect of the second-phase clock signal PH2, the fourth switching transistor K4 is turned on, such that the third capacitor C3 is charged, and hence the second charge pump circuit 120 enters the charging phase.

Under the effect of the first-phase clock signal PH1, the fifth switching transistor K5 and the seventh switching transistor K7 are both turned on, such that the third capacitor C3 may discharge to the second capacitor C2, and hence the second charge pump circuit 120 enters the discharging phase.

In summary, the control circuit may control, based on the second-phase clock signal, the second current output circuit to be conducted, such that the sixth switching transistor is turned on. Thus, under the effect of the second-phase clock signal, the fourth switching transistor is turned on, such that the second charge pump circuit may enters the charging phase. Under the effect of the first-phase clock signal, since the fifth switching transistor and the seventh switching transistor are both turned on, the second charge pump circuit enters the discharging phase.

Based on the description of the above embodiments, exemplarily, one possible implementation of the control circuit 130 is described hereinafter. As illustrated in FIG. 3, the control circuit 130 may include a first sub-control circuit 131, a second sub-control circuit 132, and a third sub-control circuit 133.

An output terminal of the first sub-control circuit 131 is electrically connected to the control terminal of the first current output circuit 111, an output terminal of the second sub-control circuit 132 is electrically connected to the control terminal of the second current output circuit 121, and an output terminal of the third sub-control circuit 133 is electrically connected to the control terminal of the first switching transistor K1 and the control terminal of the first current output circuit 111.

In a case where the input voltage VS2 of the multi-stage charge pump 100 is less than the first threshold voltage, the first sub-control circuit 131 may control, based on the first-phase clock signal PH1, the first current output circuit 111 to be conducted, such that the first charge pump circuit 110 enters the charging phase.

In a case where the input voltage VS2 of the multi-stage charge pump 100 is less than the first threshold voltage, or in a case where the input voltage VS2 of the multi-stage charge pump 100 is greater than the first threshold voltage, the second sub-control circuit 132 may control, based on the second-phase clock signal PH2, the second current output circuit 121 to be conducted, such that the second charge pump circuit 120 enters the charging phase.

In summary, in a case where the input voltage VS2 of the multi-stage charge pump 100 is greater than the first threshold voltage, the third sub-control circuit 133 may control the first switching transistor K1 to always remain on, and control the first current output circuit 111 to always remain off, such that the first charge pump circuit 110 does not operate.

In summary, in a case where the input voltage of the multi-stage charge pump is less than the first threshold voltage, the first sub-control circuit may control, based on the first-phase clock signal, the first current output circuit to be conducted, such that the first charge pump circuit enters the charging phase; and the second sub-control circuit may control, based on the second-phase clock signal, the second current output circuit to be conducted, such that the second charge pump circuit enters the charging phase. In a case where the input voltage of the multi-stage charge pump is greater than the first threshold voltage, the third sub-control circuit may control the first switching transistor to always remain on, and control the first current output circuit to always remain off, such that the first charge pump circuit does not operate.

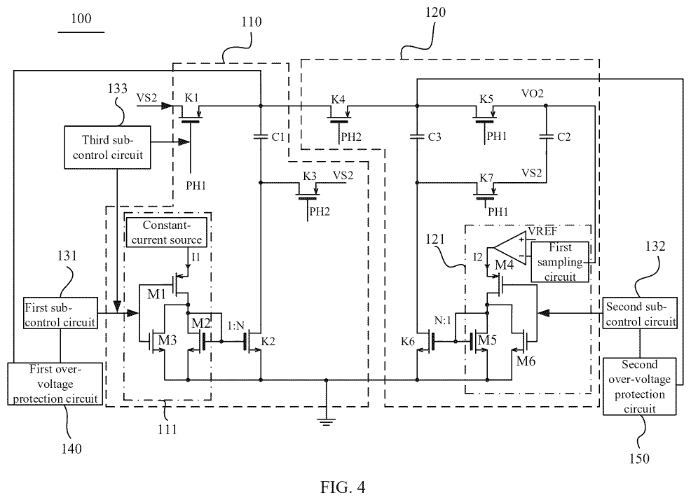

Based on the description of the above embodiment, exemplarily, one possible implementation of the multi-stage charge pump 100 is described hereinafter. FIG. 4 is a schematic structural diagram of the multi-stage charge pump in FIG. 2 and FIG. 3. As illustrated in FIG. 4, the multi-stage charge pump 100 may further include a first over-voltage protection circuit 140 and a second over-voltage protection circuit 150.

An input terminal of the first over-voltage protection circuit 140 is electrically connected to the first terminal of the first capacitor C1, an output terminal of the first over-voltage protection circuit 140 is electrically connected to an input terminal of the first sub-control circuit 131, an input terminal of the second over-voltage protection circuit 150 is electrically connected to the first terminal of the third capacitor C3, and an output terminal of the second over-voltage protection circuit 150 is electrically connected to an input terminal of the second sub-control circuit 132.

In a case where the voltage stored on the first capacitor C1 is greater than a first predetermined voltage, the first over-voltage protection circuit 140 may transmit a first over-voltage protection signal to the first sub-control circuit 131, such that the first current output circuit 111 is cut off. Thus, under the effect of cutoff of the first current output circuit 111, the second switching transistor K2 is turned off, such that the first capacitor C1 stops charging, that is, a charge current of the first capacitor C1 decreases to 0, and hence the voltage stored on the first capacitor C1 decreases. The first capacitor C1 continues charging when the voltage stored on the first capacitor C1 is less than the first predetermined voltage.

The first over-voltage protection signal is used for cutting off the first current output circuit 111.

In a case where a voltage stored on the third capacitor C3 is greater than a second predetermined voltage, the second over-voltage protection circuit 150 may transmit a second over-voltage protection signal to the second current output circuit 121, such that the second current output circuit 121 is cut off. Thus, under the effect of cutoff of the second current output circuit 121, the sixth switching transistor K6 is turned off, such that the third capacitor C3 stops charging, that is, a charge current of the third capacitor C3 decreases to 0, and hence the voltage stored on the third capacitor C3 decreases. The third capacitor C3 continues charging when the voltage stored on the third capacitor C3 is less than the second predetermined voltage.

The second over-voltage protection signal is used for cutting off the second current output circuit 121.

In summary, in a case where the voltage stored on the first capacitor is greater than the first predetermined voltage, the first over-voltage protection circuit may transmit the first over-voltage protection signal to the first sub-control circuit, such that the first current output circuit is cut off. Thus, the voltage stored on the first capacitor decreases. In a case where the voltage stored on the third capacitor is greater than a second predetermined voltage, the second over-voltage protection circuit may transmit the second over-voltage protection signal to the second current output circuit, such that the second current output circuit is cut off. Thus, the voltage stored on the third capacitor decreases.

Based on the description of the above embodiment, exemplarily, one possible implementation of the first current output circuit 111 is described hereinafter. As illustrated in FIG. 4, the first current output circuit 111 may include a constant-current source, a first transistor M1, a second transistor M2, and a third transistor M3.

An output terminal of the constant-current source is electrically connected to a second terminal of the first transistor M1, a first terminal of the first transistor M1 is electrically connected to a first terminal of the second transistor M2, a control terminal of the second transistor M2 is electrically connected to the control terminal of the second switching transistor K2, a first terminal of the third transistor M3 is electrically connected between the first terminal of the first transistor M1 and the first terminal of the second transistor M2, a control terminal of the first transistor M1 and a control terminal of the third transistor M3 are both electrically connected to the output terminal of the first sub-control circuit 131, and a second terminal of the second transistor M2 and a second terminal of the third transistor M3 are both grounded.

The constant-current source may output a first charge current I1. Thus, in a case where the first sub-control circuit 131 controls the first current output circuit 111 to be conducted, the first transistor M1, the second transistor M2, and the third transistor M3 are all turned on, such that the second switching transistor K2 is turned on. Thus, the second switching transistor K2 may mirror a current of the second transistor M2, such that a charge current of the second switching transistor K2 is N times the first charge current I1. N is a positive integer. In this way, the first capacitor C1 may be charged.

The charge current of the second switching transistor K2 determines the voltage stored on the first capacitor C1.

A current value of the first charge current I1 is greater than a maximum current value of a second charge current I2 output by the second current output circuit 121, such that the charge current of the second switching transistor K2 is greater than a charge current of the sixth switching transistor K6. Thus, a charging power amount of the first capacitor C1 is prevented from being less than a discharging power amount of the first capacitor C1 to the third capacitor C3, such that the voltage stored on the first capacitor C1 may not decrease to 0. In this way, the risk that the output voltage VO2 is over-low is prevented.

In summary, the constant-current source may output the first charge current. Thus, the first transistor, the second transistor, and the third transistor may turn on the second switching transistor, such that the second switching transistor is capable of mirroring a current of the second transistor. In this way, the first capacitor may be charged.

Based on the description of the above embodiment, exemplarily, one possible implementation of the second current output circuit 121 is described hereinafter. As illustrated in FIG. 4, the second current output circuit 121 may include a first sampling circuit, an operational amplifier, a fourth transistor M4, a fifth transistor M5, and a sixth transistor M6.

An input terminal of the first sampling circuit is electrically connected to the first terminal of the second capacitor C2, an output terminal of the first sampling circuit is electrically connected to a first input terminal of the operational amplifier, a second input terminal of the operational amplifier is electrically connected to a reference voltage VREF, an output terminal of the operational amplifier is electrically connected to a second terminal of the fourth transistor M4, a first terminal of the fourth transistor M4 is electrically connected to a first terminal of the fifth transistor M5, a control terminal of the fifth transistor M5 is electrically connected to the control terminal of the sixth switching transistor K6, a first terminal of the sixth transistor M6 is electrically connected between the first terminal of the fourth transistor M4 and the first terminal of the fifth transistor M5, a control terminal of the fourth transistor M4 and a control terminal of the sixth transistor M6 are both electrically connected to the output terminal of the second sub-control circuit 132, and a second terminal of the fifth transistor M5 and a second terminal of the sixth transistor M6 are both grounded.

The first sampling circuit may sample a voltage stored on the second capacitor C2. In addition, the first sampling circuit may transmit the voltage stored on the second capacitor C2 to the operational amplifier. Thus, the operational amplifier may regulate a magnitude of the second charge current I2 based on the voltage stored on the second capacitor C2 and the reference voltage VREF, such that control of the second current output circuit 121 is implemented.

In a case where the voltage stored on the second capacitor C2 is greater than a target voltage to be stored on the second capacitor C2, the operational amplifier decreases the second charge current I2. Thus, in a case where the second sub-control circuit 132 controls the second current output circuit 121 to be conducted, the fourth transistor M4, the fifth transistor M5, and the sixth transistor M6 are all turned on, such that the sixth switching transistor K6 is turned on. In this case, the sixth switching transistor K6 may mirror a current of the fifth transistor M5, such that a charge current of the sixth switching transistor K6 is N times the second charge current I2, and hence the third capacitor C3 may be charged. N is a positive integer. Under the effect of reduction of the second charge current I2, the voltage stored on the third capacitor C3 also decreases. In this way, the voltage stored on the second capacitor C2 decreases. In a case where the voltage stored on the second capacitor C2 is less than the target voltage to be stored on the second capacitor C2, the operational amplifier increases the second charge current I2. Under the effect of increase of the second charge current I2, the voltage stored on the third capacitor C3 also increases. In this way, the voltage stored on the second capacitor C2 increases.

The charge current of the sixth switching transistor K6 determines the voltage stored on the third capacitor C3.

In summary, the first sampling circuit may sample the voltage stored on the second capacitor, and transmit the voltage stored on the second capacitor to the operational amplifier, such that the operational amplifier acquires the voltage stored on the second capacitor. In this way, the operational amplifier may regulate the magnitude of the second charge current based on the voltage stored on the second capacitor and the reference voltage, such that control of the second current output circuit is implemented.

Based on the description of the above embodiment, exemplarily, one possible implementation of the multi-stage charge pump 100 is described hereinafter. FIG. 5 is a schematic structural diagram of the multi-stage charge pump in FIG. 2 and FIG. 3. As illustrated in FIG. 5, the multi-stage charge pump 100 may further include an over-voltage protection circuit 140.

An input terminal of the over-voltage protection circuit 140 is electrically connected to the first terminal of the third capacitor C3, and an output terminal of the over-voltage protection circuit 140 is electrically connected to the second sub-control circuit 132.

In a case where the voltage stored on the third capacitor C3 is greater than a predetermined voltage, the over-voltage protection circuit 140 may transmit an over-voltage protection signal to the second current output circuit 121, such that the second current output circuit 121 is cut off. Thus, under the effect of cutoff of the second current output circuit 121, the sixth switching transistor K6 is turned off, such that the third capacitor C3 stops charging, that is, the charge current of the third capacitor C3 decreases to 0, and hence the voltage stored on the third capacitor C3 decreases. In this way, the voltage stored on the third capacitor C3 is prevented from being over-large.

The over-voltage protection signal is used for cutting off the second current output circuit 121.

In a case where the voltage stored on the third capacitor is greater than the predetermined voltage, the over-voltage protection circuit may transmit the over-voltage protection signal to the second current output circuit, such that the second current output circuit is cut off. In this way, the voltage stored on the third capacitor decreases, and hence the voltage stored on the third capacitor is prevented from being over-large.

Based on the description of the above embodiment, exemplarily, one possible implementation of the first current output circuit 111 is described hereinafter. As illustrated in FIG. 5, the first current output circuit 111 may include a first sampling circuit, a first operational amplifier OP1, a first transistor M1, a second transistor M2, and a third transistor M3.

An input terminal of the first sampling circuit is electrically connected to the first terminal of the first capacitor C1, an output terminal of the first sampling circuit is electrically connected to a first input terminal of the first operational amplifier OP1, a second input terminal of the first operational amplifier OP1 is electrically connected to a first reference voltage VREF1, an output terminal of the first operational amplifier OP1 is electrically connected to a second terminal of the first transistor M1, a first terminal of the first transistor M1 is electrically connected to a first terminal of the second transistor M2, a control terminal of the second transistor M2 is electrically connected to the control terminal of the second switching transistor K2, a first terminal of the third transistor M3 is electrically connected between the first terminal of the first transistor M1 and the first terminal of the second transistor M2, a control terminal of the first transistor M1 and a control terminal of the third transistor M3 are both electrically connected to the output terminal of the first sub-control circuit 131, and a second terminal of the second transistor M2 and a second terminal of the third transistor M3 are both grounded.

The first sampling circuit may sample the voltage stored on the first capacitor C1. In addition, the first sampling circuit may transmit the voltage stored on the first capacitor C1 to the first operational amplifier OP1. Thus, the first operational amplifier OP1 may regulate the magnitude of the first charge current I1 based on the voltage stored on the first capacitor C1 and the first reference voltage VREF1, such that the voltage stored on the first capacitor C1 remains stable.

The first sampling circuit has good transient characteristics, and hence the first sampling circuit may change with a change of the voltage stored on the first capacitor C1 and may obtain the voltage stored on the first capacitor C1. In this way, the charging power amount of the first capacitor C1 is prevented from being less than the discharging power amount of the first capacitor C1 to the third capacitor C3, such that the voltage stored on the first capacitor C1 may not decrease to 0. In this way, the risk that the output voltage VO2 is over-low is prevented.

In summary, the first sampling circuit may sample the voltage stored on the first capacitor, and transmit the voltage stored on the first capacitor to the first operational amplifier, such that the first operational amplifier acquires the voltage stored on the first capacitor. In this way, the first operational amplifier may regulate the magnitude of the first charge current based on the voltage stored on the first capacitor and the first reference voltage, such that the voltage stored on the first capacitor remains stable.

Based on the description of the above embodiment, exemplarily, one possible implementation of the second current output circuit 121 is described hereinafter. As illustrated in FIG. 5, the second current output circuit 121 may include a second sampling circuit, a second operational amplifier OP2, a fourth transistor M4, a fifth transistor M5, and a sixth transistor M6.

An input terminal of the second sampling circuit is electrically connected to the first terminal of the second capacitor C2, an output terminal of the second sampling circuit is electrically connected to a first input terminal of the second operational amplifier OP2, a second input terminal of the second operational amplifier OP2 is electrically connected to a second reference voltage VREF2, an output terminal of the second operational amplifier OP2 is electrically connected to a second terminal of the fourth transistor M4, a first terminal of the fourth transistor M4 is electrically connected to a first terminal of the fifth transistor M5, a control terminal of the fifth transistor M5 is electrically connected to the control terminal of the sixth switching transistor K6, a first terminal of the sixth transistor M6 is electrically connected between the first terminal of the fourth transistor M4 and the first terminal of the fifth transistor M5, a control terminal of the fourth transistor M4 and a control terminal of the sixth transistor M6 are both electrically connected to the output terminal of the second sub-control circuit 132, and a second terminal of the fifth transistor M5 and a second terminal of the sixth transistor M6 are both grounded.

The second sampling circuit may sample the voltage stored on the second capacitor C2. In addition, the second sampling circuit may transmit the voltage stored on the second capacitor C2 to the second operational amplifier OP2. Thus, the second operational amplifier OP2 may regulate the magnitude of the second charge current I2 based on the voltage stored on the second capacitor C2 and the second reference voltage VREF2, such that the voltage stored on the second capacitor C2 remains stable.

In summary, the second sampling circuit may sample the voltage stored on the second capacitor, and transmit the voltage stored on the second capacitor to the second operational amplifier, such that the second operational amplifier acquires the voltage stored on the second capacitor. In this way, the second operational amplifier may regulate the magnitude of the second charge current based on the voltage stored on the second capacitor and the second reference voltage, such that the voltage stored on the second capacitor remains stable.

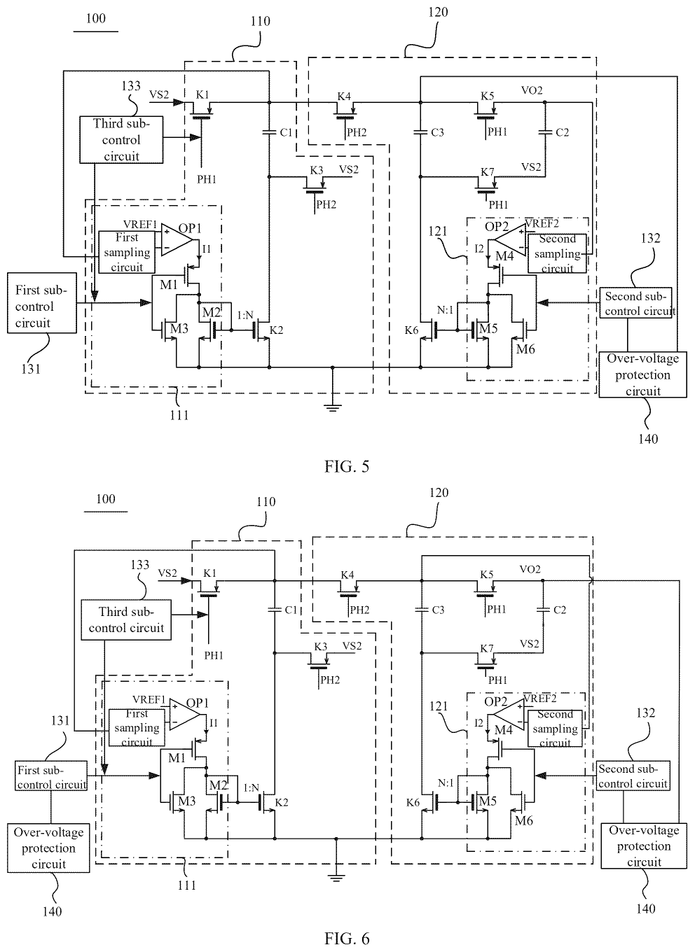

Based on the description of the above embodiment, exemplarily, one possible implementation of the multi-stage charge pump 100 is described hereinafter. FIG. 6 is a schematic structural diagram of the multi-stage charge pump in FIG. 2 and FIG. 3. As illustrated in FIG. 6, the multi-stage charge pump 100 may further include an over-voltage protection circuit 140.

An input terminal of the over-voltage protection circuit 140 is electrically connected to the first terminal of the second capacitor C2, an input terminal of the first sub-control circuit 131 and an input terminal of the second sub-control circuit 132 are both electrically connected to an output terminal of the over-voltage protection circuit 140.

In a case where the voltage stored on the second capacitor C2 is greater than the predetermined voltage, the over-voltage protection circuit 140 may transmit an over-voltage protection signal to the first sub-control circuit 131 and the second sub-control circuit 132, such that the first current output circuit 111 and the second current output circuit 121 are both cut off. Thus, under the effect of cutoff of the first current output circuit 111, the second switching transistor K2 is turned off, such that the first capacitor C1 stops charging, and hence the voltage stored on the first capacitor C1 decreases. Likewise, under the effect of cutoff of the second current output circuit 121, the sixth switching transistor K6 is turned off, such that the third capacitor C3 stops charging, and hence the voltage stored on the third capacitor C3 decreases.

In addition, in a case where the voltage stored on the second capacitor C2 is greater than the predetermined voltage, the switching transistors in the first charge pump circuit 110 and the switching transistors in the second charge pump circuit 120 are all turned off, such that the voltage stored on the second capacitor C2 is less than the predetermined voltage.

The over-voltage protection signal is used for cutting off the first current output circuit 111 and the second current output circuit 121.

In summary, in a case where the voltage stored on the second capacitor is greater than the predetermined voltage, the over-voltage protection circuit may transmit the over-voltage protection signal to the first sub-control circuit and the second sub-control circuit, such that the first current output circuit and the second current output circuit are both cut off. In this way, the voltage stored on the first capacitor and the voltage stored on the third capacitor are respectively decreased.

Based on the description of the above embodiment, exemplarily, one possible implementation of the first current output circuit 111 is described hereinafter. As illustrated in FIG. 6, the first current output circuit 111 may include a first sampling circuit, a first operational amplifier OP1, a first transistor M1, a second transistor M2, and a third transistor M3.

An input terminal of the first sampling circuit is electrically connected to the first terminal of the first capacitor C1, an output terminal of the first sampling circuit is electrically connected to a first input terminal of the first operational amplifier OP1, a second input terminal of the first operational amplifier is electrically connected to a first reference voltage VREF1, an output terminal of the first operational amplifier OP1 is electrically connected to a second terminal of the first transistor M1, a first terminal of the first transistor M1 is electrically connected to a first terminal of the second transistor M2, a control terminal of the second transistor M2 is electrically connected to the control terminal of the second switching transistor K2, a first terminal of the third transistor M3 is electrically connected between the first terminal of the first transistor M1 and the first terminal of the second transistor M2, a control terminal of the first transistor M1 and a control terminal of the third transistor M3 are both electrically connected to the output terminal of the first sub-control circuit 131, and a second terminal of the second transistor M2 and a second terminal of the third transistor M3 are both grounded.

The first sampling circuit may sample the voltage stored on the first capacitor C1. In addition, the first sampling circuit may transmit the voltage stored on the first capacitor C1 to the first operational amplifier OP1. Thus, the first operational amplifier OP1 may regulate the magnitude of the first charge current I1 based on the voltage stored on the first capacitor C1 and the first reference voltage VREF1, such that the voltage stored on the first capacitor C1 remains stable.

In summary, the first sampling circuit may sample a voltage stored on the first capacitor, and transmit the voltage stored on the first capacitor to the first operational amplifier. In this way, the first operational amplifier may regulate the magnitude of the first charge current based on the voltage stored on the first capacitor and the first reference voltage, such that the voltage stored on the first capacitor remains stable.

Based on the description of the above embodiment, exemplarily, one possible implementation of the second current output circuit 121 is described hereinafter. As illustrated in FIG. 6, the second current output circuit 121 may include a second sampling circuit, a second operational amplifier OP2, a fourth transistor M4, a fifth transistor M5, and a sixth transistor M6.

An input terminal of the second sampling circuit is electrically connected to the first terminal of the third capacitor C3, an output terminal of the second sampling circuit is electrically connected to a first input terminal of the second operational amplifier OP2, a second input terminal of the second operational amplifier OP2 is electrically connected to a second reference voltage VREF2, an output terminal of the second operational amplifier OP2 is electrically connected to a second terminal of the fourth transistor M4, a first terminal of the fourth transistor M4 is electrically connected to a first terminal of the fifth transistor M5, a control terminal of the fifth transistor M5 is electrically connected to the control terminal of the sixth switching transistor K6, a first terminal of the sixth transistor M6 is electrically connected between the first terminal of the fourth transistor M4 and the first terminal of the fifth transistor M5, a control terminal of the fourth transistor M4 and a control terminal of the sixth transistor M6 are both electrically connected to the output terminal of the second sub-control circuit 132, and a second terminal of the fifth transistor M5 and a second terminal of the sixth transistor M6 are both grounded.

The second sampling circuit may sample the voltage stored on the third capacitor C3. In addition, the second sampling circuit may transmit the voltage stored on the third capacitor C3 to the second operational amplifier OP2. Thus, the second operational amplifier OP2 may regulate the magnitude of the second charge current I2 based on the voltage stored on the third capacitor C3 and the second reference voltage VREF2, such that the voltage stored on the second capacitor C2 remains stable.

In addition, the second sampling circuit has good transient characteristics, and hence the second sampling circuit may change with a change of the voltage stored on the third capacitor C3 and may obtain the voltage stored on the third capacitor C3.

In summary, the second sampling circuit may sample the voltage stored on the third capacitor, and transmit the voltage stored on the third capacitor to the second operational amplifier. In this way, the second operational amplifier may regulate the magnitude of the second charge current based on the voltage stored on the third capacitor and the second reference voltage, such that the voltage stored on the second capacitor remains stable.

In addition, the first switching transistor K1, the third switching transistor K3, the fourth switching transistor K4, the fifth switching transistor K5, and the seventh switching transistor K7 in FIG. 3 to FIG. 6 are all P-type switching transistors.

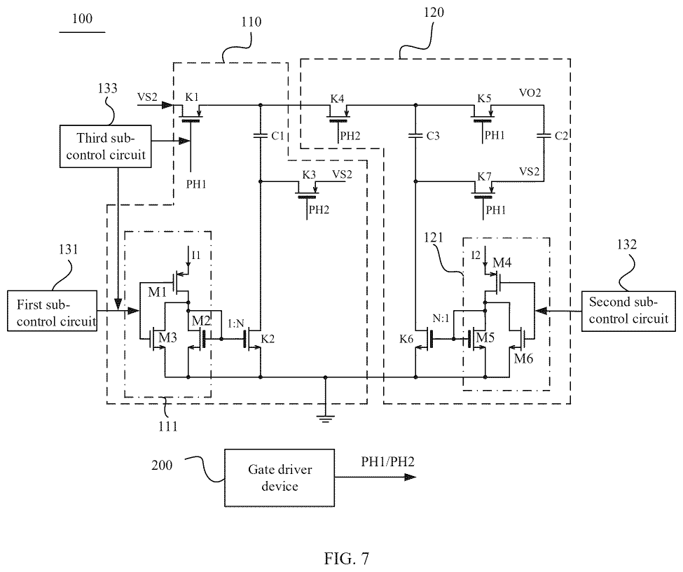

FIG. 7 is a schematic structural diagram of the multi-stage charge pump in FIG. 3 to FIG. 6. As illustrated in FIG. 7, the multi-stage charge pump 100 may further include a gate driver device 200.

The gate driver device 200 is electrically connected to control terminals of P-type switching transistors in the multi-stage charge pump 100.

The gate driver device 200 may transmit the first-phase clock signal PH1 and the second-phase clock signal PH2 to the multi-stage charge pump 100, such that the multi-stage charge pump 100 is capable of operating.

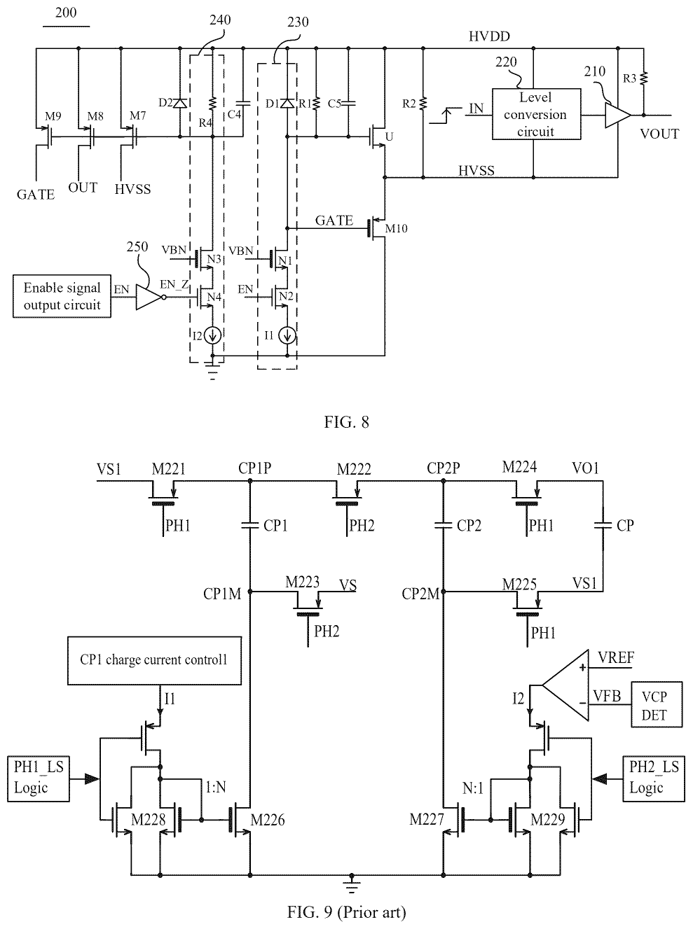

FIG. 8 is a schematic structural diagram of the gate driver device in FIG. 7. As illustrated in FIG. 8, the gate driver device 200 may include a driver circuit 210, a level conversion circuit 220, a first series branch 230, a second series branch 240, a fourth capacitor C4, a fifth capacitor C5, a seventh transistor M7, an eighth transistor M8, a ninth transistor M9, a tenth transistor M10, and an inverter 250.

A power terminal of the driver circuit 210, a power terminal of the level conversion circuit 220, a power terminal of the first series branch 230, a power terminal of the second series branch 240, a first terminal of the fourth capacitor C4, a first terminal of the fifth capacitor C5, a first terminal of the seventh transistor M7, a first terminal of the eighth transistor M8, and a first terminal of the ninth transistor M9 are all electrically connected to a high-side power supply voltage HVDD, an input terminal of the level conversion circuit 220 is configured to receive a phase control signal IN, an output terminal of the level conversion circuit 220 is electrically connected to an input terminal of the driver circuit 210, and an output terminal of the driver circuit 210 and a second terminal of the eighth transistor M8 are both electrically connected to a P-type switching transistor in the multi-stage charge pump 100.

The output terminal of the driver circuit 210 is configured to output a two-phase clock output VOUT. The two-phase clock output VOUT includes the first-phase clock signal PH1 and the second-phase clock signal PH2.

The driver circuit 210, the level conversion circuit 220, the first series branch 230, the second series branch 240, the fourth capacitor C4, the fifth capacitor C5, the seventh transistor M7, the eighth transistor M8, the ninth transistor M9, the tenth transistor M10, and the inverter 250 may be separately arranged or may be integrated.

The level conversion circuit 220 acquires the phase control signal IN. In addition, the level conversion circuit 220 may perform a level conversion on the phase control signal IN to obtain a converted phase control signal. Thus, the level conversion circuit 220 may transmit the converted control signal to the driver circuit 210.

Since any voltage within a voltage domain HVDD−HDSS is greater than a second threshold voltage, the voltage domain HVDD−HDSS is a high voltage domain. The phase control signal IN is within a low voltage domain, and the converted phase control signal is within the voltage domain HVDD−HVSS.

The driver circuit 210 may obtain the two-phase clock VOUT based on the converted phase control signal. In addition, the driver circuit 210 may transmit the two-phase clock VOUT to the P-type switching transistors in the multi-stage charge pump 100, such that the P-type switching transistors in the multi-stage charge pump 100 are alternately turned on. In this way, the multi-stage charge pump is capable of operating.

The first series branch 230 includes a node GATE, a first terminal of the first series branch 230 is electrically connected to an enable signal output circuit, the node GATE is electrically connected to a second terminal of the ninth transistor M9 and a control terminal of the tenth transistor M10, a second terminal of the tenth transistor M10, a ground terminal of the level conversion circuit 220, a ground terminal of the driver circuit 210, and a second terminal of the seventh transistor M7 are all electrically connected to a high-side ground voltage HVSS, and a second terminal of the fifth capacitor C5 is electrically connected to a second terminal of the first series branch 230.

A first terminal of the second series branch 240 is electrically connected to an output terminal of the inverter 250, an input terminal of the inverter 250 is electrically connected to the enable signal output circuit, a second terminal of the second series branch 240 is electrically connected to a second terminal of the fourth capacitor C4, a control terminal of the seventh transistor M7, a control terminal of the eighth transistor M8, and a control terminal of the ninth transistor M9, a third terminal of the second series branch 240 and a third terminal of the first series branch 230 are both electrically connected to a bias voltage VBN, and a fourth terminal of the second series branch 240, a fourth terminal of the first series branch 230, and a first terminal of the tenth transistor M10 are all grounded.

The high-side power supply voltage HVDD is a source voltage of a P-type switching transistor in the multi-stage charge pump 100, for example, a voltage at the first terminal of the fourth switching transistor.

In some examples, a withstand voltage of the tenth transistor M10 is greater than a predetermined withstand voltage.

In some examples, since the withstand voltage of the tenth transistor M10 is greater than the predetermined withstand voltage, the tenth transistor M10 is a high-voltage transistor.

Upon acquisition of the enable signal EN from the enable signal output circuit, the first series branch 230 may be conducted in response to the enable signal EN being at a high level. Thus, the first series branch 230 may pull down a voltage at the node GATE.

Upon pulldown of the voltage at the node GATE, the tenth transistor M10 is turned on. Thus, the tenth transistor M10 may pull down a potential of the high-side ground voltage HVSS, such that the high-side ground voltage HVSS is clamped to VGATE+VGS1. VGATE represents the voltage at the node GATE, and VGS1 represents a gate-source voltage of the tenth transistor M10. In this way, the voltage domain HVDD−HVSS is obtained.

Since the voltage at the node GATE changes with the high-side power supply voltage HVDD via the fifth capacitor C5, in a case where the high-side power supply voltage HVDD undergoes a rapid transient, the fifth capacitor C5 may ensure that the voltage at the node GATE changes with the change of the high-side power supply voltage HVDD, such that the voltage domain HVDD−HVSS remains stable. Thus, the gate driver device 200 has good transient characteristics.

The inverter 250 may invert the enable signal EN output by the enable signal output circuit to obtain an inverted enable signal EN_Z. In addition, the inverter 250 may transmit the inverted enable signal EN_Z to the second series branch 240.

In a case where the enable signal EN is at a high level, that is, the enable signal EN is enabled, the inverted enable signal EN_Z is at a low level. In a case where the enable signal EN is at a low level, that is, the enable signal EN is disabled, the inverted enable signal EN_Z is at a high level.

In a case where the inverted enable signal EN_Z is at a low level, the second series branch 240 is cut off. Thus, the seventh transistor M7, the eighth transistor M8, and the ninth transistor M9 are turned off. In this way, in a case where the high-side power supply voltage HDVV undergoes a rapid transient, a voltage at the control terminal of the seventh transistor M7, a voltage at the control terminal of the eighth transistor M8, and a voltage at the control terminal of the ninth transistor M9 all change with the change of the high-side power supply voltage HVDD via the fourth capacitor C4, such that the seventh transistor M7, the eighth transistor M8, and the ninth transistor M9 are constantly turned off, and may not be falsely turned on. Hence, the high-side ground voltage HVSS, an output voltage VOUT under control of the two-phase clock, and the voltage at the node GATE may not be pulled up to the high-side power supply voltage HVDD. In this way, the switching transistors in the multi-stage charge pump 100 are prevented from being falsely turned off.

In a case where the inverted enable signal EN_Z is at a high level, the second series branch 240 is conducted. Thus, the second series branch 240 may pull down a voltage at the second terminal of the second series branch 240, such that the seventh transistor M7, the eighth transistor M8, and the ninth transistor M9 are turned on. In this way, the high-side ground voltage HVSS, the output voltage VOUT under control of the two-phase clock, the voltage at the node GATE may be quickly pulled up to the high-side power supply voltage HVDD, such that a voltage difference HVDD−HVSS between the high-side power supply voltage and the high-side ground voltage HVSS, a voltage difference HVDD−VGATE between the high-side power supply voltage HVDD and the voltage at the node GATE, and a voltage difference HVDD_VOUT between the high-side power supply voltage HVDD and the output voltage VOUT under control of the two-phase clock quickly decreases to 0 V, and hence the switching transistors in the multi-stage charge pump 100 are quickly turned off. In addition, in a case where the high-side power supply voltage HDVV undergoes a rapid transient, the voltage at the control terminal of the seventh transistor M7, the voltage at the control terminal of the eighth transistor M8, and the voltage at the control terminal of the ninth transistor M9 all change with the change of the high-side power supply voltage HVDD via the fourth capacitor C4, such that the seventh transistor M7, the eighth transistor M8, and the ninth transistor M9 are constantly turned on, and may not be falsely turned off. In this way, the switching transistors in the multi-stage charge pump 100 are prevented from being falsely turned on, and hence the gate driver device 200 has good transient characteristics.

In summary, upon acquisition of the enable signal from the enable signal output circuit, the first series branch may pull down the voltage at the node in response to the enable signal being at a high level, such that the tenth transistor is turned on. In this way, the tenth transistor may pull down the potential of the high-side ground voltage to obtain the voltage domain. Since the voltage at the node changes with the high-side power supply voltage via the fifth capacitor, the voltage domain remains stable, and hence the gate driver circuit exhibits good transient characteristics. The inverter may invert the enable signal to obtain an inverted enable signal, and may transmit the inverted enable signal to the second series branch, such that the second series branch acquires the inverted enable signal. In this way, the second series branch may control, based on the inverted enable signal, the seventh transistor, the eighth transistor, and the ninth transistor to be turned on or turned off. Since the voltage at the control terminal of the seventh transistor, the voltage at the control terminal of the eighth transistor, and the voltage at the control terminal of the ninth transistor may change with the high-side power supply voltage via the fourth capacitor, in a case where the high-side power supply voltage undergoes a rapid transient, the seventh transistor, the eighth transistor, and the ninth transistor may not be falsely turned on or turned off. In this way, the switching transistors in the multi-stage charge pump are prevented from being falsely turned on or turned off.

Based on the description of the above embodiment, exemplarily, one possible implementation of the gate driver device 200 is described hereinafter. As illustrated in FIG. 8, the gate driver device 200 may further include a first resistor R1, a second resistor R2, and a third resistor R3.

A first terminal of the first resistor R1, a first terminal of the second resistor R2, and a first terminal of the third resistor R3 are all electrically connected to the high-side power supply voltage HVDD, a second terminal of the first resistor R1 is electrically connected to the second terminal of the first series branch 230, a second terminal of the second resistor R2 is electrically connected to the high-side ground voltage HVSS, and a second terminal of the third resistor R3 is electrically connected to the output terminal of the driver circuit 210.

In a case where a power supply voltage of the enable signal output circuit is 0 V, that is, the enable signal output circuit does not operate, the second series branch 240 fails to control the seventh transistor M7, the eighth transistor M8, and the ninth transistor M9 to be turned on. Therefore, the voltage difference HVDD−HVSS between the high-side power supply voltage and the high-side ground voltage HVSS, the voltage difference HVDD−VGATE between the high-side power supply voltage HVDD and the voltage at the node GATE, and the voltage difference HVDD−VOUT between the high-side power supply voltage HVDD and the output voltage VOUT under control of the two-phase clock fail to quickly decrease to 0 V, and hence the switching transistors in the multi-stage charge pump 100 fail to be quickly turned off. In this case, the first resistor R1 may pull up the voltage at the node GATE to the high-side power supply voltage HVDD, the second resistor R2 may pull up the high-side ground voltage HVSS to the high-side power supply voltage HVDD, and the third resistor R3 may pull up the output voltage VOUT under control of the two-phase clock to the high-side power supply voltage HVDD. In this way, the switching transistors in the multi-stage charge pump 100 may be quickly turned off.

In summary, in a case where the enable signal output circuit does not operate, the high-side ground voltage, the output voltage under control of the two-phase clock, and the voltage at the node may be quickly pulled up to the high-side power supply voltage using the first resistor, the second resistor, and the third resistor, such that the switching transistors in the multi-stage charge pump are turned off.

Based on the description of the above embodiments, exemplarily, one possible implementation of the first series branch 230 is described hereinafter. As illustrated in FIG. 8, the first series branch 230 may include a first N-type transistor N1, a second N-type transistor N2, a first diode D1, and a first current source.

A first terminal of the first diode D1 is electrically connected to the high-side power supply voltage HVDD, a second terminal of the first diode D1 is electrically connected to a first terminal of the first N-type transistor N1, the node is arranged between the second terminal of the first diode D1 and the first terminal of the first N-type transistor N1, a second terminal of the first N-type transistor N1 is electrically connected to a first terminal of the second N-type transistor N2, a second terminal of the second N-type transistor N2 is electrically connected to a first terminal of the first current source, a second terminal of the first current source is grounded, a control terminal of the first N-type transistor N1 is electrically connected to the bias voltage VBN, and a control terminal of the second N-type transistor N2 is electrically connected to the enable signal output circuit.

The first diode D1 is a Zener diode, and a breakdown voltage VD1 of the first diode D1 is 6 V.

In some examples, a withstand voltage of the first N-type transistor N1 is greater than a predetermined withstand voltage.

In some examples, since the withstand voltage of the first N-type transistor N1 is greater than the predetermined withstand voltage, the first N-type transistor N1 is a high-voltage transistor, such that the first N-type transistor N1 may act as a high-voltage protection or blocking transistor.

In a case where the enable signal EN is at a high level, the second N-type transistor N2 is turned on. In this way, the first current source may pull down the voltage at the node GATE via the current I1. Thus, the first diode D1 may be broken down, such that the voltage difference HVDD−VGATE between the high-side power supply voltage HVDD and the voltage at the node GATE is clamped to around 6 V, that is, the breakdown voltage VD1 of the first diode D1.

In addition, based on the above description, upon pulldown of the voltage at the node GATE, the high-side ground voltage HVSS is clamped to VGATE+VGS1. VGATE represents the voltage at the node GATE, and VGS1 represents a gate-source voltage of the tenth transistor M10. Thus, HVDD−HVSS=HVDD−(VGATE+VGS1)=VD1−VGS1

HVDD−HVSS represents the voltage domain, HVDD represents the high-side power supply voltage HVDD, VD1 represents the breakdown voltage of the first diode D1, and VGS1 represents the gate-source voltage of the tenth transistor M10.

In summary, the voltage at the node may be pulled down using the first N-type transistor, the second N-type transistor, the first diode, and the first current source. In this way, the first series branch may obtain a voltage domain.

Based on the description of the above embodiment, exemplarily, another possible implementation of the gate driver device 200 is described hereinafter. As illustrated in FIG. 8, the gate driver device 200 may further include a depletion-mode transistor U.

A first terminal of the depletion-mode transistor U is electrically connected to the high-side power supply voltage HVDD, a control terminal of the depletion-mode transistor U is electrically connected to the second terminal of the first diode D1, and a second terminal of the depletion-mode transistor U is electrically connected to the second terminal of the tenth transistor M10.

The depletion-mode transistor U has a large size, and thus a threshold voltage of the depletion-mode transistor U is close 0. Therefore, a gate-source voltage VGS2 of the depletion-mode transistor U is small.

In a case where the high-side ground voltage HVSS fails to follow the rapid transient of the high-side power supply voltage HVDD, the depletion-mode transistor U is turned on. Thus, the high-side ground voltage HVSS is clamped to HVDD−VD1−VGS2. HVSS represents the high-side ground voltage, VD1 represents the breakdown voltage of the first diode D1, and VGS2 represents the gate-source voltage of the depletion-mode transistor U. Thus, breakdown risks of low-voltage transistors in the voltage domain HVDD−HVSS are avoided.

In summary, in a case where the high-side ground voltage HVSS fails to follow the rapid transient of the high-side power supply voltage HVDD, the high-side ground voltage may be clamped using the depletion-mode transistor, such that the breakdown risks of the low-voltage transistors in the voltage domain are avoided.

Based on the description of the above embodiments, exemplarily, one possible implementation of the second series branch 240 is described hereinafter. As illustrated in FIG. 8, the second series branch 240 may include a fourth resistor R4, a third N-type transistor N3, a fourth N-type transistor N4, and a second current source.

A first terminal of the fourth resistor R4 is electrically connected to the high-side power supply voltage HVDD, a second terminal of the fourth resistor R4 is electrically connected to a first terminal of the third N-type transistor N3, a second terminal of the third N-type transistor N3 is electrically connected to a first terminal of the fourth N-type transistor N4, a second terminal of the fourth N-type transistor N4 is electrically connected to a first terminal of the second current source, a second terminal of the second current source is grounded, a control terminal of the third N-type transistor N3 is electrically connected to the bias voltage VBN, and a control terminal of the fourth N-type transistor N4 is electrically connected to the output terminal of the inverter 250.

In some examples, a withstand voltage of the third N-type transistor N3 is greater than the predetermined withstand voltage.

In some examples, since the withstand voltage of the third N-type transistor N3 is greater than the predetermined withstand voltage, the third N-type transistor N3 is a high-voltage transistor, such that the third N-type transistor N3 may act as a high-voltage protection or blocking transistor.

In a case where the inverted enable signal EN_Z is at a low level, the fourth N-type transistor N4 is turned off, such that a current on the fourth resistor R4 is 0. Thus, the fourth resistor R4 has no voltage drop, that is, the voltage at the second terminal of the second series branch 240 remains unchanged. In this way, the seventh transistor M7, the eighth transistor M8, and the ninth transistor M9 are turned off.

In a case where the inverted enable signal EN_Z is at a high level, the fourth N-type transistor N4 is turned on, such that the current on the fourth resistor R4 is I2. Thus, the fourth resistor R4 has a voltage drop r4*I2, that is, the voltage at the second terminal of the second series branch 240 is pulled down. r4 represents a resistance of the fourth resistor R4, and I2 represents a current output by the second current source. In this way, the seventh transistor M7, the eighth transistor M8, and the ninth transistor M9 are turned on.

In summary, in a case where the inverted enable signal is at a low level, the fourth N-type transistor is turned off, such that the fourth resistor has no voltage drop. Thus, the seventh transistor, the eighth transistor, and the ninth transistor are turned off. In a case where the inverted enable signal is at a high level, the fourth N-type transistor is turned on, such that the fourth resistor has a voltage drop. Thus, the seventh transistor, the eighth transistor, and the ninth transistor are turned on. In this way, the second series branch may control, based on the inverted enable signal, the seventh transistor, the eighth transistor, and the ninth transistor to be turned on or turned off.

Based on the description of the above embodiment, exemplarily, another possible implementation of the gate driver circuit 200 is described hereinafter. As illustrated in FIG. 8, the gate driver device 200 may further include a second diode D2.

A first terminal of the second diode D2 is electrically connected to the high-side power supply voltage HVDD, and a second terminal of the second diode D2 is electrically connected to the control terminal of the seventh transistor M7.

The second diode D2 is a Zener diode, and a breakdown voltage VD2 of the second diode D2 is 6 V.

Since the second diode D2 is a Zener diode, the second diode D2 may clamp a gate-source voltage of the seventh transistor M7, a gate-source voltage of the eighth transistor M8, and a gate-source voltage of the ninth transistor M9, such that the gate-source voltage of the seventh transistor M7, the gate-source voltage of the eighth transistor M8, and the gate-source voltage of the ninth transistor M9 remain stable. In this way, the seventh transistor M7, the eighth transistor M8, and the ninth transistor M9 is prevented from over-voltage.

In summary, by the second diode, the gate-source voltage of the seventh transistor, the gate-source voltage of the eighth transistor, and the gate-source voltage of the ninth transistor remain stable. In this way, the seventh transistor, the eighth transistor, and the ninth transistor are prevented from over-voltage.

Besides, the power transistor in FIG. 8 may be a metal-oxide-semiconductor field-effect transistor (MOSFET). Meanwhile, the transistor may also be an insulated-gate bipolar transistor (IGBT) device, an integrated gate-commutated thyristor (IGCT) device, a gate turn-off thyristor (GTO) device, a silicon-controlled rectifier (SCR) device, a junction gate field-effect transistor (JFET) device, a MOS-controlled thyristor (MCT) device, a GaN-based power device, a SiC-based power device, or the like. The embodiments of the present disclosure set no limitation thereto.

FIG. 9 is a schematic structural diagram of a charge pump in the related art. As illustrated in FIG. 9, in a case where the input voltage VS1 is relatively low, the charge pump enters a first operating mode. In this way, under ideal conditions without any load, an output voltage VO1 may be three times the input voltage VS1.

In a case where the input voltage VS1 is relatively high, using a controller, a switching transistor M221 is controlled to always remain always on and a switching transistor M226 is controlled to retain always off, such that the charge pump enters a second operating mode to reduce power consumption. In this way, the output voltage VO1 may be twice the input voltage VS1.

The operating principles of the charge pump in both the first and second operating modes are detailed hereinafter.

In a case where the charge pump is in the first operating mode, the switching transistor connected to the first phase clock signal PH1 and the switching transistor connected to the second-phase clock signal PH2 are alternately turned on at a 50% duty cycle.

In a case where the charge pump is at the first-phase clock signal PH1, the switching transistor M221 and the switching transistor M226 are turned on, such that the input voltage VS1 charges a capacitor CP1. In this way, a voltage across the capacitor CP1 may be up to VS1. Meanwhile, a switching transistor M224 and a switching transistor M225 are turned on, such that a capacitor CP2 discharges to a capacitor CP. In this case, a voltage across the capacitor CP2 may be up to twice VS1, such that under ideal conditions without any load, the output voltage VO1 may be up to three times VS1. A charge current of the switching transistor M226 is obtained by current mirroring by a switching transistor M228. The charge current of the switching transistor M226 is N*I1, wherein N*I1 may determine the voltage across the capacitor CP1.

In a case where the charge pump is at the second-phase clock signal PH2, a switching transistor M222, a switching transistor M223, and a switching transistor M227 are turned on, such that the capacitor CP1 discharges to the capacitor CP2. In this way, the voltage on the capacitor CP2 may be up to twice VS1. A charge current of the switching transistor M227 is obtained by current mirroring by a switching transistor M229. The charge current of the switching transistor M227 is N*I2, wherein N*I2 may determine the voltage across the capacitor CP2.

In summary, during the first-phase clock signal PH1, the capacitor CP1 may be charged; and during the second phase clock signal PH2, the capacitor CP2 may be discharged. Thus, the voltage VCP across the capacitor CP is equal to the voltage VCP2 across the capacitor CP2, such that the voltage VCP2 across the capacitor CP2 may be up to twice VS1. In this way, the output voltage VO1 may be up to three times VS1.

In a case where the charge pump is in the second operating mode, the switching transistor connected to the first phase clock signal PH1 and the switching transistor connected to the second-phase clock signal PH2 are alternately turned on at a 50% duty cycle.

In a case where the charge pump is at the first-phase clock signal PH1, a switching transistor M224 and a switching transistor M225 are turned on, such that the capacitor CP2 discharges to the capacitor CP. In this case, the output voltage VO1 is equal to a sum of the input voltage VS1 and the voltage VCP2 across the capacitor CP2, that is, VS1+VCP2.

In a case where the charge pump is at the second-phase clock signal PH2, the switching transistor M222, the switching transistor M223, and the switching transistor M227 are turned on, such that the capacitor CP2 starts to be charged. In this case, a voltage at a node CP2P is equal to VS1, such that the voltage across the capacitor CP1 is equal to 0. After the capacitor CP2 is charged, the voltage at the node CP2P may be up to VS1, such that the voltage across the capacitor CP2 may be up to VS1.

In summary, during the first-phase clock signal PH1, the capacitor CP2 may be charged; and during the second phase clock signal PH2, the capacitor CP2 may be discharged. Thus, the voltage VCP across the capacitor CP is equal to the voltage VCP2 across the capacitor CP2. In this way, the output voltage VO1 may be up to twice VS1.

However, in the related art, under special operating conditions such as power-up with an arbitrary initial value of an energy storage capacitor, input voltage transients, or open/short circuits of the energy storage capacitor, body diodes of power transistors in the charge pump may be turned on. This results in uncontrollable large currents flowing through the body diodes of the power transistors.

For example, in a case where the charge pump is at the second phase clock signal PH2 in the first operating mode, an initial potential of the capacitor CP1 is 14.5 V and initial potentials of the capacitor CP and the capacitor CP2 are both 0 V. Thus, the voltage VCP2P at the node CP2P is a sum of the input voltage VS1 and the initial potential of the capacitor CP1 of 14.5 V, i.e., VCP2P=VS1+14.5 V. The output voltage VO1 is VS1, and a voltage VCP2M at a node CP2M is a sum of the input voltage VS1 and the initial potential of the capacitor CP1 of 14.5V, i.e., VCP2M is equal to VS1+14.5 V. Since both the voltages at nodes CP2P and CP2M are greater than the output voltage VO1, body diodes of the switching transistors M224 and M225 are turned on. Consequently, the body diodes of the switching transistor M224 and the switching transistor M225 have an uncontrollable current.

For example, in a case where the charge pump is at the first-phase clock signal PH1 in the first operating mode, the input voltage VS1 is initially high and is V1, and the voltage VCP1 across the capacitor CP1 is equal to V1. The input voltage VS1 has a voltage transient from V1 to V2, wherein V2<V1. Since the voltage across the capacitor CP2 fails to undergo a transient, a voltage at a node CP1M becomes negative, such that a body diode of the switching transistor M226 is turned on. Consequently, the body diode of the switching transistor M226 may not have an uncontrolled current.

In addition, in the charge pump, the input terminal, the node CP1P, the node CP1M, the node CP2P, the node CP2M, and the output terminal are all high-voltage pins. The switching transistors M221 to M225 in the charge pump are all P-type transistors.

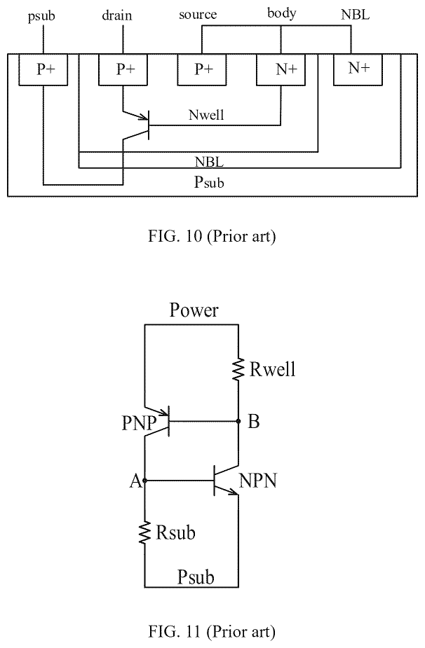

FIG. 10 is a schematic sectional view of a power transistor in a charge pump in the related art. Referring to FIG. 10, in a case where a body diode of a P-type switching transistor is turned on, a certain percentage of an on-current in the body diode may travel through along a path of: a drain of the P-type switching transistor-->a buried layer NBL of the P-type switching transistor-->a substrate psub of the P-type switching transistor, such that a parasitic PNP path leaks into the substrate psub of the P-type switching transistor.

In high-voltage applications of the charge pump, since the drain of the P-type switching transistor is at a high voltage and the substrate psub of the P-type switching transistor is at 0 V, a voltage drop Vpnp on the parasitic PNP path is a high voltage, and a current is Ipnp, such that a power Ppnp on the parasitic PNP path becomes larger. Consequently, the risk that the P-type switching transistor causes damages to the chip where the charge pump is arranged is present.

The power on the parasitic PNP path may be calculated by the following formula (1).

$$Ppnp = Vpnp * Ipnp \qquad ( 1 )$$

Ppnp represents the power on the parasitic PNP path, Vpnp represents the voltage drop on the parasitic PNP path, and Ipnp represents the current on the parasitic PNP path.

FIG. 11 is a schematic structural diagram of a latched path in a charge pump in the related art. Referring to FIG. 11, in a case where a body diode of a P-type switching transistor is turned on, and in a case where an on-current of the body diode is relatively large, the current in the parasitic PNP path also becomes large. Thus, the current in the parasitic PNP path travels through a parasitic resistor Rsub on the parasitic PNP path, and a potential of a node A is raised. In a case where an N-type region connected to a low potential (e.g., connected to the substrate psub) is present around the P-type switching transistor, the substrate psub acts as an emitter of the NPN. In this way, the parasitic NPN path is conducted, such that the current in the parasitic NPN path travels through the parasitic resistor Rwell in the parasitic NPN path, which increases the voltage drop across the parasitic resistor Rwell. Consequently, a potential of a node B is further pulled down (lowered). Thereby, an N-P-N-P latching path is formed, which puts the charge pump at risk of burnout (damages).

Embodiments of the present disclosure provide a current limiting circuit, a charge pump, a chip, and an electronic device.

The current limiting circuit and the charge pump may be chips or circuit modules.

The current limiting circuit and the charge pump may be integrated in a single chip, or may be integrated in different chips, which is not limited in the embodiments of the present disclosure.

In the present disclosure, the electronic device may include, but is not limited to, a charger, a tablet computer, a smart home device, a vehicle, and a wearable device.

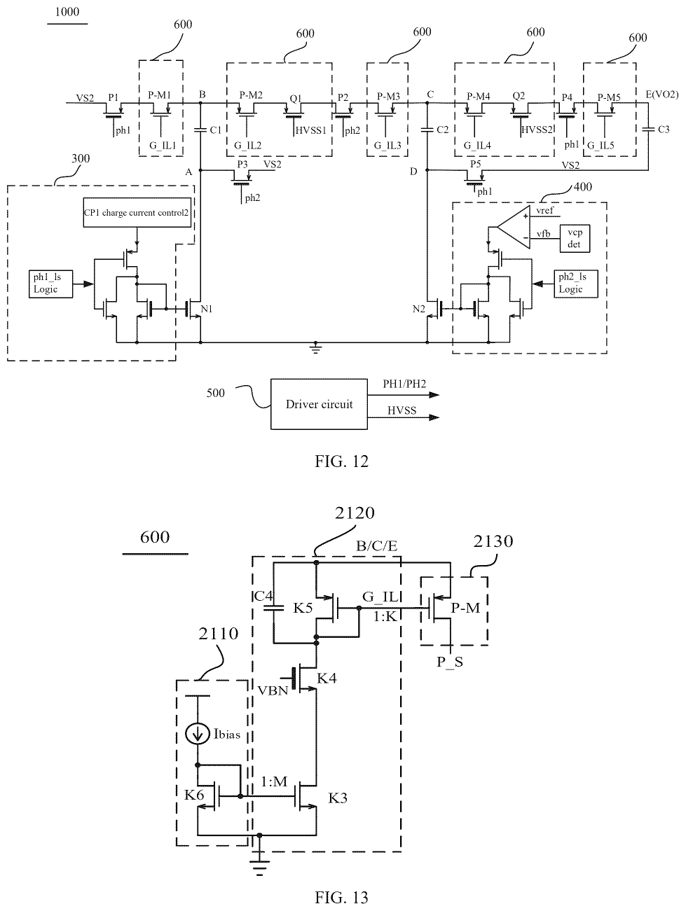

FIG. 12 is a schematic structural diagram of a charge pump 1000 according to some embodiments of the present disclosure. As illustrated in FIG. 12, the charge pump 1000 may include a first P-type power transistor P1, a second P-type power transistor P2, a third P-type power transistor P3, a fourth P-type power transistor P4, a fifth P-type power transistor P5, a first N-type power transistor N1, a second N-type power transistor N2, a first capacitor C1, a second capacitor C2, a third capacitor C3, a first control circuit 300, a second control circuit 400, a driver circuit 500, and at least one current limiting circuit 600.

A control terminal of the first P-type power transistor P1, a control terminal of the second P-type power transistor P2, a control terminal of the third P-type power transistor P3, a control terminal of the fourth P-type power transistor P4, and a control terminal of the fifth P-type power transistor P5 are all electrically connected to the driver circuit 500, a second terminal of the first P-type power transistor P1 and a first terminal of the third P-type power transistor P3 are both configured to receive an input voltage VS2 of the charge pump 1000, a second terminal of the first P-type power transistor P1 is electrically connected to a second terminal of the second P-type power transistor P2, and a first terminal of the second P-type power transistor P2 is electrically connected to a second terminal of the fourth P-type power transistor P4.

A first terminal of the first capacitor C1 is electrically connected between the second terminal of the first P-type power transistor P1 and the second terminal of the second P-type power transistor P2, a second terminal of the first capacitor C1 is electrically connected to a second terminal of the first N-type power transistor N1, a second terminal of the third P-type power transistor P3 is electrically connected between the second terminal of the first capacitor C1, and the second terminal of the first N-type power transistor N1, a control terminal of the first N-type power transistor N1 is electrically connected to the first control circuit 300, and a first terminal of the first N-type power transistor N1 and a first terminal of the second N-type power transistor N2 are both grounded.

A first terminal of the second capacitor C2 is electrically connected between the first terminal of the second P-type power transistor P2 and the second terminal of the fourth P-type power transistor P4, a second terminal of the second capacitor C2 is electrically connected to a second terminal of the second N-type power transistor N2, a second terminal of the fifth P-type power transistor P5 is electrically connected between the second terminal of the second capacitor C2 and the second terminal of the second N-type power transistor N2, and a control terminal of the second N-type power transistor N2 is electrically connected to the second control circuit 400.

A first terminal of the third capacitor C3 is electrically connected to a first terminal of the fourth P-type power transistor P4, and a second terminal of the third capacitor C3 is electrically connected to a first terminal of the fifth P-type power transistor P5.

The charge pump 1000 may include a plurality of nodes, wherein the plurality of nodes includes the first terminal of the first capacitor C1, the first terminal of the second capacitor C2, and the first terminal of the third capacitor C3, and the at least one current limiting circuit 600 is electrically connected to at least one of the plurality of nodes.

The plurality of nodes include a node B, a node C, and a node E. The node B is the first terminal of the first capacitor C1, the node C is the first terminal of the second capacitor C2, and the node E is the first terminal of the third capacitor C3.

One node may be electrically connected to one current limiting circuit 600, may be electrically connected to a plurality of current limiting circuits 600. Using the node B as an example, the node B may be electrically connected to one current limiting circuit 600, or may be electrically connected to two current limiting circuits 600. One current limiting circuit 600 may be electrically connected to one node.

The first control circuit 300, the second control circuit 400, and the driver circuit 500 have circuit structures similar to those in the related art, which are not described herein any further.

One or a plurality of current limiting circuits 600 may be arranged, which is not limited in the embodiments of the present disclosure. In different specific operating scenarios of the charge pump 1000, the body diodes of different power transistors may be turned on, such that a plurality of current paths are formed in the charge pump 1000 in response to the body diodes being turned on. For clarity, the current limiting circuit 600 may control the current in each of the current paths formed in response to the body diodes being turned on to be less than or equal to the second current I22, that is, controlling the current within a safe range. In this way, the current in each of the current paths formed in response to the body diodes being turned on is controlled within a safe range, such that the currents are controllable when the body diodes are turned on. Accordingly, as illustrated in FIG. 12, the charge pump 1000 may include a plurality of current limiting circuits 600.

Furthermore, to illustrate electrical connection relationships between the current limiting circuits 600 and different nodes, FIG. 12 only schematically illustrates partial components of the current limiting circuits 600.

A detailed explanation is given hereinafter to the operating principles of different current limiting circuits 600 in controlling the currents generated when the body diodes of the power transistors in the charge pump 1000 are turned on.

Under specific operating scenarios, the body diodes of the power transistors in the charge pump 1000 may be turned on. In this way, the current paths when the body diodes of the power transistors are turned on are present in the charge pump 1000. Since the current paths are electrically connected to the current limiting circuit 600, the current limiting circuit 600 may control the currents on these current paths to be less than or equal to the second current I22, such that the currents on the current paths are controllable. In this embodiment, the symbol “-->” denotes directionality. For example, “a-->b” indicates a transition from “a” to “b.”

In a case where the current limiting component 2130 is a P-type transistor P-M1, when the charge pump 1000 operates at the first-phase clock signal PH1 in the first operating mode, initially, an input voltage VS2 is V1. Since the input voltage VS2 is relatively high, a voltage VC1 across the first capacitor C1 is also relatively high. Assuming that in this case, the voltage VC1 across the first capacitor C1 is V1, then, where the input voltage VS2 undergoes a downward transient from V1 to V2, where V2<V1, a voltage VB at the node B becomes V2. Since the voltage across the first capacitor C1 may not change instantaneously, a voltage VA at the node A becomes a difference between V2 and the voltage VC1 across the first capacitor C1, i.e., VA=V2−V1, that is, VA is a negative voltage. Thus, a voltage at the first terminal of the first N-type power transistor N1 is greater than a voltage at the second terminal of the first N-type power transistor N1, such that the body diode of the first N-type power transistor N1 is turned on. In this case, a current path formed when the body diode of the first N-type power transistor N1 is turned on is as follows: the first N-type power transistor N1-->the node A-->the node B-->input terminal.

Furthermore, since the current limiting circuit 600 is electrically connected to the node B, the current limiting circuit 600 may be electrically connected in this current path. In this way, the current limiting circuit 600 may control the current in this current path to be less than or equal to the second current I22, such that the current in this current path is controllable. Hence, the current limiting circuit 600 may control the current flowing through the body diode, in response to being turned on, of the first N-type power transistor N1 to be less than or equal to the second current I22, such that the current flowing through the body diode, in response to being turned on, of the first N-type power transistor N1 is controllable.

In a case where the current limiting component 2130 is a P-type transistor P-M3, when the charge pump 1000 operates at the second-phase clock signal PH2 in the second operating mode, initially, the input voltage VS2 is V1. Since the input voltage VS2 is relatively high, a voltage VC2 across the second capacitor C2 is also relatively high. Assuming that in this case, the voltage VC2 across the second capacitor C2 is V1, then, where the input voltage VS2 undergoes a downward transient from V1 to V2, where V2<V1, a voltage VC at the node C becomes V2. Since the voltage across the second capacitor C2 may not change instantaneously, a voltage VD at the node D becomes a difference between V2 and the voltage VC2 across the second capacitor C2, i.e., VD=V2−V1, that is, VA is a negative voltage. Thus, a voltage at the first terminal of the second N-type power transistor N2 is greater than a voltage at the second terminal of the second N-type power transistor N2, such that the body diode of the first N-type power transistor N2 is turned on. In this case, a current path formed when the body diode of the second N-type power transistor N2 is turned on is as follows: the second N-type power transistor N2-->the node A-->the node B-->the input terminal.

Furthermore, since the current limiting circuit 600 is electrically connected to the node C, the current limiting circuit 600 may be electrically connected in this current path. In this way, the current limiting circuit 600 may control the current in this current path to be less than or equal to the second current I22, such that the current in this current path is controllable. Hence, the current limiting circuit 600 may control the current flowing through the body diode, in response to being turned on, of the second N-type power transistor N2 to be less than or equal to the second current I22, such that the current flowing through the body diode, in response to being turned on, of the second N-type power transistor N2 is controllable.

In a case where the current limiting assembly 2130 is a P-type transistor P-M2, when the charge pump 1000 operates in the first operating mode, an initial voltage VC1 across the first capacitor C1 is relatively high, and an initial voltage VC2 across the second capacitor C2 and an initial voltage VC3 across the third capacitor 3 are both 0 V. Under the effect of the second-phase clock signal PH2, the voltage VC at the node C is VS2+VC1. Since the initial voltage VC2 across the second capacitor C2 is 0 V and fails to undergo a transient, the voltage VD at the node D is also VS2+VC1. Thus, a voltage at the first terminal of the fifth P-type power transistor P5 is greater than a voltage at the second terminal of the fifth P-type power transistor P5, such that the body diode of the fifth P-type power transistor P5 is turned on. In this case, a current path formed when the body diode of the fifth P-type power transistor P5 is turned on is as follows: the third P-type power transistor P3-->the node A-->the node B-->the node C-->the node D-->the second terminal of the third capacitor C3.

Furthermore, since the initial voltage VC3 across the third capacitor C3 is also 0 V, the output voltage VO2 of the charge pump 1000 is equal to VS2. Thus, a voltage at the first terminal of the fourth P-type power transistor P4 is greater than a voltage at the second terminal of the fourth P-type power transistor P4, such that the body diode of the fourth P-type power transistor P4 is turned on. In this case, a current path formed when the body diode of the fourth P-type power transistor P4 is turned on is as follows: the third P-type power transistor P3-->the node A-->the node B-->the node C-->the node D-->the node E.

Hence, since the current limiting circuit 600 is electrically connected to the node B, the current limiting circuit 600 may be electrically connected in the current path formed when the body diode of the fifth P-type power transistor P5 is turned on and in the current path formed when the body diode of the fourth P-type power transistor P4 is turned on. In this way, the current limiting circuit 600 may control the currents in these two current paths to be less than or equal to the second current I22, such that the current in these two current paths are both controllable.

Hence, the current limiting circuit 600 may control the current flowing through the body diode, in response to being turned on, of the fifth P-type power transistor P5 and the current flowing through the body diode, in response to being turned on, of the fourth P-type power transistor P4 to be both less than or equal to the second current I22, such that these two currents are controllable. In this way, currents in parasitic PNP paths formed due to a manufacture process that flow into the fourth P-type power transistor P4 and the fifth P-type power transistor P5 are reduced, and the risk that the fourth P-type power transistor P4 and the fifth P-type power transistor P5 cause damages to the chip where the charge pump 1000 is arranged is avoided, and the fourth P-type power transistor P4 and the fifth P-type power transistor P5 are prevented from forming an N-P-N-P latched current path.

In a case where the current limiting assembly 2130 is a P-type transistor P-M4, when the charge pump 1000 operates in the first operating mode, the initial voltage VC2 across the second capacitor C2 is relatively high, and the initial voltage VC3 across the third capacitor C3 is 0 V. Under the effect of the first-phase clock signal PH1, the voltage VC at the node C is VS2+VC2. Since the initial voltage VC3 across the third capacitor C3 is 0 V and fails to undergo a transient, the voltage VD at the node E is also VS2. Thus, even if the fifth P-type power transistor P5 is turned on, a voltage drop generated by an on-resistance of the fifth P-type power transistor P5 causes the body diode of the fifth P-type power transistor P5 to be turned on. In this case, a current path formed when the body diode of the fifth P-type power transistor P5 is turned on is as follows: the second terminal of the third capacitor C3-->the node D-->the node C-->the node E.

Furthermore, since the current limiting circuit 600 is electrically connected to the node C, the current limiting circuit 600 may be electrically connected in this current path. In this way, the current limiting circuit 600 may control the current in this current path to be less than or equal to the second current I22, such that the current in this current path is controllable. Hence, the current limiting circuit 600 may control the current flowing through the body diode, in response to being turned on, of the fifth P-type power transistor P5 to be less than or equal to the second current I22, such that the current flowing through the body diode, in response to being turned on, of the fifth P-type power transistor P5 is controllable. In this way, a current in a parasitic PNP path formed due to a manufacture process that flows into the fifth P-type power transistor P5 decreases, and the risk that the fifth P-type power transistor P5 causes damages to the chip where the charge pump 1000 is arranged is avoided, and the fifth P-type power transistor P5 are prevented from forming an N-P-N-P latched current path.

In a case where the current limiting assembly 2130 is a P-type transistor P-M5, when the charge pump 1000 operates in the first operating mode, the initial voltage VC2 across the second capacitor C2 is 0 V, and the initial voltage VC3 across the third capacitor C3 is relatively high. Under the effect of the first-phase clock signal PH1, the voltage at the node E is VS2+VC3. Since the initial voltage VC2 across the second capacitor C2 is 0 V, the voltage VC at the node C is VS2+VC3, and the voltage across the capacitor fails to undergo a transient, the voltage VD at the node D is also VS2+VC3. Thus, even if the fifth P-type power transistor P5 is turned on, the voltage drop generated by an the-resistance of the fifth P-type power transistor P5 causes the body diode of the fifth P-type power transistor P5 to be turned on. In this case, a current path formed when the body diode of the fifth P-type power transistor P5 is turned on is as follows: the node E-->the node C-->the node D-->the second terminal of the third capacitor C3.

Furthermore, since the current limiting circuit 600 is electrically connected to the node E, the current limiting circuit 600 may be electrically connected in this current path. In this way, the current limiting circuit 600 may control the current in this current path to be less than or equal to the second current I22, such that the current in this current path is controllable. Hence, the current limiting circuit 600 may control the current flowing through the body diode, in response to being turned on, of the fifth P-type power transistor P5 to be less than or equal to the second current I22, such that the current flowing through the body diode, in response to being turned on, of the fifth P-type power transistor P5 is controllable. In this way, a current in a parasitic PNP path formed due to a manufacture process that flows into the fifth P-type power transistor P5 decreases, and the risk that the fifth P-type power transistor P5 causes damages to the chip where the charge pump 1000 is arranged is avoided, and the fifth P-type power transistor P5 are prevented from forming an N-P-N-P latched current path.

In addition, the operating principles of the charge pump 1000 entering the first operating mode and the second operating mode according to the embodiments of the present disclosure are similar to those of the charge pump in the related art, which are thus not described herein any further.

FIG. 13 is a schematic structural diagram of the current limiting circuit 600 in FIG. 11. The current limiting circuit 600 may include a first current output circuit 2110, a second current output circuit 2120, and a current limiting assembly 2130.

An output terminal of the first current output circuit 2110 is electrically connected to a first terminal of the second current output circuit 2120, a second terminal of the second current output circuit 2120 is electrically connected to a control terminal of the current limiting assembly 2130, a third terminal of the second current output circuit 2120 and a first terminal of the current limiting assembly 2130 are both electrically connected to a node in the charge pump 1000, a second terminal of the current limiting assembly 2130 is electrically connected to a second terminal of a P-type power transistor in the charge pump 1000, and a ground terminal of the first current output circuit 2110 and a ground terminal of the second current output circuit 2120 are both grounded.

The first current output circuit 2110, the second current output circuit 2120, and the current limiting assembly 2130 may be arranged separately, or may be integrated.

In some examples, the current limiting circuit 2130 may include a P-type transistor P-M; wherein a first terminal of the P-type transistor P-M is electrically connected to a node in the charge pump 1000, and a second terminal of the P-type transistor P-M is electrically connected to the second terminal of the P-type power transistor P in the charge pump 1000.

A withstand voltage of the P-type transistor P-M is less than or equal to a first predetermined withstand voltage.

The first current output circuit 2110 may transmit a first current I21 to the second current output circuit 2120, such that the second current output circuit 2120 is capable of obtaining the first current I21.

The first current I21 acts as a reference current.

Thus, the second current output circuit 2120 may obtain a second current I22 based on the first current I21. In addition, the second current output circuit 2120 may transmit the second current I22 to the current limiting assembly 2130, such that the current limiting assembly 2130 obtains the second current I22. In this way, a current in a direction from the first terminal of the current limiting assembly 2130 to the second terminal of the current limiting assembly 2130 may be up to the second current I22.

The second current output circuit 2120 may obtain the second current I22 by amplifying the first current I21, or may obtain the second current I22 by attenuating the first current I21, or may obtain the second current I22 by proportionally duplicating the first current I21. Generally, the second current I22 is obtained by amplifying the first current I21.

Since the current limiting assembly 2130 operates in a saturation region in a case where a body diode of a power transistor in the charge pump 1000 is turned on (forward-biased), the current limiting assembly 2130 may control a current flowing through the body diode, in response to being turned on, of the power transistor in the charge pump 1000 to be less than or equal to the second current I22. Hence, the current limiting assembly 2130 may control the current flowing through the body diode, in response to being turned on, of the power transistor in the charge pump 1000 to be less than or equal to the second current I22. In this way, the current flowing through the body diode, in response to being turned on, of the power transistor in the charge pump 1000 is controllable.

The current limiting assembly 2130 may control a current flowing through a body diode, in response to being turned on, of an N-type power transistor N in the charge pump 1000 to be less than or equal to the second current I22, or may control a current flowing through a body diode, in response to being turned on, of a P-type power transistor P in the charge pump 1000 to be less than or equal to the second current I22. In a case where the current limiting assembly 2130 controls the current flowing through the body diode, in response to being turned on, of the P-type power transistor P in the charge pump 1000 to be less than or equal to the second current I22, a current in a parasitic PNP path formed due to a manufacture process that flows into the P-type power transistor P decreases, and the risk that the P-type transistor P causes damages to the chip where the charge pump 1000 is arranged is avoided, and the P-type transistor P5 is prevented from forming an N-P-N-P latched path.

Embodiments of the present disclosure provide a current limiting circuit, a chip, and an electronic device. The first current output circuit may transmit the first current acting as the reference current to the second current output circuit, such that the second current output circuit obtains the first current. In this case, the second current output circuit may obtain the second current based on the first current, and transmit the second current to the current limiting assembly, such that the current limiting assembly controls a current flowing through a body diode, in response to being turned on, of a power transistor in the charge pump to be less than or equal to the second current. Hence, the current limiting assembly may control the current flowing through the body diode, in response to being turned on, of the power transistor in the charge pump to be less than or equal to the second current. In this way, the current flowing through the body diode, in response to being turned on, of the power transistor in the charge pump is controllable.

Based on the description of the above embodiments, exemplarily, a possible implementation of the current limiting circuit 600 is described hereinafter. FIG. 14 is a schematic structural diagram of the current limiting circuit 600 in FIG. 12 and FIG. 13. The current limiting circuit 600 may include a regulation circuit 2140.

A first terminal of the regulation circuit 2140 is electrically connected to the first terminal of the second current output circuit 2120, a control terminal of the regulation circuit 2140 is configured to receive a control signal ctrl, a second terminal of the regulation circuit 2140 is electrically connected to a fourth terminal of the second current output circuit 2120, and a ground terminal of the regulation circuit 2140 is grounded.

The second current output circuit 2120 may transmit the second current I22 to the regulation circuit 2140, such that the regulation circuit 2140 obtains the second current I22.

Thus, under the effect of the control signal ctrl, the regulation circuit 2140 is conducted, such that the regulation circuit 2140 mirrors the second current I22. In this way, the regulation circuit 2140 may obtain a mirrored second current I22, and transmit the mirrored second current I22 to the second current output circuit 2120. Hence, the second current I22 changes from the second current I22 before mirroring to a sum of the second current I22 before mirroring and the mirrored second current I22, such that the second current I22 becomes larger. In this way, the regulation circuit 2140 may regulate a magnitude of the second current I22, such that the current limiting circuit 600 controls the current of the body diode, in response to being turned on, of the power transistor in the charge pump 1000 under different load conditions. That is, the regulation circuit 2140 may adjust the magnitude of the second current I22, such that the current limiting circuit 600 has regulatable control levels.

For example, the regulation circuit 2140 may acquire the control signal ctrl from a register. During the process that the current limiting circuit 600 controls the currents in the current paths formed when the body diodes of different power transistors, that is, the current limiting circuit 600 controls the currents flowing through the body diodes, in response to being turned on, of the different power transistors, the control signals ctrl acquired by the regulation circuit 2140 are different. That is, different current limiting circuits 600 may independently and individually acquire their corresponding control signals ctrl.

In summary, the second current output circuit may transmit the second current to the regulation circuit, such that the regulation circuit obtains the second current. Thus, under the effect of the control signal, the regulation circuit may mirror the second current, such that the second current changes to the sum of the second current before mirroring and the mirrored second current. In this way, the regulation circuit may adjust the magnitude of the second current, such that the current limiting circuit has regulatable control levels.

Based on the description of the above embodiments, exemplarily, one possible implementation of the regulation circuit 2140 is described hereinafter. As illustrated in FIG. 14, the regulation circuit 2140 may include at least one current mirror assembly.

A first terminal of the current mirror assembly is electrically connected to the fourth terminal of the second current output circuit 2120, a control terminal of the current mirror assembly is configured to receive the control signal ctrl, a second terminal of the current mirror assembly is electrically connected to the first terminal of the second current output circuit 2120, and a third terminal of the current mirror assembly is grounded.

The current mirror assembly may be turned on under the effect of the control signal ctrl. Thus, the current mirror assembly may mirror the second current I22, such that the regulation circuit 120 is capable of mirroring the second current I22. In this way, the regulation circuit 120 may regulate a magnitude of the second current I22.

The number of current mirror assembles may be one, three, or five, which is not limited in the embodiments of the present disclosure.

In summary, under the effect of the control signal, the current mirror assembly may be conducted, such that the current mirror assembly is capable of mirroring the second current. In this way, the regulation circuit may regulate the magnitude of the second current.

Based on the description of the above embodiments, exemplarily, one possible implementation of the current mirror assembly is described hereinafter. As illustrated in FIG. 14, the current mirror assembly may include a first switching transistor K1 and a second switching transistor K2.

A second terminal of the first switching transistor K1 is electrically connected to the fourth terminal of the second current output circuit 2120, a control terminal of the first switching transistor K1 is configured to receive the control signal ctrl, a first terminal of the first switching transistor K1 is electrically connected to a second terminal of the second switching transistor K2, a control terminal of the second switching transistor K2 is electrically connected to the first terminal of the second current output circuit 2120, and a first terminal of the second switching transistor K2 is grounded.

In summary, under the effect of the control signal ctrl, the first switching transistor K1 is turned on, such that the current on the second switching transistor K2 is obtained by mirroring the second current I22. In this way, under the effect of the control signal, the current mirror assembly may mirror the second current I22.

In summary, under the effect of the control signal, the first switching transistor is turned on, such that the second switching transistor is capable of mirroring the second current. In this way, under the effect of the control signal, the current mirror assembly may mirror the second current.

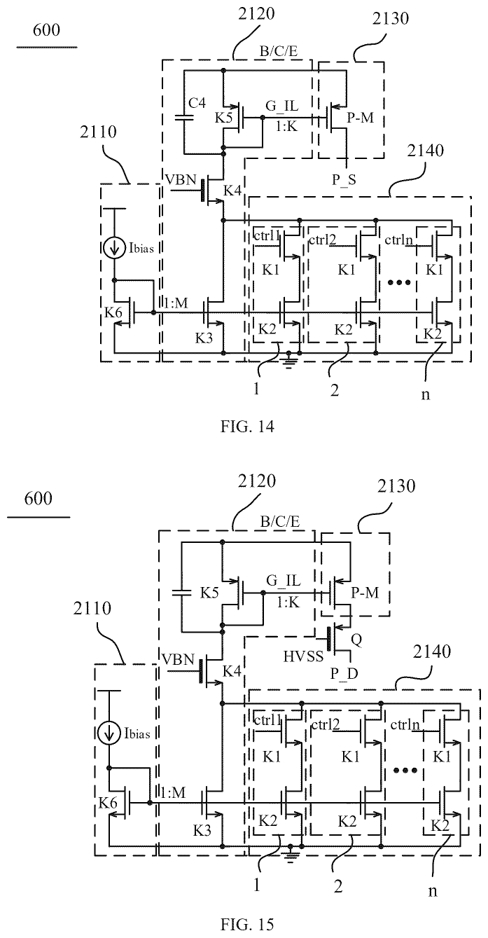

Based on the description of the above embodiments, exemplarily, another possible implementation of the current limiting circuit 600 is described hereinafter. FIG. 15 is a schematic structural diagram of the current limiting circuit in FIG. 12 and FIG. 13. In a case where the current limiting assembly 2130 includes a P-type transistor P-M2 and a P-type transistor P-M4, the current limiting circuit 600 may further include a power transistor Q.

A first terminal of the power transistor Q is electrically connected to the second terminal of the current limiting assembly 2130, a second terminal of the power transistor Q is electrically connected to a first terminal of the P-type transistor P in the charge pump 1000, and a control terminal of the power transistor Q is electrically connected to the driver circuit 500 in the charge pump 1000.

In some examples, a withstand voltage of the power transistor Q is greater than a second predetermined withstand voltage.

In a case where the current limiting assembly 2130 includes a P-type transistor P-M2 and the power transistor Q is the power transistor Q1, a voltage VHVSS1 acquired by the control terminal of a power transistor Q1 from the driver circuit 500 in the charge pump 1000 is a difference between the voltage VB at the node B and 5 V, that is, VHVSS1 is equal to VB-5 V. 5 V is a voltage obtained by the driver circuit 500 within a high-voltage domain. In this way, a voltage difference between a voltage at the second terminal of the current limiting assembly 2130 and a voltage at the first terminal of the current limiting assembly 2130 remains within a range where VB−VHVSS1 is less than or equal to 5 V, such that the current limiting assembly 2130 is prevented from over-voltage.

In a case where the current limiting assembly 2130 includes a P-type transistor P-M4, a voltage VHVSS2 acquired by the control terminal of a power transistor Q2 from the driver circuit 500 in the charge pump 1000 is a difference between the voltage VC at the node C and 5 V, that is, VHVSS2 is equal to VC-5 V. 5 V is a voltage obtained by the driver circuit 500 within a high-voltage domain. In this way, a voltage difference between a voltage at the second terminal of the current limiting assembly 2130 and a voltage at the first terminal of the current limiting assembly 2130 remains within a range where VC−VHVSS2 is equal to 5 V, such that the current limiting assembly 2130 is prevented from over-voltage.

In a case where the current limiting assembly 2130 includes a P-type transistor P-M1, a P-type transistor P-M3, and a P-type transistor P-M5, since the first P-type power transistor P1, the second P-type power transistor P2, and the fourth P-type transistor P4 may respectively protect the P-type transistor P-M1, the P-type transistor P-M3, and the P-type transistor P-M5, the P-type transistor P-M1, the P-type transistor P-M3, and the P-type transistor P-M5 are prevented from over-voltage. Therefore, the corresponding current limiting circuit 600 may not include the power transistor Q.

In addition, P_S in FIG. 13 and FIG. 14 represents a first terminal of the P-type power transistor. P_S in FIG. 15 represents a second terminal of the P-type power transistor.

In summary, using the power transistors, the voltage difference between the voltage at the second terminal of the current limiting assembly 2130 and the voltage at the first terminal of the current limiting assembly 2130 remains within a safe voltage range. In this way, the current limiting assembly is prevented from over-voltage, and a protection effect is achieved for the current limiting assembly.

Based on the description of the above embodiment, exemplarily, one possible implementation of the second current output circuit 2120 is described hereinafter. As illustrated in FIG. 13 to FIG. 15, the second current output circuit 2120 may include a third switching transistor K3, a fourth switching transistor K4, and a fifth switching transistor K5.

A control terminal of the third switching transistor K3 is electrically connected to the output terminal of the first current output circuit 2110, a first terminal of the third switching transistor K3 is grounded, a second terminal of the third switching transistor K3 is electrically connected to a first terminal of the fourth switching transistor K4, a control terminal of the fourth switching transistor K4 is configured to receive a bias voltage VBN, a second terminal of the fourth switching transistor K4 is electrically connected to a second terminal of the fifth switching transistor K5, a control terminal of the fifth switching transistor K5, and the control terminal of the current limiting assembly 2130, and a first terminal of the fifth switching transistor K5 is electrically connected to a node in the charge pump 1000.

In some examples, a withstand voltage of the fourth switching transistor K4 is greater than a third predetermined withstand voltage.

High-voltage may be blocked using the high-voltage fourth switching transistor K4, and hence a volume of the fourth switching transistor K4 may be reduced.

The first current I21 may be acquired from the first current output circuit 2110 via the second switching transistor K3, and the second current I22 may be obtained based on the first current I21. Thus, the second current I22 flows through the fourth switching transistor K4 to the fifth switching transistor K5, such that the second current I22 may flow through the fifth switching transistor K5 to the current limiting assembly 2130. In this way, the second current output circuit 2120 may obtain the second current I22, and transmit the second current I22 to the current limiting assembly 2130.

In addition, for example, in a case where a size ratio of the fifth switching transistor K5 to the P-type transistor P-M is 1:K, the second current I22 may be up to K times the current of the fifth switching transistor K5.

In some examples, the second current output circuit 2120 may further include a fourth capacitor C4. A first terminal of the fourth capacitor C4 is electrically connected to the first terminal of the fifth switching transistor K5, and a second terminal of the fourth capacitor C4 is electrically connected between the second terminal of the fifth switching transistor K5 and the second terminal of the fourth switching transistor K4.

Since the fourth capacitor C4 is capable of storing energy, the second current I22 flowing to the fifth switching transistor K5 tends to be stable.

In summary, the first current may be acquired via the second switching transistor, and the second current may be obtained based on the first current. Thus, the second current flows through the fourth switching transistor to the fifth switching transistor, such that the second current may flow through the fifth switching transistor to the current limiting assembly. In this way, the second current output circuit may obtain the second current.

Based on the description of the above embodiment, exemplarily, one possible implementation of the second current output circuit 2120 is described hereinafter. As illustrated in FIG. 13 to FIG. 15, the first current output circuit 2110 may include a current source and a sixth switching transistor K6.

An output terminal of the current source is electrically connected to a second terminal of the sixth switching transistor K6, a control terminal of the sixth switching transistor K6 is electrically connected between the output terminal of the current source and a first terminal of the sixth switching transistor K6, the control terminal of the sixth switching transistor K6 is further electrically connected to the first terminal of the second current output circuit 2120, and the first terminal of the sixth switching transistor K6 is grounded.

A size ratio of the sixth switching transistor K6 to the third switching transistor K3 is 1:M, such that the second current I22 is M times the first current I21.

A current Ibias output by the current source may be converted to the first current I21 after flowing through the sixth switching transistor K6. Thus, the first current output circuit 2110 may obtain the first current I21, and the first current I21 may be transmitted to the second current output circuit 2120 via the sixth switching transistor K6.

In summary, the current output by the current source may be converted to the first current via the sixth switching transistor. In this way, the first current output circuit may obtain the first current.

The switching transistors according to the embodiments of the present disclosure are all three-terminal switching transistors. For example, each of the switching transistors has a control terminal, a first terminal, and a second terminal. The switching transistors may be bipolar switching transistors or field-effect switching transistors. For example, in a case where the switching transistor is a bipolar switching transistor, the control terminal of the switching transistor refers to a base of the bipolar switching transistor, the first terminal refers to a collector or an emitter of the bipolar switching transistor, and the second terminal refers to an emitter or a collector; or in a case where the switching transistor is a field-effect switching transistor, the control terminal of the switching transistor refers to a gate of the field-effect switching transistor, the first terminal of the switching transistor refers to a drain or a source of the field-effect transistor, and the second terminal of the switching transistor is a source or a drain of the field-effect switching transistor.

The charge pump typically performing DC/DC voltage conversion by supplying power or cutting off power to two or more than two capacitors using a switching network. In a basic charge pump circuit, the switching network continuously switches between supplying power and cutting of power to the capacitor.

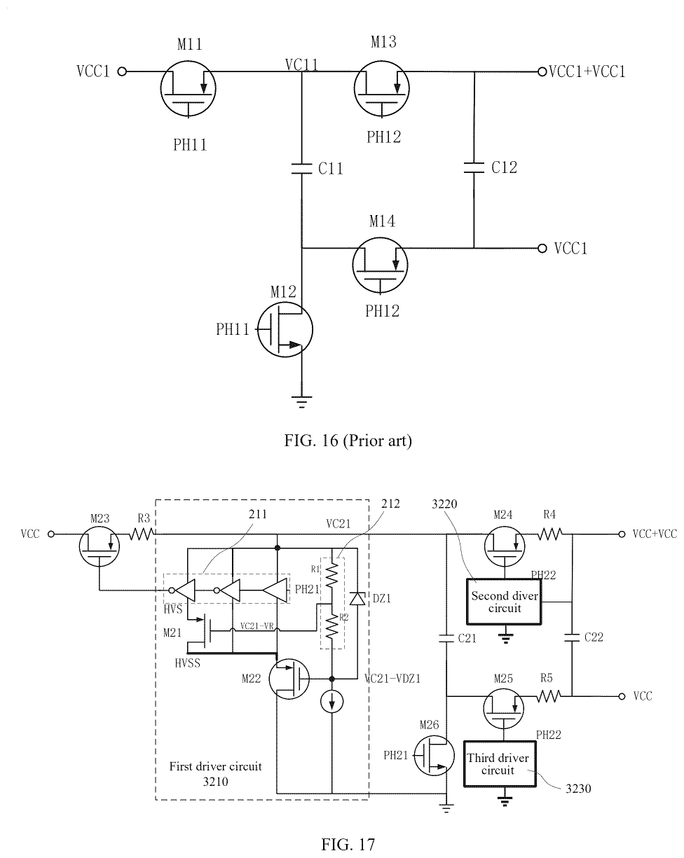

Different charge pump may achieve voltage conversion at different ratios, for example, half-voltage conversion, 2× voltage conversion, 3× voltage conversion. The structure of the charge pump is exemplarily described hereinafter with reference to the charge pump having the 2× voltage conversion function in FIG. 16.

FIG. 16 is a schematic structural diagram of a charge pump in the related art. The charge pump as illustrated in FIG. 16 includes a switching transistor M11, a switching transistor M12, a switching transistor M13, a switching transistor M14, a capacitor C11, and a capacitor C12. The first-stage energy storage branch includes a switching transistor M11, a switching transistor M12, and a capacitor C11; and the second-stage energy storage branch includes a switching transistor M13, a switching transistor M14, and a capacitor C12. In practice, the charge pump operates in two phases. In a first phase, in the first-stage energy storage branch, the switching transistor M11 and the switching transistor M12 are controlled to be turned on based on a signal PH11, and an output voltage VCC1 charges the capacitor C11. In a second phase, the switching transistor M11 and the switching transistor M12 in the first-stage energy storage branch are turned on, and the switching transistor M13 and the switching transistor M14 are turned on, the input voltage VCC1 may be represented by VCC1, a bottom plate of the capacitor C11 is electrically connected to the input voltage VCC1, and a top plate of the capacitor C11 is electrically connected to the output terminal of the charge pump. Since a voltage difference across the capacitor fails to undergo a transient, an output voltage of the top plate of the capacitor C11 is VCC1+VCC1, and the capacitor C11 outputs a voltage of VCC1+VCC1 to charge the capacitor C12. That is, the charge pump achieves 2× voltage conversion.

However, using the charge pump in FIG. 16 as an example, the switching transistors in the charge pump all have a smaller resistance, and in a case where the input voltage VCC1 is abruptly applied to the capacitor C11, a peak current of the capacitor C11 may be represented by the following formula (1).

$${I}_{peak} = C 1 \frac{dV}{dt} \qquad Formula ( 1 )$$

Iₚₑₐₖ Represents the peak value, C1 represents a capacity of the capacitor C11, and V represents the input voltage.

The input voltage is equivalent to a step voltage, where a peak current region thereof is infinitely large.

In addition, during normal operation of the charge pump, the resistances Ron of the switching transistors in the charge pump circuit are only observed. Assuming that a voltage at the top plate of the capacitor C11 is VC11, then the current in the circuit is (VCC1−VC11)/Ron or is a reverse current (VC11−VCC1)/Ron. Since the resistances of the switching transistors are relatively small, as seen from the above analysis, the peak current is relatively large.

In a case where the on-chip capacitance is large or an external capacitor is used, the peak current in the charge pump may be relatively high, which further leads to damages of the charge pump circuit and reduced reliability of the charge pump.

In view of the above technical problems, some embodiments of the present disclosure provide a driver circuit, a charge pump, a chip, and an electronic device. The original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

The technical solutions according to the present disclosure are described in detail with reference to some specific embodiments.

Some embodiments of the present disclosure provide a charge pump. The charge pump includes a driver circuit and energy storage branches in at least two stages; wherein an output terminal of the energy storage branch in a previous stage is electrically connected to an input terminal of the energy storage branch in a subsequent stage, each of the energy storage branches in at least two stages includes at least one switching transistor and a capacitor, an output terminal of the driver circuit is electrically connected to a control terminal of at least one switching transistor in a first-stage energy storage branch, and the energy storage branches in at least two stages include the first-stage energy storage branch and a second-stage energy storage branch.

The structure of a charge pump according to some embodiments of the present disclosure is described hereinafter with reference to FIG. 17. It should be understood that the charge pump in FIG. 17 is merely an example and does not constitute limitations to the present disclosure.

FIG. 17 is a schematic structural diagram of a charge pump according to some embodiments of the present disclosure. The driver circuit according to the embodiments of the present disclosure is applicable to the charge pump. FIG. 17 exemplarily illustrates energy storage branches in two stages, including a first-stage energy storage branch formed by a third switching transistor M23, a first capacitor C21, and a sixth switching transistor M26, and a second-stage energy storage branch formed by a fourth switching transistor M24, a capacitor C22, and a fifth switching transistor M25. The structure of the energy storage branch of the charge pump in FIG. 17 is similar to that of the energy storage branch in the charge pump of FIG. 16, which is thus not described herein any further.

It should be noted that the type of the switching transistors in the charge pump according to the embodiments herein is not limited in the present disclosure. The switching transistors exemplarily illustrated in FIG. 17 are field-effect transistors.

An output terminal of a first driver circuit 3210 is electrically connected to a control terminal of at least one of the switching transistors in the first-stage energy storage branch. The first driver circuit 3210 is configured to control the switching transistors in the energy storage branch to be turned on or turned off, such that the capacitors in the energy storage branch are charged or discharged. FIG. 17 exemplarily illustrates the structure of the first driver circuit 3210, which is arranged in the first-stage energy storage branch of the charge pump.

Hereinafter, the structure of a first driver circuit 3210 according to some embodiments of the present disclosure is described with reference to FIG. 17. The first driver circuit 3210 includes a first Zener diode DZ1, a first voltage divider circuit 212, a first current source I, a first level conversion circuit 211, a first switching transistor M21, and a second switching transistor M22.

An input terminal of the first level conversion circuit 211 is configured to receive a first-phase clock signal PH21, and an output terminal of the first level conversion circuit 211 is the output terminal of the first driver circuit 3210. An output terminal of the first level conversion circuit 211 is electrically connected to a control terminal of the switching transistor. As illustrated in FIG. 17, the first level conversion circuit 211 is electrically connected to a control terminal of the third switching transistor M23.

A first power supply terminal of the first level conversion circuit 211 is configured to receive the first power supply voltage. As illustrated in FIG. 17, the first power supply voltage is a voltage VC21 at a top plate of the first capacitor C21. The first power supply voltage may be from another source, which is not limited in the present disclosure.

A second power supply terminal of the first level conversion circuit 211 is electrically connected to a second terminal of the first switching transistor M21.

The first level conversion circuit 211 is configured to convert the first-phase clock signal PH21 received at the input terminal into a signal with a voltage range from the voltage received at the second power supply terminal to the voltage received at the first power supply terminal. The converted voltage signal is output from the output terminal of the first level conversion circuit 211.

The output terminal of the first level conversion circuit 211 acts as the output terminal of the first driver circuit 3210, and is electrically connected to the control terminal of the switching transistor. As illustrated in FIG. 17, the output terminal of the first level conversion circuit 211 is connected to the control terminal of the third switching transistor M23. Since the third switching transistor M23 is arranged in the branch where the input voltage is electrically connected to the capacitor C21, the switching transistor M23 is a high-voltage transistor. The first-phase clock signal PH21 is a low-voltage signal, and thus it is necessary to convert the low-voltage first-phase clock signal PH21 into a relatively higher voltage signal via the first level conversion circuit 211, such that the third switching transistor M23 may be driven.

Further, the first level conversion circuit 211 includes a first level converter and series-connected inverters in a plurality of stages that are connected sequentially. An input terminal of the first level converter is configured to receive the first-phase clock signal. An output terminal of the inverter in a last stage in the series-connected inverters in the plurality of stages is the output terminal of the first driver circuit. The first level conversion circuit is configured to convert a level value of the first-phase clock signal, and output a converted first-phase clock signal at the output terminal of the first level conversion circuit. The series-connected inverters in the plurality of stages may be configured to enhance signal strength and maintain signal integrity. Exemplarily, still referring to FIG. 17, inverters in two stages are exemplarily illustrated, including a first inverter and a second inverter. An input terminal of the first inverter is electrically connected to an output terminal of the first level converter, an output terminal of the first inverter is electrically connected to an input terminal of the second inverter, and the output terminal of the second inverter is the output terminal of the first driver circuit.

A control terminal of the first switching transistor M21 is electrically connected to an output terminal of the first voltage divider circuit 212, a first terminal of the first switching transistor M21 is electrically connected to a second terminal of the second switching transistor M22, a control terminal of the second switching transistor M22 is electrically connected to a positive terminal of the first Zener diode DZ1, and a first terminal of the second switching transistor M22 is grounded.

Furthermore, the first switching transistor M21 may be a P-channel metal-oxide-semiconductor field-effect transistor (PMOSFET). Accordingly, the control terminal of the first switching transistor M21 is a gate of the first switching transistor M21, the first terminal of the first switching transistor M21 is a source of the first switching transistor M21, and the second terminal of the first switching transistor M21 is a drain of the first switching transistor M21.

Furthermore, the second switching transistor M22 may also be a PMOSFET. Correspondingly, the control terminal of the second switching transistor M22 is a gate of the second switching transistor M22, the first terminal of the second switching transistor M22 is a source of the second switching transistor M22, and the second terminal of the second switching transistor M22 is a drain of the second switching transistor M22.

A negative terminal of the first Zener diode DZ1 is configured to receive a first power supply voltage. The positive terminal of the first Zener diode DZ1 is grounded via the first current source I.

The first power supply voltage received at the negative terminal of the first Zener diode DZ1 is the same as the first power supply voltage received at the first power supply terminal of the first level conversion circuit 211.

The first voltage divider circuit 212 and the first Zener diode DZ1 are connected in parallel. The first voltage divider circuit 212 is configured to divide a voltage across the two terminals of the first Zener diode DZ1, and output a divided voltage at the output terminal of the first voltage divider circuit, such that a voltage at the second terminal of the first switching transistor M21 is greater than a difference between the power supply voltage and the divided voltage.

The first level conversion circuit 211 is configured to convert a level value of the first-phase clock signal, and output a converted first-phase clock signal at the output terminal of the first level conversion circuit.

A level value of the converted first-phase clock signal is within a value range from the power supply voltage to the voltage at the second terminal of the first switching transistor M21.

Further, the first voltage divider circuit 212 may be implemented by resistors that are connected in series. As illustrated in FIG. 17, the first voltage divider circuit 212 includes a first resistor R1 and a second resistor R2 that are connected in series. A first terminal of the first resistor R1 is electrically connected to the negative terminal of the first Zener diode DZ1, a second terminal of the first resistor R1 is electrically connected to a first terminal of the second resistor R2, a second terminal of the second resistor R2 is electrically connected to the positive terminal of the first Zener diode DZ1, and a first terminal of the second resistor R2 is electrically connected to the control terminal of the first switching transistor M21.

In some embodiments, the charge pump further includes a third resistor R3. The second terminal of the third switching transistor M23 is electrically connected to the top plate of the first capacitor C21 via the third resistor R3.

In practice, current limiting is achieved using the third resistor R3. In a case where the input voltage VCC is powered on, the peak current is VCC/R3, such that current limiting is implemented during power-up.

In practice, it is assumed that the source voltage of the second switching transistor M22 is represented as HVSS. Where the first switching transistor M21 is not arranged in the first driver circuit 3210, to ensure that HVSS follows the transient of VCC, during normal operation of the charge pump, the voltage HVSS may be generated using a clamping structure of the first Zener diode DZ1. HVSS is output at the output terminal of the first level conversion circuit 211. The current limit values for the forward and reverse currents of the first-stage energy storage branch are approximately (VC21−HVSS)/R, wherein R represents the sum of the resistance of the third resistor R3 and the gate-source resistance of the third switching transistor M23. Amusing that a gate-source voltage of the third switching transistor M23 is represented as VGS_M23, then since VGS_M23 is relatively low, for the sake of simplicity in analysis, VGS_M23 is ignored herein.

Furthermore, the first Zener diode DZ1 may be a device with a voltage drop of around 6 V. The following analysis is based on an example where the voltage drop of the first Zener diode DZ1 is 6 V. It should be understood that this example is provided for explanatory purposes and does not constitute limitations to the present disclosure.

Assuming that the gate-source voltage of the second switching transistor is represented as VSG_M22, then HVSS is equal to VC21−6+VSG_M22. Since the voltage drop of the first Zener diode DZ1 is 6 V, HVSS is relatively low. As seen from the previous current calculation formula (VC21−HVSS)/R, the current is still relatively large.

On the basis of the above circuit structure, the first switching transistor M21 and the first voltage divider circuit 212 are added to the first driver circuit 3210. A gate bias voltage of the first switching transistor M21 is obtained from the voltage divider of the first Zener diode DZ1 via the first voltage divider circuit 212. A voltage division ratio of the first voltage divider circuit 212 may be set based on the current limit value. Assuming that the voltage of the first voltage divider circuit 212 is represented as VR, the gate bias voltage of the first switching transistor M21 is equal to VC21−VR, and a source voltage of the first switching transistor M21 is equal to HVS=VC21−3V+VSG_M21. The current of the first-stage energy storage branch may be approximately represented as (VC21−HVS)/R3. It may be understood that HVS is greater than HVSS. Therefore, the current limit value of the first-stage energy storage branch may be controlled to a smaller range.

For example, when the resistances of the first and second resistors in the first voltage divider circuit 212 are equal, i.e., R1=R2, the voltage division ratio is 1/2, and the divided voltage VR=1/2*6V=3 V The gate bias voltage of the first switching transistor M21 is equal to VC21−VR=VC21−3V, and the source voltage of the first switching transistor M21 is equal to HVS=VC21−3V+VSG_M21. The voltage HVS is output at the output terminal of the first level conversion circuit 211, and in this case, the current limit value of the charge pump is approximately equal to (VC21−HVS)/R3.

Meanwhile, since the first Zener diode DZ1 is arranged in the first driver circuit, the first driver circuit may still function properly during significant transients in the power supply, such that current limiting is achieved for the charge pump.

In addition, a gate-source resistance of the third switching transistor M23 is variable, which changes with the variation of VGS_M23, and is approximately inversely proportional to VGS_M23. As the HVS voltage increases, VGS_M23 decreases, leading to an increase in the gate-source impedance of the third switching transistor M23, which, in turn, lowers the efficiency of the charge pump. Therefore, where HVS is relatively high, the efficiency of the charge pump during normal operation may be affected. Hence, the voltage division ratio of the first voltage divider circuit 212 may be adjusted to correspondingly set and regulate HVS, such that the efficiency of the charge pump and the reliability of the current-limiting protection are balanced.

In the driver circuit applicable to the charge pump according to the embodiments of the present disclosure, in the energy storage branch in any stage of the charge pump, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

Some embodiments of the present disclosure provide a charge pump. The charge pump includes a driver circuit and energy storage branches in at least two stages; wherein an output terminal of the energy storage branch in a previous stage is electrically connected to an input terminal of the energy storage branch in a subsequent stage, each of the energy storage branches in at least two stages includes at least one switching transistor and a capacitor, an output terminal of the driver circuit is electrically connected to a control terminal of at least one switching transistor in a first-stage energy storage branch, and the energy storage branches in at least two stages include the first-stage energy storage branch.

The driver circuit is the driver circuit according to any of the above embodiments.

The implementation principles of the charge pump according to the embodiments herein are similar to those in the above embodiments, which are thus not described herein any further.

In the charge pump according to the embodiments of the present disclosure, in the energy storage branch in any stage, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

It should be noted that the charge pump according to the embodiments of the present disclosure may be the charge pump in FIG. 17, or a charge pump of another structure, which is not limited in the present disclosure. The driver circuit in the charge pump is described hereinafter using the structure of the charge pump as illustrated in FIG. 17.

In some embodiments, using the charge pump in FIG. 17 as an example, during normal operation of the charge pump, the current direction is from the left to the right, and in this case the current is a forward current. In case of abnormal operation of the charge pump, the current direction may be from the right to the left, and thus current limiting may be implemented for both of these two current directions. Current limiting for the charge pump using the driver circuit is described hereinafter.

In some embodiments, still referring to FIG. 17, the first-stage energy storage branch includes a third switching transistor M23 and a first capacitor C21. A first terminal of the third switching transistor M23 is configured to receive the input voltage VCC. A second terminal of the third switching transistor M23 is electrically connected to a top plate of the first capacitor C21. FIG. 17 exemplarily illustrates that the driver circuit is arranged in the first-stage energy storage branch.

The driver circuit includes a first driver circuit 3210. An output terminal of the first driver circuit 3210 is electrically connected to a control terminal of the third switching transistor M23, and a first power supply voltage of the first driver circuit 3210 comes from the top plate of the first capacitor C21. The first driver circuit 3210 includes a first Zener diode DZ1, a first voltage divider circuit 212, a first current source I, a first level conversion circuit 211, a first switching transistor M21, a second switching transistor M22.

A control terminal of the first switching transistor M21 is electrically connected to an output terminal of the first voltage divider circuit 212, a first terminal of the first switching transistor M21 is electrically connected to a second terminal of the second switching transistor M22, a control terminal of the second switching transistor M22 is electrically connected to a positive terminal of the first Zener diode DZ1, and a first terminal of the second switching transistor M22 is grounded.

A negative terminal of the first Zener diode DZ1 is configured to receive a first power supply voltage. The positive terminal of the first Zener diode DZ1 is grounded via the first current source I.

The first voltage divider circuit 212 and the first Zener diode DZ1 are connected in parallel. The first voltage divider circuit 212 is configured to divide a voltage across the two terminals of the first Zener diode DZ1, and output a first divided voltage at the output terminal of the first voltage divider circuit, such that a voltage at the second terminal of the first switching transistor is greater than a difference between the first power supply voltage and the first divided voltage.

Further, the first voltage divider circuit 212 includes a first resistor R1 and a second resistor R2 that are connected in series. A first terminal of the first resistor R1 is electrically connected to the negative terminal of the first Zener diode DZ1, a second terminal of the first resistor R1 is electrically connected to a first terminal of the second resistor R2, a second terminal of the second resistor R2 is electrically connected to the positive terminal of the first Zener diode DZ1, and a first terminal of the second resistor R2 is electrically connected to the control terminal of the first switching transistor M21.

An input terminal of the first level conversion circuit 211 is configured to receive a first-phase clock signal PH21, and an output terminal of the first level conversion circuit 211 is the output terminal of the driver circuit. The output terminal of the first level conversion circuit 211 is electrically connected to the control terminal of the third switching transistor M23.

A first power supply terminal of the first level conversion circuit 211 is configured to receive the first power supply voltage. A second power supply terminal of the first level conversion circuit 211 is electrically connected to a second terminal of the first switching transistor M21.

The level conversion circuit is configured to convert a level value of the first-phase clock signal PH21, and output a converted first-phase clock signal at the output terminal of the level conversion circuit. A level value of the converted first-phase clock signal is within a value range from the first power supply voltage to the voltage at the second terminal of the first switching transistor.

Further, the first level conversion circuit 211 includes a first level converter and series-connected inverters in a plurality of stages that are connected sequentially. An input terminal of the first level converter is configured to receive the first-phase clock signal. An output terminal of the inverter in a last stage in the series-connected inverters in the plurality of stages is the output terminal of the first driver circuit. Exemplarily, still referring to FIG. 17, inverters in two stages are exemplarily illustrated, including a first inverter and a second inverter. An input terminal of the first inverter is electrically connected to an output terminal of the first level converter, an output terminal of the first inverter is electrically connected to an input terminal of the second inverter, and the output terminal of the second inverter is the output terminal of the first driver circuit.

In some embodiments, the charge pump further includes a third resistor R3. The second terminal of the third switching transistor M23 is electrically connected to the top plate of the first capacitor C21 via the third resistor R3.

The implementation principles of the first driver circuit according to the embodiments herein are similar to those in the above embodiments, which are thus not described herein any further.

In the charge pump according to the embodiments of the present disclosure, in the first-stage energy storage branch, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the first-stage energy storage branch, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In some embodiments, still referring to FIG. 17, the charge pump further includes a third resistor R3, wherein the second terminal of the third switching transistor M23 is electrically connected to the top plate of the first capacitor C21 via the third resistor R3.

In practice, the first-stage energy storage branch in the charge pump achieves current limiting using the third resistor R3. In a case where the input voltage VCC is powered on, the peak current is VCC/R3, such that current limiting is implemented during power-up.

The charge pump according to the embodiments herein introduces a resistor in the first-stage energy storage branch to limit an inrush current during power-up. Additionally, during normal operation of the charge pump, the current is approximately equal to a converted control voltage divided by a resistance of the third resistor R3, which also serves to limit the current in the first-stage energy storage branch. This ensures proper operation of the charge pump, and improves reliability and safety of the charge pump.

In some embodiments, still referring to FIG. 17, the second-stage energy storage branch includes a fourth switching transistor M24 and a second capacitor C22. A top plate of the second capacitor C22 is electrically connected to the top plate of the first capacitor C21 via the fourth switching transistor M24.

The driver circuit according to the embodiments of the present disclosure includes a second driver circuit 3220, wherein an output terminal of the second driver circuit 3220 is electrically connected to a control terminal of the fourth switching transistor M24, and a second power supply voltage of the second driver circuit 3220 comes from the top plate of the second capacitor C22.

The second driver circuit 3220 includes a second Zener diode, a second voltage divider circuit, a second current source, a second level conversion circuit, a seventh switching transistor, and an eighth switching transistor.

A control terminal of the seventh switching transistor is electrically connected to an output terminal of the second voltage divider circuit, a first terminal of the seventh switching transistor is electrically connected to a second terminal of the eighth switching transistor, a control terminal of the eighth switching transistor is electrically connected to a positive terminal of the second Zener diode, and a first terminal of the eighth switching transistor is grounded.

A negative terminal of the second Zener diode is configured to receive a second power supply voltage VCC+VCC. The positive terminal of the second Zener diode is grounded via the second current source.

The second voltage divider circuit and the second Zener diode are connected in parallel. The second voltage divider circuit is configured to divide a voltage across the two terminals of the second Zener diode, and output a second divided voltage at the output terminal of the second voltage divider circuit, such that a voltage at a second terminal of the seventh switching transistor is greater than a difference between the second power supply voltage and the second divided voltage.

Further, the second voltage divider circuit includes a sixth resistor and a seventh resistor that are connected in series. A first terminal of the sixth resistor is electrically connected to the negative terminal of the second Zener diode, a second terminal of the sixth resistor is electrically connected to a first terminal of the seventh resistor, a second terminal of the seventh resistor is electrically connected to the positive terminal of the second Zener diode, and the first terminal of the seventh resistor is electrically connected to the control terminal of the seventh switching transistor.

An input terminal of the second level conversion circuit is configured to receive a second-phase clock signal PH22, and an output terminal of the second level conversion circuit is the output terminal of the second driver circuit 3220. The output terminal of the second level conversion circuit is electrically connected to the control terminal of the fourth switching transistor M24.

A first power supply terminal of the second level conversion circuit is configured to receive the second power supply voltage. A second power supply terminal of the second level conversion circuit is electrically connected to the second terminal of the seventh switching transistor.

The second level conversion circuit is configured to convert a level value of the second-phase clock signal PH22, and output a converted second first-phase clock signal at the output terminal of the second level conversion circuit. A level value of the converted second first-phase clock signal is within a value range from the second power supply voltage to the voltage at the second terminal of the seventh switching transistor.

Further, the second level conversion circuit includes a second level converter and series-connected inverters in a plurality of stages that are connected sequentially. An input terminal of the second level converter is configured to receive the first-phase clock signal. An output terminal of the inverter in a last stage in the series-connected inverters in the plurality of stages is the output terminal of the second driver circuit. Exemplarily, still referring to FIG. 17, inverters in two stages are exemplarily illustrated, including a third inverter and a fourth inverter. An input terminal of the third inverter is electrically connected to an output terminal of the second level converter, an output terminal of the third inverter is electrically connected to an input terminal of the fourth inverter, and the output terminal of the fourth inverter is the output terminal of the second driver circuit.

The implementation principles of the second driver circuit according to the embodiments herein are similar to those of the first driver circuit in the above embodiments, which are thus not described herein any further.

In the charge pump according to the embodiments of the present disclosure, in the second-stage energy storage branch, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the second-stage energy storage branch, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

Further, the charge pump further includes a fourth resistor R4, wherein a second terminal of the fourth switching transistor M24 is electrically connected to the top plate of the second capacitor C22 via the fourth resistor R4.

In practice, the second-stage energy storage branch in the charge pump achieves current limiting using the fourth resistor R4. In a case where the input voltage 2VCC is powered on, the peak current is 2VCC/R4, such that current limiting is implemented during power-up.

The charge pump according to the embodiments herein introduces a resistor in the second-stage energy storage branch to limit an inrush current during power-up. Additionally, during normal operation of the charge pump, the current is approximately equal to a converted control voltage divided by a resistance of the fourth resistor, which also serves to limit the current in the second-stage energy storage branch. This ensures proper operation of the charge pump, and improves reliability and safety of the charge pump.

In some embodiments, still referring to FIG. 17, the second-stage energy storage branch further includes a fifth switching transistor M25. A bottom plate of the second capacitor C22 is electrically connected to a bottom plate of the first capacitor C21 via the fifth switching transistor M25.

The driver circuit according to the embodiments of the present disclosure includes a third driver circuit 3230, wherein an output terminal of the third driver circuit 3230 is electrically connected to a control terminal of the fifth switching transistor M25, and a third power supply voltage of the third driver circuit 3230 comes from the input voltage.

The third driver circuit 3230 includes a third Zener diode, a third voltage divider circuit, a third current source, a third level conversion circuit, a ninth switching transistor, and a tenth switching transistor.

A control terminal of the ninth switching transistor is electrically connected to an output terminal of the third voltage divider circuit, a first terminal of the ninth switching transistor is electrically connected to a second terminal of the tenth switching transistor, a control terminal of the tenth switching transistor is electrically connected to a positive terminal of the third Zener diode, and a first terminal of the tenth switching transistor is grounded.

A negative terminal of the third Zener diode is configured to receive a third power supply voltage VCC. The positive terminal of the third Zener diode is grounded via the third current source.

The third voltage divider circuit and the third Zener diode are connected in parallel. The third voltage divider circuit is configured to divide a voltage across the two terminals of the third Zener diode, and output a third divided voltage at the output terminal of the third voltage divider circuit, such that a voltage at the second terminal of the ninth switching transistor is greater than a difference between the third power supply voltage and the third divided voltage.

Further, the third voltage divider circuit includes an eighth resistor and a ninth resistor that are connected in series. A first terminal of the eighth resistor is electrically connected to the negative terminal of the third Zener diode, a second terminal of the eighth resistor is electrically connected to a first terminal of the ninth resistor, a second terminal of the ninth resistor is electrically connected to the positive terminal of the third Zener diode, and the first terminal of the ninth resistor is electrically connected to the control terminal of the ninth switching transistor.

An input terminal of the third level conversion circuit is configured to receive the second-phase clock signal PH22, and an output terminal of the third level conversion circuit is the output terminal of the third driver circuit 3230. The output terminal of the third level conversion circuit is electrically connected to the control terminal of the fifth switching transistor M25.

A first power supply terminal of the third level conversion circuit is configured to receive the third power supply voltage. A second power supply terminal of the third level conversion circuit is electrically connected to the second terminal of the ninth switching transistor.

Further, the third level conversion circuit includes a third level converter and series-connected inverters in a plurality of stages that are connected sequentially. An input terminal of the third level converter is configured to receive the first-phase clock signal. An output terminal of the inverter in a last stage in the series-connected inverters in the plurality of stages is the output terminal of the third driver circuit. Exemplarily, still referring to FIG. 17, inverters in two stages are exemplarily illustrated, including a fifth inverter and a sixth inverter. An input terminal of the fifth inverter is electrically connected to an output terminal of the third level converter, an output terminal of the fifth inverter is electrically connected to an input terminal of the sixth inverter, and the output terminal of the sixth inverter is the output terminal of the third driver circuit.

The level conversion circuit is configured to convert a level value of the second-phase clock signal PH22, and output a converted third first-phase clock signal at the output terminal of the level conversion circuit, wherein a level value of the converted third first-phase clock signal is within a value range from the third power supply voltage to the voltage at the second terminal of the ninth switching transistor.

The implementation principles of the third driver circuit according to the embodiments herein are similar to those of the first driver circuit in the above embodiments, which are thus not described herein any further.

In the charge pump according to the embodiments of the present disclosure, in the second-stage energy storage branch, by arrangement of the Zener diodes, the voltage divider circuit, the switching transistors, and the level conversion circuit in the driver circuit, the divided voltage in the energy storage branch where the driver circuit is arranged is relatively low, and hence the current in the energy storage branch is controlled to achieve current limiting for the energy storage branch. The original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

Further, the charge pump further includes a fifth resistor R5, wherein a second terminal of the fifth switching transistor M25 is electrically connected to a bottom plate of the second capacitor C21 via the fifth resistor R5.

In practice, the second-stage energy storage branch in the charge pump achieves current limiting using the fifth resistor R5. In a case where the input voltage VCC is powered on, the peak current is VCC/R5, such that current limiting is implemented during power-up.

The charge pump according to the embodiments herein introduces a resistor in the second-stage energy storage branch to limit an inrush current during power-up. Additionally, during normal operation of the charge pump, the current is approximately equal to a converted control voltage divided by a resistance of the fifth resistor, which also serves to limit the current in the second-stage energy storage branch. This ensures proper operation of the charge pump, and improves reliability and safety of the charge pump.

It should be noted that, in the charge pump, the drive circuit may be configured at any of the possible design positions mentioned above, or may also be configured at the corresponding positions of the switch transistors in two or more energy storage branches. The number of drive circuits configured in the charge pump is not limited in the present disclosure. Exemplarily, in the charge pump in FIG. 17, drive circuits may be respectively configured on the branches of the third switch transistor M23, the fourth switch transistor M24, and the fifth switch transistor M25 to achieve current limiting for the charge pump.

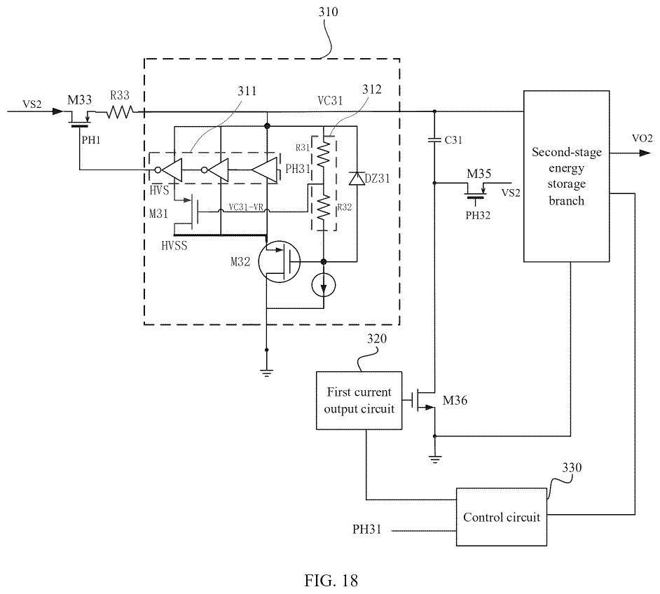

The structure of another charge pump according to some embodiments of the present disclosure is described hereinafter with reference to FIG. 18. It should be understood that the charge pump in FIG. 18 is merely an example and does not constitute limitations to the present disclosure. The driver circuit according to the embodiments of the present disclosure is applicable to the charge pump. The charge pump may include a first-stage energy storage branch, a second-stage energy storage branch, and a driver circuit. It should be noted that the type of the switching transistors in the charge pump according to the embodiments herein is not limited in the present disclosure. The switching transistors exemplarily illustrated in FIG. 18 are field-effect transistors.

FIG. 18 exemplarily illustrates energy storage branches in two stages. A first-stage energy storage branch includes a third switching transistor M33, a sixth switching transistor M36, a fifth switching transistor M35, a first capacitor C31, and a first current output circuit 320.

A control terminal of the third switching transistor M33, a control terminal of the first current output circuit 320, and a control terminal of the second-stage energy storage branch are all electrically connected to the control circuit 330, a first terminal of the third switching transistor M33 and a second terminal of the fifth switching transistor M35 are both electrically connected to an input voltage VS2 of the charge pump, a second terminal of the third switching transistor M33 is electrically connected to an input terminal of the second-stage energy storage branch, a first terminal of the first capacitor C31 is electrically connected between the second terminal of the third switching transistor M33 and the input terminal of the second-stage energy storage branch, a second terminal of the first capacitor C31 is electrically connected to a first terminal of the sixth switching transistor M36, a control terminal of the sixth switching transistor M36 is electrically connected to a first terminal of the first current output circuit 320, a first terminal of the fifth switching transistor M35 is electrically connected between the second terminal of the first capacitor C31 and the first terminal of the sixth switching transistor M36, a second terminal of the first current output circuit 320, a second terminal of the sixth switching transistor M36 and a first terminal of the second-stage energy storage branch are all grounded, and an output terminal of the second-stage energy storage branch is configured to output an output voltage VO2 of the charge pump.

The first-stage energy storage branch, the second-stage energy storage branch and the control circuit 330 may be arranged separately, or may be integrated.

A first-phase clock signal PH31 and a second-phase clock signal PH32 do not overlap and each have a duty cycle of 50%, forming a two-phase clock. The charge pump is controlled by the first-phase clock signal PH31 and the second-phase clock signal PH32, that is, the switching transistors in the first-stage energy storage branch and the second-stage energy storage branch are alternately turned on at a duty cycle of 50%.

In response to the first-phase clock signal PH31, the first-stage energy storage branch is in a charging phase, and the second-stage energy storage branch is in a discharging phase. In response to the second-phase clock signal PH32, the first-stage energy storage branch is in a discharge phase, and the second-stage energy storage branch is in a charging phase.

In a case where the input voltage VS2 of the charge pump is less than a first threshold voltage, that is, the input voltage VS2 of the charge pump is small, in response to the first-phase clock signal PH31, the control circuit 330 may control the first current output circuit 320 to be conducted, such that the sixth switching transistor M36 is turned on. In this way, under the effect of the first-phase clock signal PH31, the third switching transistor M33 is turned on, such that the input voltage VS2 of the charge pump may charge the first capacitor C31, and hence the first-stage energy storage branch is in the charging phase. Further, the first-stage energy storage branch is capable of charging the first capacitor C31 using the input voltage VS2 of the charge pump. Under the effect of the second-phase clock signal PH32, the control circuit 330 may control the second-stage energy storage branch to use an output voltage of the first-stage energy storage branch, that is, a voltage at the first terminal of the first capacitor C31 enters a charging state, such that the second-stage energy storage branch is in the charging phase.

Under the effect of the first-phase clock signal PH31, the sixth switching transistor M36 and the third switching transistor M33 are both in a turned-on state. Therefore, the input voltage VS2 of the charge pump may charge the first capacitor C31, such that a voltage stored on the first capacitor C31 may be up to the input voltage VS2 of the charge pump. Meanwhile, the second-stage energy storage branch is in the discharging phase, and the second-stage energy storage branch may boost the output voltage of the first-stage energy storage branch to obtain the output voltage VO2 of the charge pump. The output voltage of the first-stage energy storage branch is twice the input voltage VS2 of the charge pump. Therefore, the output voltage VO2 of the charge pump is three times the input voltage VS2 of the charge pump.

Under the effect of the second-phase clock signal PH32, the first-stage energy storage branch is in the discharging phase, and the fifth switching transistor M35 is turned on, such that the first-stage energy storage branch boosts the input voltage VS2 of the charge pump to obtain the output voltage of the first-stage energy storage branch, that is, the voltage at the first terminal of the first capacitor C31. The voltage stored on the first capacitor C31 may be up to the input voltage VS2 of the charge pump, and the second terminal of the fifth switching transistor M35 is electrically connected to the input voltage VS2 of the charge pump. Therefore, the voltage at the first terminal of the first capacitor C31 may be up to twice the input voltage VS2 of the charge pump. Meanwhile, the second-stage energy storage branch is in the charging phase, and the second-stage energy storage branch may be charged using the output voltage of the first-stage energy storage branch, that is, the voltage at the first terminal of the first capacitor C31.

As illustrated in FIG. 18, the driver circuit includes a fourth driver circuit 310. Some embodiments exemplarily illustrate that the fourth driver circuit 310 is arranged on the first-stage energy storage branch. The fourth driver circuit 310 includes: a Zener diode DZ31, a voltage divider circuit 312, a current source, a level conversion circuit 311, a first switching transistor M31, a second switching transistor M32, and a control circuit 313.

An input terminal of the first level conversion circuit 311 is configured to receive a first-phase clock signal PH31, and an output terminal of the level conversion circuit 311 is an output terminal of the fourth driver circuit 310. A first power supply terminal of the level conversion circuit 311 is configured to receive a power supply voltage, and a second power supply terminal of the level conversion circuit 311 is electrically connected to a second terminal of the first switching transistor M31. A control terminal of the first switching transistor M31 is electrically connected to an output terminal of voltage divider circuit 312, a first terminal of the first switching transistor M31 is electrically connected to a second terminal of the second switching transistor M32, a control terminal of the second switching transistor M32 is electrically connected to a positive terminal of the Zener diode DZ31, and a first terminal of the second switching transistor M32 is grounded. A negative terminal of the Zener diode DZ31 is configured to receive the power supply voltage, and a positive terminal of the Zener diode DZ31 is grounded via the current source; and the voltage divider circuit 312 and the Zener diode DZ31 are connected in parallel.

The voltage divider circuit 312 is configured to divide a voltage across the two terminals of the Zener diode DZ31, and output a divided voltage at the output terminal of the voltage divider circuit, such that a voltage at the second terminal of the first switching transistor M31 is greater than a difference between the power supply voltage and the divided voltage.

The level conversion circuit 311 is configured to convert a level value of the first-phase clock signal PH31, and output a converted first-phase clock signal at the output terminal of the level conversion circuit 311, wherein a level value of the converted first-phase clock signal is within a value range from the power supply voltage to the voltage at the second terminal of the first switching transistor M31.

The implementation principles of the fourth driver circuit 310 according to the embodiments herein are similar to those of the first driver circuit in the above embodiments, which are thus not described herein any further.

In the charge pump according to the embodiments herein, in a case where the input voltage of the charge pump is less than the first threshold voltage, the control circuit may control, based on the first-phase clock signal, the first current output circuit to turn on the sixth switching transistor, such that the first-stage energy storage branch charges the first capacitor using the input voltage of the charge pump, and hence the first-stage energy storage branch is capable of boosting the input voltage of the charge pump. In addition, the control circuit may control, based on the second-phase clock signal, the second-stage energy storage branch to enter a charging state using the output voltage of the first-stage energy storage branch, such that the second-stage energy storage branch is capable of boosting the output voltage of the first-stage energy storage branch. In this case, under the effect of the first-phase clock signal, the first-stage energy storage branch may charge the first capacitor using the input voltage of the charge pump, and the second-stage energy storage branch may boost the output voltage of the first-stage energy storage branch, such that the output voltage of the charge pump is obtained. Under the effect of the second-phase clock signal, the first-stage energy storage branch may boost the input voltage of the charge pump, such that the output voltage of the first-stage energy storage branch is obtained. The second-stage energy storage branch may be charged using the output voltage of the first-stage energy storage branch. The output voltage of the first-stage energy storage branch is twice the input voltage of the charge pump. Therefore, the output voltage of the charge pump obtained by the second-stage energy storage branch is three times the input voltage of the charge pump. In this way, the charge pump is capable of raising the output voltage thereof to three times the input voltage of the charge pump, such that the high-side switch driver circuit satisfies the drive requirement of the high-side switch under the effect of the output voltage of the charge pump. In the energy storage branch in any stage, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the energy storage branch in this stage, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In some examples, in a case where the input voltage VS2 of the charge pump is greater than the first threshold voltage, that is, the input voltage VS2 of the charge pump is large, no matter under the effect of the first-phase clock signal PH31 or under the effect of the second-phase clock signal PH32, the control circuit 330 may control the third switching transistor M33 to be turned on, and control the first current output circuit 320 to always remain on, such that the first-stage energy storage branch does not operate. In this way, power consumption of the first-stage energy storage branch is reduced. In addition, the control circuit 330 may control, based on the second-phase clock signal PH32, the second-stage energy storage branch to be charged using the input voltage VS2 of the charge pump. In this way, in a case where the input voltage VS2 of the charge pump is greater than the first threshold voltage, power consumption of the charge pump is reduced.

Under the effect of the first-phase clock signal PH31, the second-stage energy storage branch is in the discharging phase, and the second-stage energy storage branch may boost the input voltage VS2 of the charge pump to obtain the output voltage VO2 of the charge pump. Therefore, the output voltage VO2 of the charge pump is twice the input voltage VS2 of the charge pump.

Under the effect of the second-phase clock signal PH32, the fifth switching transistor M35 is turned on, and the second-stage energy storage branch is in the charging phase, such that the second-stage energy storage branch may be charged using the input voltage VS2 of the charge pump, that is, the voltage at the first terminal of the first capacitor C31. The voltage stored on the first capacitor C31 is 0, and the second terminal of the fifth switching transistor M35 is electrically connected to the input voltage VS2 of the charge pump. Therefore, the voltage at the first terminal of the first capacitor C31 may be up to the input voltage VS2 of the charge pump.

In summary, in a case where the input voltage of the charge pump is greater than the first threshold voltage, the control circuit may control the fifth switching transistor to always remain on, and control the first current output circuit to always remain off, such that the first-stage energy storage branch does not operate, and hence power consumption of the first-stage energy storage branch is reduced. In addition, the control circuit may control, based on the second-phase clock signal, the second-stage energy storage branch to be charged using the input voltage of the charge pump, such that the second-stage energy storage branch is in the charging phase. In this way, power consumption of the charge pump is reduced.

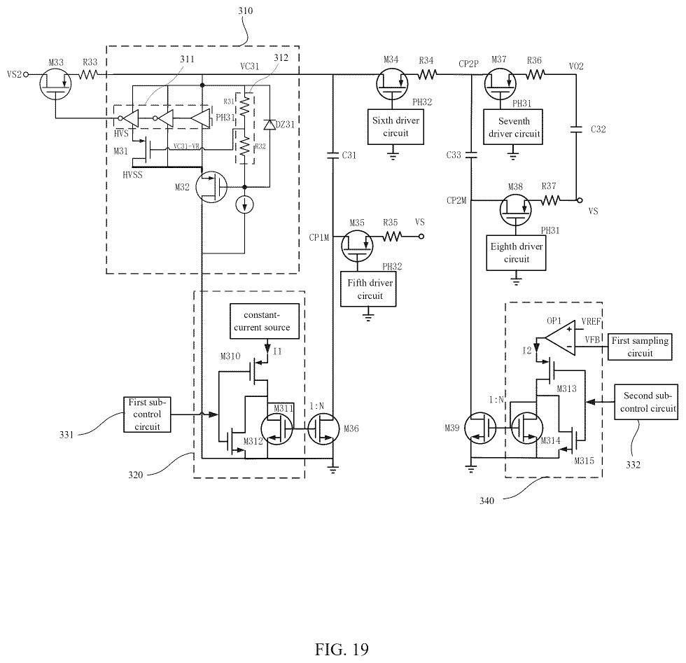

Based on the description of the above embodiments, exemplarily, one possible implementation of the second-stage energy storage branch is described hereinafter. FIG. 19 is a schematic structural diagram of a charge pump according to some embodiments of the present disclosure, and FIG. 19 further illustrates the structure of the charge pump shown in FIG. 18, based on the charge pump in FIG. 18. As illustrated in FIG. 19, the second-stage energy storage branch may include a fourth switching transistor M34, a seventh switching transistor M37, a ninth switching transistor M39, an eighth switching transistor M38, a second capacitor C32, a third capacitor C33, and a second current output circuit 340.

A control terminal of the second current output circuit 340 is electrically connected to the control circuit 330, a first terminal of the fourth switching transistor M34 is electrically connected to the second terminal of the third switching transistor M33, a second terminal of the fourth switching transistor M34 is electrically connected to a first terminal of the seventh switching transistor M37, a second terminal of the seventh switching transistor M37 is electrically connected to a first terminal of the second capacitor C32, a first terminal of the third capacitor C33 is electrically connected between the second terminal of the fourth switching transistor M34 and the first terminal of the seventh switching transistor M37, a second terminal of the third capacitor C33 is electrically connected to a first terminal of the ninth switching transistor M39, a control terminal of the ninth switching transistor M39 is electrically connected to a first terminal of the second current output circuit 340, a first terminal of the eighth switching transistor M38 is electrically connected between the second terminal of the third capacitor C33 and the first terminal of the ninth switching transistor M39, a second terminal of the eighth switching transistor M38 is electrically connected to a second terminal of the second capacitor C32, and a second terminal of the second current output circuit 340 and a second terminal of the ninth switching transistor M39 are both grounded.

The control circuit 330 may control, based on the second-phase clock signal PH32, the second current output circuit 340 to be conducted, such that the ninth switching transistor M39 is turned on. In this way, under the effect of the second-phase clock signal PH32, the fourth switching transistor M34 is turned on, such that the third capacitor C33 is charged, and hence the second-stage energy storage branch enters the charging phase.

Under the effect of the first-phase clock signal PH31, the seventh switching transistor M37 and the eighth switching transistor M38 are both turned on, such that the third capacitor C33 may discharge to the second capacitor C32, and hence the second-stage energy storage branch enters the discharging phase.

In summary, the control circuit may control, based on the second-phase clock signal, the second current output circuit to be conducted, such that the ninth switching transistor is turned on. Thus, under the effect of the second-phase clock signal, the fourth switching transistor is turned on, such that the second-stage energy storage branch may enters the charging phase. Under the effect of the first-phase clock signal, since the seventh switching transistor and the eighth switching transistor are both turned on, the second-stage energy storage branch enters the discharging phase.

Based on the description of the above embodiments, exemplarily, one possible implementation of the control circuit 330 is described hereinafter. As illustrated in FIG. 19, the control circuit 330 may include a first sub-control circuit 331, a second sub-control circuit 332, and a third sub-control circuit.

An output terminal of the first sub-control circuit 331 is electrically connected to the control terminal of the first current output circuit 320, an output terminal of the second sub-control circuit 332 is electrically connected to the control terminal of the second current output circuit 340, and an output terminal of the third sub-control circuit is electrically connected to the control terminal of the third switching transistor M33 and the control terminal of the first current output circuit 320.

In a case where the input voltage VS2 of the charge pump is less than the first threshold voltage, the first sub-control circuit 331 may control, based on the first-phase clock signal PH31, the first current output circuit 320 to be conducted, such that the first-stage energy storage branch enters the charging phase.

In a case where the input voltage VS2 of the charge pump is less than the first threshold voltage, or in a case where the input voltage VS2 of the charge pump is greater than the first threshold voltage, the second sub-control circuit 332 may control, based on the second-phase clock signal PH32, the second current output circuit 340 to be conducted, such that the second-stage energy storage branch enters the charging phase.

In a case where the input voltage VS2 of the charge pump is greater than the first threshold voltage, the third sub-control circuit may control the third switching transistor M33 to always remain on, and control the first current output circuit 320 to always remain off, such that the first-stage energy storage branch does not operate.

In summary, in a case where the input voltage of the charge pump is less than the first threshold voltage, the first sub-control circuit may control, based on the first-phase clock signal, the first current output circuit to be conducted, such that the first-stage energy storage branch enters the charging phase. The second sub-control circuit may control, based on the second-phase clock signal, the second current output circuit to be conducted, such that the second-stage energy storage branch enters the charging phase. In a case where the input voltage of the charge pump is greater than the first threshold voltage, the third sub-control circuit may control the fifth switching transistor to always remain on, and control the first current output circuit to always remain off, such that the first-stage energy storage branch does not operate.

Based on the description of the above embodiment, exemplarily, one possible implementation of the first current output circuit 320 is described hereinafter. As illustrated in FIG. 19, the first current output circuit 320 may include a constant-current source, a first transistor M310, a second transistor M311, and a third transistor M312.

An output terminal of the constant-current source is electrically connected to a second terminal of the first transistor M310, a first terminal of the first transistor M310 is electrically connected to a first terminal of the second transistor M311, a control terminal of the second transistor M311 is electrically connected to the control terminal of the sixth switching transistor M36, a first terminal of the third transistor M312 is electrically connected between the first terminal of the first transistor M310 and the first terminal of the second transistor M311, a control terminal of the first transistor M310 and a control terminal of the third transistor M312 are both electrically connected to the output terminal of the first sub-control circuit 331, and a second terminal of the second transistor M311 and a second terminal of the third transistor M312 are both grounded.

The constant-current source may output a first charge current I1. Thus, in a case where the first sub-control circuit 331 controls the first current output circuit 320 to be conducted, the first transistor M310, the second transistor M311, and the third transistor M312 are all turned on, such that the sixth switching transistor M36 is turned on. Thus, the sixth switching transistor M36 may mirror a current of the second transistor M311, such that a charge current of the sixth switching transistor M36 is N times the first charge current I1. N is a positive integer. In this way, the first capacitor C331 may be charged.

The charge current of the sixth switching transistor M36 determines the voltage stored on the first capacitor C331.

A current value of the first charge current I1 is greater than a maximum current value of a second charge current I2 output by the second current output circuit 340, such that the charge current of the sixth switching transistor M36 is greater than a charge current of the ninth switching transistor M39. Thus, a charging power amount of the first capacitor C331 is prevented from being less than a discharging power amount of the first capacitor C331 to the third capacitor C33, such that the voltage stored on the first capacitor C331 may not decrease to 0. In this way, the risk that the output voltage VO2 is over-low is prevented.

In summary, the constant-current source may output the first charge current. Thus, the first transistor, the second transistor, and the third transistor may turn on the sixth switching transistor, such that the sixth switching transistor is capable of mirroring a current of the second transistor. In this way, the first capacitor may be charged.

Based on the description of the above embodiment, exemplarily, one possible implementation of the second current output circuit 340 is described hereinafter. As illustrated in FIG. 19, the second current output circuit 340 may include a first sampling circuit, an operational amplifier, a fourth transistor M313, a fifth transistor M314, and a sixth transistor M315.

An input terminal of the first sampling circuit is electrically connected to the first terminal of the third capacitor C32, an output terminal of the first sampling circuit is electrically connected to a first input terminal of the operational amplifier, a second input terminal of the operational amplifier is electrically connected to a reference voltage VREF, an output terminal of the operational amplifier is electrically connected to a second terminal of the fourth transistor M313, a first terminal of the fourth transistor M313 is electrically connected to a first terminal of the fifth transistor M314, a control terminal of the fifth transistor M314 is electrically connected to the control terminal of the ninth switching transistor M39, a first terminal of the sixth transistor M315 is electrically connected between the first terminal of the fourth transistor M313 and the first terminal of the fifth transistor M314, a control terminal of the fourth transistor M313 and a control terminal of the sixth transistor M315 are both electrically connected to the output terminal of the second sub-control circuit 332, and a second terminal of the fifth transistor M314 and a second terminal of the sixth transistor M315 are both grounded.

The first sampling circuit may sample a voltage stored on the second capacitor C32. In addition, the first sampling circuit may transmit the voltage stored on the second capacitor C32 to the operational amplifier. Thus, the operational amplifier may regulate a magnitude of the second charge current I2 based on the voltage stored on the second capacitor C32 and the reference voltage VREF, such that control of the second current output circuit 340 is implemented.

In a case where the voltage stored on the second capacitor C32 is greater than a target voltage to be stored on the second capacitor C32, the operational amplifier decreases the second charge current I2. Thus, the second sub-control circuit 332 controls the second current output circuit 340 to be conducted, the fourth transistor M313, the fifth transistor M314, and the sixth transistor M315 are all turned on, such that the ninth switching transistor M39 is turned on. In this case, the ninth switching transistor M39 may mirror a current of the fifth transistor M314, such that a charge current of the ninth switching transistor M39 is N times the second charge current I2, and hence the third capacitor C33 may be charged. N is a positive integer. Under the effect of reduction of the second charge current I2, the voltage stored on the third capacitor C33 also decreases. In this way, the voltage stored on the second capacitor C32 decreases. In a case where the voltage stored on the second capacitor C32 is less than the target voltage to be stored on the second capacitor C32, the operational amplifier increases the second charge current I2. Under the effect of increase of the second charge current I2, the voltage stored on the third capacitor C33 also increases. In this way, the voltage stored on the second capacitor C32 increases.

The charge current of the ninth switching transistor M39 determines the voltage stored on the third capacitor C33.

In summary, the first sampling circuit may sample the voltage stored on the second capacitor, and transmit the voltage stored on the second capacitor to the operational amplifier, such that the operational amplifier acquires the voltage stored on the second capacitor. In this way, the operational amplifier may regulate the magnitude of the second charge current based on the voltage stored on the second capacitor and the reference voltage, such that control of the second current output circuit is implemented.

Based on the description of the above embodiment, exemplarily, one possible implementation of the second current output circuit 340 is described hereinafter. As illustrated in FIG. 19, the second current output circuit 340 may include a first sampling circuit, a first operational amplifier OP1, a fourth transistor M313, a fifth transistor M314, and a sixth transistor M315.

An input terminal of the first sampling circuit is electrically connected to the first terminal of the third capacitor C32, an output terminal of the first sampling circuit is electrically connected to a first input terminal of the first operational amplifier OP1, a second input terminal of the first operational amplifier OP1 is electrically connected to a first reference voltage VREF1, an output terminal of the first operational amplifier OP1 is electrically connected to a second terminal of the fourth transistor M313, a first terminal of the fourth transistor M313 is electrically connected to a first terminal of the fifth transistor M314, a control terminal of the fifth transistor M314 is electrically connected to the control terminal of the ninth switching transistor M39, a first terminal of the sixth transistor M315 is electrically connected between the first terminal of the fourth transistor M313 and the first terminal of the fifth transistor M314, a control terminal of the fourth transistor M313 and a control terminal of the sixth transistor M315 are both electrically connected to the output terminal of the second sub-control circuit 332, and a second terminal of the fifth transistor M314 and a second terminal of the sixth transistor M315 are both grounded.

The first sampling circuit may sample a voltage stored on the second capacitor C32. In addition, the first sampling circuit may transmit the voltage stored on the second capacitor C32 to the first operational amplifier OP1. Thus, the first operational amplifier OP1 may regulate the magnitude of the second charge current I2 based on the voltage stored on the second capacitor C32 and the first reference voltage VREF1, such that the voltage stored on the second capacitor C32 remains stable.

In summary, the first sampling circuit may sample the voltage stored on the second capacitor, and transmit the voltage stored on the second capacitor to the second operational amplifier, such that the second operational amplifier acquires the voltage stored on the second capacitor. In this way, the second operational amplifier may regulate the magnitude of the second charge current based on the voltage stored on the second capacitor and the first reference voltage, such that the voltage stored on the second capacitor remains stable.

Based on the description of the above embodiment, exemplarily, one possible implementation of the second current output circuit 340 is described hereinafter. As illustrated in FIG. 19, the second current output circuit 340 may include a first sampling circuit, a first operational amplifier OP1, a fourth transistor M313, a fifth transistor M314, and a sixth transistor M315.

An input terminal of the first sampling circuit is electrically connected to the first terminal of the third capacitor C33, an output terminal of the first sampling circuit is electrically connected to a first input terminal of the first operational amplifier OP1, a second input terminal of the first operational amplifier OP1 is electrically connected to a first reference voltage VREF1, an output terminal of the first operational amplifier OP1 is electrically connected to a second terminal of the fourth transistor M313, a first terminal of the fourth transistor M313 is electrically connected to a first terminal of the fifth transistor M314, a control terminal of the fifth transistor M314 is electrically connected to the control terminal of the ninth switching transistor M39, a first terminal of the sixth transistor M315 is electrically connected between the first terminal of the fourth transistor M313 and the first terminal of the fifth transistor M314, a control terminal of the fourth transistor M313 and a control terminal of the sixth transistor M315 are both electrically connected to the output terminal of the second sub-control circuit 332, and a second terminal of the fifth transistor M314 and a second terminal of the sixth transistor M315 are both grounded.

The first sampling circuit may sample the voltage stored on the third capacitor C33. In addition, the first sampling circuit may transmit the voltage stored on the third capacitor C33 to the first operational amplifier OP1. Thus, the first operational amplifier OP1 may regulate the magnitude of the second charge current I2 based on the voltage stored on the third capacitor C33 and the first reference voltage VREF, such that the voltage stored on the second capacitor C32 remains stable.

In addition, the first sampling circuit has good transient characteristics, and hence the first sampling circuit may change with a change of the voltage stored on the third capacitor C33 and may obtain the voltage stored on the third capacitor C33.

In summary, the first sampling circuit may sample the voltage stored on the third capacitor, and transmit the voltage stored on the third capacitor to the second operational amplifier. In this way, the second operational amplifier may regulate the magnitude of the second charge current based on the voltage stored on the third capacitor and the first reference voltage, such that the voltage stored on the second capacitor remains stable.

In addition, the third switching transistor M33, the fifth switching transistor M35, the fourth switching transistor M34, the seventh switching transistor M37, and the eighth switching transistor M38 in FIG. 19 are all P-type switching transistors.

In some embodiments, the charge pump further includes a third resistor R3. The second terminal of the third switching transistor M23 is electrically connected to the top plate of the first capacitor C21 via the third resistor R3.

The implementation principles of the first driver circuit according to the embodiments herein are similar to those in the above embodiments, which are thus not described herein any further.

In the charge pump according to the embodiments of the present disclosure, in the first-stage energy storage branch, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the first-stage energy storage branch, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

In some embodiments, still referring to FIG. 17, the charge pump further includes a third resistor R3, wherein the second terminal of the third switching transistor M23 is electrically connected to the top plate of the first capacitor C21 via the third resistor R3.

In practice, the first-stage energy storage branch in the charge pump achieves current limiting using the third resistor R3. In a case where the input voltage VCC is powered on, the peak current is VCC/R3, such that current limiting is implemented during power-up.

The charge pump according to the embodiments herein introduces a resistor in the first-stage energy storage branch to limit an inrush current during power-up. Additionally, during normal operation of the charge pump, the current is approximately equal to a converted control voltage divided by a resistance of the third resistor R3, which also serves to limit the current in the first-stage energy storage branch. This ensures proper operation of the charge pump, and improves reliability and safety of the charge pump.

In some embodiments, still referring to FIG. 17, the second-stage energy storage branch includes a fourth switching transistor M24 and a second capacitor C22. A top plate of the second capacitor C22 is electrically connected to the top plate of the first capacitor C21 via the fourth switching transistor M24.

The driver circuit according to the embodiments of the present disclosure includes a second driver circuit 3220, wherein an output terminal of the second driver circuit 3220 is electrically connected to a control terminal of the fourth switching transistor M24, and a second power supply voltage of the second driver circuit 3220 comes from a top plate of the second capacitor C22.

The second driver circuit 3220 includes a second Zener diode, a second voltage divider circuit, a second current source, a second level conversion circuit, a seventh switching transistor, and an eighth switching transistor.

A control terminal of the seventh switching transistor is electrically connected to an output terminal of the second voltage divider circuit, a first terminal of the seventh switching transistor is electrically connected to a second terminal of the eighth switching transistor, a control terminal of the eighth switching transistor is electrically connected to a positive terminal of the second Zener diode, and a first terminal of the eighth switching transistor is grounded.

A negative terminal of the second Zener diode is configured to receive a second power supply voltage VCC+VCC. The positive terminal of the second Zener diode is grounded via the second current source.

The second voltage divider circuit and the second Zener diode are connected in parallel. The second voltage divider circuit is configured to divide a voltage across the two terminals of the second Zener diode, and output a second divided voltage at the output terminal of the second voltage divider circuit, such that a voltage at the second terminal of the seventh switching transistor is greater than a difference between the second power supply voltage and the second divided voltage.

Further, the second voltage divider circuit includes a sixth resistor and a seventh resistor that are connected in series. A first terminal of the sixth resistor is electrically connected to the negative terminal of the second Zener diode, a second terminal of the sixth resistor is electrically connected to a first terminal of the seventh resistor, a second terminal of the seventh resistor is electrically connected to the positive terminal of the second Zener diode, and the first terminal of the seventh resistor is electrically connected to the control terminal of the seventh switching transistor.

An input terminal of the second level conversion circuit is configured to receive a second-phase clock signal PH22, and an output terminal of the second level conversion circuit is the output terminal of the second driver circuit 3220. The output terminal of the second level conversion circuit is electrically connected to the control terminal of the fourth switching transistor M24.

A first power supply terminal of the second level conversion circuit is configured to receive the second power supply voltage. A second power supply terminal of the second level conversion circuit is electrically connected to the second terminal of the seventh switching transistor.

The second level conversion circuit is configured to convert a level value of the second-phase clock signal PH22, and output a converted second-phase clock signal at the output terminal of the second level conversion circuit. A level value of the converted second-phase clock signal is within a value range from the second power supply voltage to the voltage at the second terminal of the seventh switching transistor.

Further, the second level conversion circuit includes a second level converter and series-connected inverters in a plurality of stages that are connected sequentially. An input terminal of the second level converter is configured to receive the first-phase clock signal. An output terminal of the inverter in a last stage in the series-connected inverters in the plurality of stages is the output terminal of the second driver circuit. Exemplarily, still referring to FIG. 17, inverters in two stages are exemplarily illustrated, including a third inverter and a fourth inverter. An input terminal of the third inverter is electrically connected to an output terminal of the second level converter, an output terminal of the third inverter is electrically connected to an input terminal of the fourth inverter, and the output terminal of the fourth inverter is the output terminal of the second driver circuit.

The implementation principles of the second driver circuit according to the embodiments herein are similar to those of the first driver circuit in the above embodiments, which are thus not described herein any further.

In the charge pump according to the embodiments of the present disclosure, in the second-stage energy storage branch, by arrangement of the Zener diodes, the voltage divider circuit, the switching transistors, and the level conversion circuit in the driver circuit, the voltage divider circuit causes the voltage at the second terminal of the first switching transistor to be greater than the difference between the power supply voltage and the divided voltage, the level conversion circuit converts the level value of the first-phase clock signal and outputs the converted first-phase clock signal at the output terminal of the level conversion circuit, and the level value of the converted first-phase clock signal is within the value range from the power supply voltage to the voltage at the second terminal of the first switching transistor, such that a voltage at the output terminal of the level conversion circuit is relatively high, the divided voltage of the voltage of the first-phase clock signal in the energy storage branch where the driver circuit is arranged is relatively low, and hence the current in the energy storage branch decreases. By implementing current limiting for the second-stage energy storage branch, the original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

Further, the charge pump further includes a fourth resistor R4, wherein a second terminal of the fourth switching transistor M24 is electrically connected to the top plate of the second capacitor C22 via the fourth resistor R4.

In practice, the second-stage energy storage branch in the charge pump achieves current limiting using the fourth resistor R4. In a case where the input voltage 2VCC is powered on, the peak current is 2VCC/R4, such that current limiting is implemented during power-up.

The charge pump according to the embodiments herein introduces a resistor in the second-stage energy storage branch to limit an inrush current during power-up. Additionally, during normal operation of the charge pump, the current is approximately equal to a converted control voltage divided by a resistance of the fourth resistor, which also serves to limit the current in the second-stage energy storage branch. This ensures proper operation of the charge pump, and improves reliability and safety of the charge pump.

In some embodiments, still referring to FIG. 17, the second-stage energy storage branch further includes a fifth switching transistor M25. A bottom plate of the second capacitor C22 is electrically connected to a bottom plate of the first capacitor C21 via the fifth switching transistor M25.

The driver circuit according to the embodiments of the present disclosure includes a third driver circuit 3230, wherein an output terminal of the third driver circuit 3230 is electrically connected to a control terminal of the fifth switching transistor M25, and a third power supply voltage of the third driver circuit 3230 comes from the input voltage.

The third driver circuit 3230 includes a third Zener diode, a third voltage divider circuit, a third current source, a third level conversion circuit, a ninth switching transistor, and a tenth switching transistor.

A control terminal of the ninth switching transistor is electrically connected to an output terminal of the third voltage divider circuit, a first terminal of the ninth switching transistor is electrically connected to a second terminal of the tenth switching transistor, a control terminal of the tenth switching transistor is electrically connected to a positive terminal of the third Zener diode, and a first terminal of the tenth switching transistor is grounded.

A negative terminal of the third Zener diode is configured to receive a third power supply voltage VCC. The positive terminal of the third Zener diode is grounded via the third current source.

The third voltage divider circuit and the third Zener diode are connected in parallel. The third voltage divider circuit is configured to divide a voltage across the two terminals of the third Zener diode, and output a third divided voltage at the output terminal of the third voltage divider circuit, such that a voltage at the second terminal of the ninth switching transistor is greater than a difference between the third power supply voltage and the third divided voltage.

Further, the third voltage divider circuit includes an eighth resistor and a ninth resistor that are connected in series. A first terminal of the eighth resistor is electrically connected to the negative terminal of the third Zener diode, a second terminal of the eighth resistor is electrically connected to a first terminal of the ninth resistor, a second terminal of the ninth resistor is electrically connected to the positive terminal of the third Zener diode, and the first terminal of the ninth resistor is electrically connected to the control terminal of the ninth switching transistor.

An input terminal of the third level conversion circuit is configured to receive the second-phase clock signal PH22, and an output terminal of the third level conversion circuit is the output terminal of the third driver circuit 3230. The output terminal of the third level conversion circuit is electrically connected to the control terminal of the fifth switching transistor M25.

A first power supply terminal of the third level conversion circuit is configured to receive the third power supply voltage. A second power supply terminal of the third level conversion circuit is electrically connected to the second terminal of the ninth switching transistor.

Further, the third level conversion circuit includes a third level converter and series-connected inverters in a plurality of stages that are connected sequentially. An input terminal of the third level converter is configured to receive the first-phase clock signal. An output terminal of the inverter in a last stage in the series-connected inverters in the plurality of stages is the output terminal of the third driver circuit. Exemplarily, still referring to FIG. 17, inverters in two stages are exemplarily illustrated, including a fifth inverter and a sixth inverter. An input terminal of the fifth inverter is electrically connected to an output terminal of the third level converter, an output terminal of the fifth inverter is electrically connected to an input terminal of the sixth inverter, and the output terminal of the sixth inverter is the output terminal of the third driver circuit.

The level conversion circuit is configured to convert a level value of the second-phase clock signal PH22, and output a converted third first-phase clock signal at the output terminal of the level conversion circuit, wherein a level value of the converted third first-phase clock signal is within a value range from the third power supply voltage to the voltage at the second terminal of the ninth switching transistor.

The implementation principles of the third driver circuit according to the embodiments herein are similar to those of the first driver circuit in the above embodiments, which are thus not described herein any further.

In the charge pump according to the embodiments of the present disclosure, in the second-stage energy storage branch, by arrangement of the Zener diodes, the voltage divider circuit, the switching transistors, and the level conversion circuit in the driver circuit, the divided voltage in the energy storage branch where the driver circuit is arranged is relatively low, and hence the current in the energy storage branch is controlled to achieve current limiting for the energy storage branch. The original driver circuit of the charge pump is slightly modified to achieve current limiting protection for the charge pump. This ensures that the current within the charge pump remains below the current limit threshold, such that normal operation of the charge pump is ensured while the cost and circuit area are reduced. In this way, the reliability and safety of the charge pump are improved.

Further, the charge pump further includes a fifth resistor R5, wherein a second terminal of the fifth switching transistor M25 is electrically connected to a bottom plate of the second capacitor C21 via the fifth resistor R5.

In practice, the second-stage energy storage branch in the charge pump achieves current limiting using the fifth resistor R5. In a case where the input voltage VCC is powered on, the peak current is VCC/R5, such that current limiting is implemented during power-up.

The charge pump according to the embodiments herein introduces a resistor in the second-stage energy storage branch to limit an inrush current during power-up. Additionally, during normal operation of the charge pump, the current is approximately equal to a converted control voltage divided by a resistance of the fifth resistor, which also serves to limit the current in the second-stage energy storage branch. This ensures proper operation of the charge pump, and improves reliability and safety of the charge pump.

It should be noted that, in the charge pump, the drive circuit may be configured at any of the possible design positions mentioned above, or may also be configured at the corresponding positions of the switch transistors in two or more energy storage branches. The number of drive circuits configured in the charge pump is not limited in the present disclosure. Exemplarily, in the charge pump in FIG. 17, drive circuits may be respectively configured on the branches of the third switch transistor M23, the fourth switch transistor M24, and the fifth switch transistor M25 to achieve current limiting for the charge pump.

In some embodiments, the driver circuit may further include at least one of a fifth driver circuit, a sixth driver circuit, a seventh driver circuit, or an eighth driver circuit as illustrated in FIG. 19. The structure, implementation principles, and beneficial effects of the driver circuit are similar to those of the first driver circuit as described above, which are thus not described herein any further.

Some embodiments of the present disclosure provide a chip. The chip includes the driver circuit according to any of the above embodiments.

The implementation principles and technical effects of the chip according to the embodiments herein are similar to those in the above embodiments, which are thus not described herein any further.

Some embodiments of the present disclosure provide a chip. The chip includes the charge pump according to any of the above embodiments.

The implementation principles and technical effects of the chip according to the embodiments herein are similar to those in the above embodiments, which are thus not described herein any further.

Some embodiments of the present disclosure provide an electronic device. The electronic device includes the driver circuit according to any of the above embodiments.

The implementation principles and technical effects of the electronic device according to the embodiments herein are similar to those in the above embodiments, which are thus not described herein any further.

Some embodiments of the present disclosure provide an electronic device. The electronic device includes the charge pump according to any of the above embodiments.

The implementation principles and technical effects of the electronic device according to the embodiments herein are similar to those in the above embodiments, which are thus not described herein any further.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A multi-stage charge pump, comprising: a first charge pump circuit, a second charge pump circuit, and a control circuit; wherein
the first charge pump circuit comprises a first switching transistor, a second switching transistor, a third switching transistor, a first capacitor, and a first current output circuit; wherein a control terminal of the first switching transistor, a control terminal of the first current output circuit, and a control terminal of the second charge pump circuit are all electrically connected to the control circuit, a first terminal of the first switching transistor and a second terminal of the third switching transistor are both electrically connected to an input voltage of the multi-stage charge pump, a second terminal of the first switching transistor is electrically connected to an input terminal of the second charge pump circuit, a first terminal of the first capacitor is electrically connected between the second terminal of the first switching transistor and the input terminal of the second charge pump circuit, a second terminal of the first capacitor is electrically connected to a first terminal of the second switching transistor, a control terminal of the second switching transistor is electrically connected to a first terminal of the first current output circuit, a first terminal of the third switching transistor is electrically connected between the second terminal of the first capacitor and the first terminal of the second switching transistor, a second terminal of the first current output circuit, a second terminal of the second switching transistor and a first terminal of the second charge pump circuit are all grounded, and an output terminal of the second charge pump circuit is configured to output an output voltage of the multi-stage charge pump;
the control circuit is configured to, in a case where the input voltage of the multi-stage charge pump is less than a first threshold voltage, control, based on a first-phase clock signal, the first current output circuit to turn on the second switching transistor to charge the first capacitor using the input voltage of the multi-stage charge pump; and control, based on a second-phase clock signal, the second charge pump circuit to be charged using an output voltage of the first charge pump circuit;
in response to the first-phase clock signal, the first switching transistor is turned on, such that the first capacitor starts to be charged; and the second charge pump circuit is configured to boost the output voltage of the first charge pump circuit to obtain the output voltage of the multi-stage charge pump, wherein the output voltage of the multi-stage charge pump is three times the input voltage of the multi-stage charge pump; and
in response to the second-phase clock signal, the third switching transistor is turned on, such that the first charge pump circuit starts boosting the input voltage of the multi-stage charge pump to obtain the output voltage of the first charge pump circuit, and the output voltage of the first charge pump circuit is twice the input voltage of the multi-stage charge pump; and the second charge pump circuit is configured to be charged using the output voltage of the first charge pump circuit;
wherein the first-phase clock signal and the second-phase clock signal do not overlap and each have a duty cycle of 50%, forming a two-phase clock.

2. The multi-stage charge pump according to claim 1, wherein
the control circuit is configured to, in a case where the input voltage of the multi-stage charge pump is greater than the first threshold voltage, control the first switching transistor to always remain on, and control the first current output circuit to always remains off; and control, based on the second-phase clock signal, the second charge pump circuit to be charged using the input voltage of the multi-stage charge pump;
in response to the first-phase clock signal, the second charge pump circuit is configured to boost the input voltage of the multi-stage charge pump to obtain the output voltage of the multi-stage charge pump, wherein the output voltage of the multi-stage charge pump is twice the input voltage of the multi-stage charge pump; and
in response to the second-phase clock signal, the third switching transistor is turned on, such that the second charge pump circuit starts to be charged using the input voltage of the multi-stage charge pump.

3. The multi-stage charge pump according to claim 1, wherein the second charge pump circuit comprises: a fourth switching transistor, a fifth switching transistor, a sixth switching transistor, a seventh switching transistor, a second capacitor, a third capacitor, and a second current output circuit; wherein
a control terminal of the second current output circuit is electrically connected to the control circuit, a first terminal of the fourth switching transistor is electrically connected to the second terminal of the first switching transistor, a second terminal of the fourth switching transistor is electrically connected to a first terminal of the fifth switching transistor, a second terminal of the fifth switching transistor is electrically connected to a first terminal of the second capacitor, a first terminal of the third capacitor is electrically connected between the second terminal of the fourth switching transistor and the first terminal of the fifth switching transistor, a second terminal of the third capacitor is electrically connected to a first terminal of the sixth switching transistor, a control terminal of the sixth switching transistor is electrically connected to a first terminal of the second current output circuit, a first terminal of the seventh switching transistor is electrically connected between the second terminal of the third capacitor and the first terminal of the sixth switching transistor, a second terminal of the seventh switching transistor is electrically connected to a second terminal of the second capacitor, and a second terminal of the second current output circuit and a second terminal of the sixth switching transistor are both grounded;
the control circuit is configured to control, based on the second-phase clock signal, the second current output circuit to be conducted so as to turn on the sixth switching transistor;
in response to the first-phase clock signal, the fifth switching transistor and the seventh switching transistor are both turned on, such that the third capacitor discharges to the second capacitor; and
in response to the second-phase clock signal, the fourth switching transistor is turned on, such that the third capacitor starts to be charged.

4. The multi-stage charge pump according to claim 3, wherein the control circuit comprises a first sub-control circuit, a second sub-control circuit, and a third sub-control circuit; wherein
an output terminal of the first sub-control circuit is electrically connected to the control terminal of the first current output circuit, an output terminal of the second sub-control circuit is electrically connected to the control terminal of the second current output circuit, and an output terminal of the third sub-control circuit is electrically connected to the control terminal of the first switching transistor and the control terminal of the first current output circuit;
the first sub-control circuit is configured to, in a case where the input voltage of the multi-stage charge pump is less than the first threshold voltage, control, based on the first-phase clock signal, the first current output circuit to be conducted;
the second sub-control circuit is configured to control, based on the second-phase clock signal, the second current output circuit to be conducted; and
the third sub-control circuit is configured to, in a case where the input voltage of the multi-stage charge pump is greater than the first threshold voltage, control the first switching transistor to always remain on, and control the first current output circuit to always remain off.

5. The multi-stage charge pump according to claim 4, further comprising: a first over-voltage protection circuit and a second over-voltage protection circuit; wherein
an input terminal of the first over-voltage protection circuit is electrically connected to the first terminal of the first capacitor, an output terminal of the first over-voltage protection circuit is electrically connected to an input terminal of the first sub-control circuit, an input terminal of the second over-voltage protection circuit is electrically connected to the first terminal of the third capacitor, and an output terminal of the second over-voltage protection circuit is electrically connected to an input terminal of the second sub-control circuit;
the first over-voltage protection circuit is configured to, in a case where a voltage stored on the first capacitor is greater than a first predetermined voltage, transmit a first over-voltage protection signal to the first sub-control circuit, wherein the first over-voltage protection signal is used to cut off the first current output circuit; and
the second over-voltage protection circuit is configured to, in a case where a voltage stored on the third capacitor is greater than a second predetermined voltage, transmit a second over-voltage protection signal to the second current output circuit, wherein the second over-voltage protection signal is used to cut off the second current output circuit.

6. The multi-stage charge pump according to claim 5, wherein the first current output circuit comprises a constant-current source, a first transistor, a second transistor, and a third transistor;
an output terminal of the constant-current source is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded; and
the constant-current source is configured to output a first charge current, wherein a current value of the first charge current is greater than a maximum current value of a second charge current output by the second current output circuit.

7. The multi-stage charge pump according to claim 5, wherein the second current output circuit comprises a first sampling circuit, an operational amplifier, a fourth transistor, a fifth transistor, and a sixth transistor; wherein
an input terminal of the first sampling circuit is electrically connected to the first terminal of the second capacitor, an output terminal of the first sampling circuit is electrically connected to a first input terminal of the operational amplifier, a second input terminal of the operational amplifier is electrically connected to a reference voltage, an output terminal of the operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the first sampling circuit is configured to sample a voltage stored on the second capacitor, and transmit the voltage stored on the second capacitor to the operational amplifier; and
the operational amplifier is configured to regulate a magnitude of the second charge current based on the voltage stored on the second capacitor and the reference voltage.

8. The multi-stage charge pump according to claim 4, further comprising: an over-voltage protection circuit; wherein
an input terminal of the over-voltage protection circuit is electrically connected to the first terminal of the third capacitor, and an output terminal of the over-voltage protection circuit is electrically connected to the second sub-control circuit; and
the over-voltage protection circuit is configured to, in a case where a voltage stored on the third capacitor is greater than a predetermined voltage, transmit an over-voltage protection signal to the second current output circuit, wherein the over-voltage protection signal is used to cut off the second current output circuit.

9. The multi-stage charge pump according to claim 8, wherein the first current output circuit comprises a first sampling circuit, a first operation amplifier, a first transistor, a second transistor, and a third transistor; wherein
an input terminal of the first sampling circuit is electrically connected to the first terminal of the first capacitor, an output terminal of the first sampling circuit is electrically connected to a first input terminal of the first operational amplifier, a second input terminal of the first operational amplifier is electrically connected to a first reference voltage, an output terminal of the first operational amplifier is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded;
the first sampling circuit is configured to sample a voltage stored on the first capacitor, and transmit the voltage stored on the first capacitor to the first operational amplifier; and
the first operational amplifier is configured to regulate a magnitude of the first charge current based on the voltage stored on the first capacitor and the first reference voltage.

10. The multi-stage charge pump according to claim 8, wherein the second current output circuit comprises a second sampling circuit, a second operation amplifier, a fourth transistor, a fifth transistor, and a sixth transistor; wherein
an input terminal of the second sampling circuit is electrically connected to the first terminal of the second capacitor, an output terminal of the second sampling circuit is electrically connected to a first input terminal of the second operational amplifier, a second input terminal of the second operational amplifier is electrically connected to a second reference voltage, an output terminal of the second operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the second sampling circuit is configured to sample a voltage stored on the second capacitor, and transmit the voltage stored on the second capacitor to the second operational amplifier; and
the second operational amplifier is configured to regulate a magnitude of the second charge current based on the voltage stored on the second capacitor and the second reference voltage.

11. The multi-stage charge pump according to claim 4, further comprising: an over-voltage protection circuit; wherein
an input terminal of the over-voltage protection circuit is electrically connected to the first terminal of the second capacitor, an input terminal of the first sub-control circuit and an input terminal of the second sub-control circuit are both electrically connected to an output terminal of the over-voltage protection circuit; and
the over-voltage protection circuit is configured to, in a case where a voltage stored on the second capacitor is greater than a predetermined voltage, transmit an over-voltage protection signal to the first sub-control circuit and the second sub-control circuit, wherein the over-voltage protection signal is used for cutting off the first current output circuit and the second current output circuit.

12. The multi-stage charge pump according to claim 11, wherein the first current output circuit comprises a first sampling circuit, a first operation amplifier, a first transistor, a second transistor, and a third transistor; wherein
an input terminal of the first sampling circuit is electrically connected to the first terminal of the first capacitor, an output terminal of the first sampling circuit is electrically connected to a first input terminal of the first operational amplifier, a second input terminal of the first operational amplifier is electrically connected to a first reference voltage, an output terminal of the first operational amplifier is electrically connected to a second terminal of the first transistor, a first terminal of the first transistor is electrically connected to a first terminal of the second transistor, a control terminal of the second transistor is electrically connected to the control terminal of the second switching transistor, a first terminal of the third transistor is electrically connected between the first terminal of the first transistor and the first terminal of the second transistor, a control terminal of the first transistor and a control terminal of the third transistor are both electrically connected to the output terminal of the first sub-control circuit, and a second terminal of the second transistor and a second terminal of the third transistor are both grounded;
the first sampling circuit is configured to sample a voltage stored on the first capacitor, and transmit the voltage stored on the first capacitor to the first operational amplifier; and
the first operational amplifier is configured to regulate a magnitude of the first charge current based on the voltage stored on the first capacitor and the first reference voltage.

13. The multi-stage charge pump according to claim 11, wherein the second current output circuit comprises a second sampling circuit, a second operation amplifier, a fourth transistor, a fifth transistor, and a sixth transistor; wherein
an input terminal of the second sampling circuit is electrically connected to the first terminal of the third capacitor, an output terminal of the second sampling circuit is electrically connected to a first input terminal of the second operational amplifier, a second input terminal of the second operational amplifier is electrically connected to a second reference voltage, an output terminal of the second operational amplifier is electrically connected to a second terminal of the fourth transistor, a first terminal of the fourth transistor is electrically connected to a first terminal of the fifth transistor, a control terminal of the fifth transistor is electrically connected to the control terminal of the sixth switching transistor, a first terminal of the sixth transistor is electrically connected between the first terminal of the fourth transistor and the first terminal of the fifth transistor, a control terminal of the fourth transistor and a control terminal of the sixth transistor are both electrically connected to the output terminal of the second sub-control circuit, and a second terminal of the fifth transistor and a second terminal of the sixth transistor are both grounded;
the second sampling circuit is configured to sample a voltage stored on the third capacitor, and transmit the voltage stored on the third capacitor to the second operational amplifier; and
the second operational amplifier is configured to regulate a magnitude of the second charge current based on the voltage stored on the third capacitor and the second reference voltage.

14. The multi-stage charge pump according to claim 1, further comprising: a gate driver device; wherein
the gate driver device is electrically connected to a control terminal of a P-type switching transistor in the multi-stage charge pump; and
the gate driver device is configured to transmit the first-phase clock signal and the second-phase clock signal to the multi-stage charge pump.

15. The multi-stage charge pump according to claim 14, wherein the gate driver device comprises a driver circuit, a level conversion circuit, a first series branch, a second series branch, a fourth capacitor, a fifth capacitor, a seventh transistor, an eighth transistor, a ninth transistor, a tenth transistor, and an inverter; wherein
a power terminal of the driver circuit, a power terminal of the level conversion circuit, a power terminal of the first series branch, a power terminal of the second series branch, a first terminal of the fourth capacitor, a first terminal of the fifth capacitor, a first terminal of the seventh transistor, a first terminal of the eighth transistor, and a first terminal of the ninth transistor are all electrically connected to a high-side power supply voltage, an input terminal of the level conversion circuit is configured to receive a phase control signal, an output terminal of the level conversion circuit is electrically connected to an input terminal of the driver circuit, and an output terminal of the driver circuit and a second terminal of the eighth transistor are both electrically connected to a control terminal of a P-type switching transistor in the multi-stage charge pump;
the first series branch comprises a node, a first terminal of the first series branch is electrically connected to an enable signal output circuit, the node is electrically connected to a second terminal of the ninth transistor and a control terminal of the tenth transistor, a second terminal of the tenth transistor, a ground terminal of the level conversion circuit, a ground terminal of the driver circuit, and a second terminal of the seventh transistor are all electrically connected to a high-side ground voltage, and a second terminal of the fifth capacitor is electrically connected to a second terminal of the first series branch;
a first terminal of the second series branch is electrically connected to an output terminal of the inverter, an input terminal of the inverter is electrically connected to the enable signal output circuit, a second terminal of the second series branch is electrically connected to a second terminal of the fourth capacitor, a control terminal of the seventh transistor, a control terminal of the eighth transistor, and a control terminal of the ninth transistor, a third terminal of the second series branch and a third terminal of the first series branch are both electrically connected to a bias voltage, and a fourth terminal of the second series branch, a fourth terminal of the first series branch, and a first terminal of the tenth transistor are all grounded;
the first series branch is configured to, upon acquisition of an enable signal from the enable signal output circuit, pull down a voltage at the node in response to the enable signal being at a high level;
the tenth transistor is configured to, upon pulldown of the voltage at the node, pull down a potential of the high-side ground voltage to obtain a voltage domain, wherein a voltage within the voltage domain is greater than a second threshold voltage, and the voltage at the node changes with the high-side power supply voltage via the fifth capacitor;
the inverter is configured to invert the enable signal to obtain an inverted enable signal, and transmit the inverted enable signal to the second series branch; and
the second series branch is configured control, based on the inverted enable signal, the seventh transistor, the eighth transistor, and the ninth transistor to be turned on or turned off, wherein a voltage at the control terminal of the seventh transistor, a voltage at the control terminal of the eighth transistor, and a voltage at the control terminal of the ninth transistor change with the high-side power supply voltage via the fourth capacitor.

16. The multi-stage charge pump according to claim 15, wherein the first series branch comprises a first N-type transistor, a second N-type transistor, a first diode, and a first current source;
wherein a first terminal of the first diode is electrically connected to the high-side power supply voltage, a second terminal of the first diode is electrically connected to a first terminal of the first N-type transistor, the node is arranged between the second terminal of the first diode and the first terminal of the first N-type transistor, a second terminal of the first N-type transistor is electrically connected to a first terminal of the second N-type transistor, a second terminal of the second N-type transistor is electrically connected to a first terminal of the first current source, a second terminal of the first current source is grounded, a control terminal of the first N-type transistor is electrically connected to the bias voltage, and a control terminal of the second N-type transistor is electrically connected to the enable signal output circuit.

17. The multi-stage charge pump according to claim 15, wherein the second series branch comprises a fourth resistor, a third N-type transistor, a fourth N-type transistor, and a second current source;
wherein a first terminal of the fourth resistor is electrically connected to the high-side power supply voltage, a second terminal of the fourth resistor is electrically connected to a first terminal of the third N-type transistor, a second terminal of the third N-type transistor is electrically connected to a first terminal of the fourth N-type transistor, a second terminal of the fourth N-type transistor is electrically connected to a first terminal of the second current source, a second terminal of the second current source is grounded, a control terminal of the third N-type transistor is electrically connected to the bias voltage, and a control terminal of the fourth N-type transistor is electrically connected to the output terminal of the inverter.

18. A current limiting circuit, comprising: a first current output circuit, a second current output circuit, and a current limiting assembly; wherein
an output terminal of the first current output circuit is electrically connected to a first terminal of the second current output circuit, a second terminal of the second current output circuit is electrically connected to a control terminal of the current limiting assembly, a third terminal of the second current output circuit and a first terminal of the current limiting assembly are both electrically connected to a node in a charge pump, a second terminal of the current limiting assembly is electrically connected to a second terminal of a P-type power transistor in the charge pump, and a ground terminal of the first current output circuit and a ground terminal of the second current output circuit are both grounded; and
the first current output circuit is configured to transmit a first current to the second current output circuit, wherein the first current acts as a reference current;
the second current output circuit is configured to acquire a second current based on the first current, and transmit the second current to the current limiting assembly; and
the current limiting assembly is configured to control a current flowing through a body diode, in response to being turned on, of a power transistor in the charge pump to be less than or equal to the second current.

19. The current limiting circuit according to claim 18, further comprising: a regulation circuit; wherein
a first terminal of the regulation circuit is electrically connected to the first terminal of the second current output circuit, a control terminal of the regulation circuit is configured to receive a control signal, a second terminal of the regulation circuit is electrically connected to a fourth terminal of the second current output circuit, and a ground terminal of the regulation circuit is grounded;
the second current output circuit is further configured to transmit the second current to the regulation circuit; and
the regulation circuit is configured to regulate a magnitude of the second current under an effect of the control signal.

20. The current limiting circuit according to claim 19, wherein the regulation circuit comprises at least one current mirror assembly; wherein
a first terminal of the current mirror assembly is electrically connected to the fourth terminal of the second current output circuit, a control terminal of the current mirror assembly is configured to receive the control signal, a second terminal of the current mirror assembly is electrically connected to the first terminal of the second current output circuit, and a third terminal of the current mirror assembly is grounded; and
the current mirror assembly is configured to mirror the second current under the effect of the control signal.

21. The current limiting circuit according to claim 18, wherein the second current output circuit comprises a third switching transistor, a fourth switching transistor, and a fifth switching transistor;
wherein a control terminal of the third switching transistor is electrically connected to the output terminal of the first current output circuit, a first terminal of the third switching transistor is grounded, a second terminal of the third switching transistor is electrically connected to a first terminal of the fourth switching transistor, a control terminal of the fourth switching transistor is configured to receive a bias voltage, a second terminal of the fourth switching transistor is electrically connected to a second terminal of the fifth switching transistor, a control terminal of the fifth switching transistor, and the control terminal of the current limiting assembly, and a first terminal of the fifth switching transistor is electrically connected to a node in the charge pump.

22. The current limiting circuit according to claim 18, wherein the first current output circuit comprises a power source and a sixth switching transistor;
wherein an output terminal of the current source is electrically connected to a second terminal of the sixth switching transistor, a control terminal of the sixth switching transistor is electrically connected between the output terminal of the current source and a first terminal of the sixth switching transistor, the control terminal of the sixth switching transistor is further electrically connected to the first terminal of the second current output circuit, and the first terminal of the sixth switching transistor is grounded.

23. A driver circuit, wherein a charge pump comprises the driver circuit and energy storage branches in at least two stages; wherein an output terminal of the energy storage branch in a previous stage is electrically connected to an input terminal of the energy storage branch in a subsequent stage, each of the energy storage branches in at least two stages comprises at least one switching transistor and a capacitor, an output terminal of the driver circuit is electrically connected to a control terminal of at least one switching transistor in a first-stage energy storage branch, and the energy storage branches in at least two stages comprise the first-stage energy storage branch;
wherein the driver circuit comprises: a Zener diode, a voltage divider circuit, a current source, a level conversion circuit, a first switching transistor, and a second switching transistor; wherein
an input terminal of the level conversion circuit is configured to receive a first-phase clock signal, an output terminal of the level conversion circuit is the output terminal of the driver circuit, a first power supply terminal of the level conversion circuit is configured to receive a power supply voltage, a second power supply terminal of the level conversion circuit is electrically connected to a second terminal of the first switching transistor, a control terminal of the first switching transistor is electrically connected to an output terminal of the voltage divider circuit, a first terminal of the first switching transistor is electrically connected to a second terminal of the second switching transistor, a control terminal of the second switching transistor is electrically connected to a positive terminal of the Zener diode, a first terminal of the second switching transistor is grounded, a negative terminal of the Zener diode is configured to receive a power supply voltage, the positive terminal of the Zener diode is grounded via the current source, and the voltage divider circuit and the Zener diode are connected in parallel;
the voltage divider circuit is configured to divide a voltage across the two terminals of the Zener diode, and output a divided voltage at the output terminal of the voltage divider circuit, such that a voltage at the second terminal of the first switching transistor is greater than a difference between the power supply voltage and the divided voltage; and
the level conversion circuit is configured to convert a level value of the first-phase clock signal, and output a converted first-phase clock signal at the output terminal of the level conversion circuit, wherein a level value of the converted first-phase clock signal is within a value range from the power supply voltage to the voltage at the second terminal of the first switching transistor.

24. A charge pump, comprising: a driver circuit and energy storage branches in at least two stages; wherein an output terminal of the energy storage branch in a previous stage is electrically connected to an input terminal of the energy storage branch in a subsequent stage, each of the energy storage branches in at least two stages comprises at least one switching transistor and a capacitor, an output terminal of the driver circuit is electrically connected to a control terminal of at least one switching transistor in a first-stage energy storage branch, and the energy storage branches in at least two stages comprise the first-stage energy storage branch and a second-stage energy storage branch; and
wherein the driver circuit comprises: a Zener diode, a voltage divider circuit, a current source, a level conversion circuit, a first switching transistor, and a second switching transistor; wherein
an input terminal of the level conversion circuit is configured to receive a first-phase clock signal, an output terminal of the level conversion circuit is the output terminal of the driver circuit, a first power supply terminal of the level conversion circuit is configured to receive a power supply voltage, a second power supply terminal of the level conversion circuit is electrically connected to a second terminal of the first switching transistor, a control terminal of the first switching transistor is electrically connected to an output terminal of the voltage divider circuit, a first terminal of the first switching transistor is electrically connected to a second terminal of the second switching transistor, a control terminal of the second switching transistor is electrically connected to a positive terminal of the Zener diode, a first terminal of the second switching transistor is grounded, a negative terminal of the Zener diode is configured to receive a power supply voltage, the positive terminal of the Zener diode is grounded via the current source, and the voltage divider circuit and the Zener diode are connected in parallel;
the voltage divider circuit is configured to divide a voltage across the two terminals of the Zener diode, and output a divided voltage at the output terminal of the voltage divider circuit, such that a voltage at the second terminal of the first switching transistor is greater than a difference between the power supply voltage and the divided voltage; and
the level conversion circuit is configured to convert a level value of the first-phase clock signal, and output a converted first-phase clock signal at the output terminal of the level conversion circuit, wherein a level value of the converted first-phase clock signal is within a value range from the power supply voltage to the voltage at the second terminal of the first switching transistor.

25. The charge pump according to claim 24, wherein the first-stage energy storage branch comprises a third switching transistor and a first capacitor; wherein a first terminal of the third switching transistor is configured to receive an input voltage, and a second terminal of the third switching transistor is electrically connected to the top plate of the first capacitor; and
the driver circuit comprises a first driver circuit, wherein an output terminal of the first driver circuit is electrically connected to a control terminal of the third switching transistor, and a power supply voltage of the first driver circuit comes from the top plate of the first capacitor.

26. The charge pump according to claim 24, wherein the charge pump further comprises a control circuit; and the first-stage energy storage branch comprises a third switching transistor, a sixth switching transistor, a fifth switching transistor, a first capacitor, and a first current output circuit; wherein a control terminal of the third switching transistor, a control terminal of the first current output circuit, and a control terminal of the second-stage energy storage branch are all electrically connected to the control circuit, a first terminal of the third switching transistor and a second terminal of the fifth switching transistor are both electrically connected to an input voltage, a second terminal of the third switching transistor is electrically connected to an input terminal of the second-stage energy storage branch, a first terminal of the first capacitor is electrically connected between the second terminal of the third switching transistor and the input terminal of the second-stage energy storage branch, a second terminal of the first capacitor is electrically connected to a first terminal of the sixth switching transistor, a control terminal of the sixth switching transistor is electrically connected to a first terminal of the first current output circuit, a first terminal of the fifth switching transistor is electrically connected between the second terminal of the first capacitor and the first terminal of the sixth switching transistor, a second terminal of the first current output circuit, a second terminal of the sixth switching transistor and a first terminal of the second-stage energy storage branch are all grounded, and an output terminal of the second-stage energy storage branch is configured to output an output voltage of the charge pump;
the control circuit is configured to, in a case where the input voltage of the charge pump is less than a first threshold voltage, control, based on a first-phase clock signal, the first current output circuit to turn on the sixth switching transistor to charge the first capacitor using the input voltage of the charge pump; and control, based on a second-phase clock signal, the second-stage energy storage branch to be charged using an output voltage of the first-stage energy storage branch;
in response to the first-phase clock signal, the third switching transistor is turned on, such that the first capacitor starts to be charged; and the second-stage energy storage branch is configured to boost the output voltage of the first-stage energy storage branch to obtain the output voltage of the charge pump, wherein the output voltage of the charge pump is three times the input voltage of the charge pump; and
in response to the second-phase clock signal, the fifth switching transistor is turned on, such that the first charge pump circuit starts boosting the input voltage of the multi-stage charge pump to obtain the output voltage of the first charge pump circuit, and the output voltage of the first charge pump circuit is twice the input voltage of the multi-stage charge pump; and the second charge pump circuit is configured to be charged using the output voltage of the first charge pump circuit;
wherein the first-phase clock signal and the second-phase clock signal do not overlap and each have a duty cycle of 50%, forming a two-phase clock.

27. The charge pump according to claim 25, further comprising: a third resistor; wherein the second terminal of the third switching transistor is electrically connected to a top plate of the first capacitor via the third resistor, wherein,
the second-stage energy storage branch comprises a fourth switching transistor and a second capacitor, wherein a top plate of the second capacitor is electrically connected to the top plate of the first capacitor via the fourth switching transistor; and
the driver circuit comprises a second driver circuit, wherein an output terminal of the second driver circuit is electrically connected to a control terminal of the fourth switching transistor, and a power supply voltage of the second driver circuit comes from the top plate of the second capacitor.

28. The charge pump according to claim 25, wherein the second-stage energy storage branch further comprises a fifth switching transistor, wherein a bottom plate of the second capacitor is electrically connected to a bottom plate of the first capacitor via the fifth switching transistor; and
the driver circuit comprises a third driver circuit, wherein an output terminal of the third driver circuit is electrically connected to a control terminal of the fifth switching transistor, and a power supply voltage of the third driver circuit comes from the input voltage.
